(19) United States
(12) Patent Application Publication
(10) Pub. No.: US 2024/0210845 A1
(43) Pub. Date: Jun. 27, 2024

(54) AMORPHOUS POLYESTER RESIN, AQUEOUS DISPERSION LIQUID, METHOD FOR PRODUCING AQUEOUS DISPERSION LIQUID, RESIN PARTICLES, METHOD FOR PRODUCING RESIN PARTICLES, TONER RESIN PARTICLES, TONER, METHOD FOR PRODUCING TONER, DEVELOPER, TONER STORAGE, AND IMAGE FORMING APPARATUS

(71) Applicants: Junichi WATANABE, Shizuoka (JP); Akinori SAITOH, Shizuoka (JP); Masahiro YUKIKAWA, Kanagawa (JP); Akio TAKEI, Shizuoka (JP); Yuka MIZOGUCHI, Shizuoka (JP)

(72) Inventors: Junichi WATANABE, Shizuoka (JP); Akinori SAITOH, Shizuoka (JP); Masahiro YUKIKAWA, Kanagawa (JP); Akio TAKEI, Shizuoka (JP); Yuka MIZOGUCHI, Shizuoka (JP)

(73) Assignee: Ricoh Company, Ltd., Tokyo (JP)

(21) Appl. No.: 18/543,008

(22) Filed: Dec. 18, 2023

(30) Foreign Application Priority Data
Dec. 26, 2022 (JP) 2022-207826

(51) Int. Cl. G03G 9/08; G03G 9/125; G03G 9/13

(52) U.S. Cl. CPC G03G 9/0804; G03G 9/125; G03G 9/13

(57) ABSTRACT

An amorphous polyester resin includes an environmentally friendly component. An environmentally friendly component content of the amorphous polyester resin is 40% by mass or greater and 80% by mass or less. The amorphous polyester resin is a sulfo group-containing amorphous polyester resin. A sulfo group content of the sulfo group-containing amorphous polyester resin is 2 mol % or greater and 10 mol % or less.

### CROSS-REFERENCE TO RELATED APPLICATION

The present application claims priority under 35 U.S.C. § 119 to Japanese Patent Application No. 2022-207826, filed Dec. 26, 2022, the contents of which are incorporated herein by reference in their entirety.

### BACKGROUND OF THE INVENTION

### 1. Field of the Invention

The disclosures herein generally relate to an amorphous polyester resin, an aqueous dispersion liquid, a method for producing an aqueous dispersion liquid, resin particles, a method for producing resin particles, toner resin particles, a toner, a method for producing a toner, a developer, a toner storage, and an image forming apparatus.

### 2. Description of the Related Art

A resin material used for a toner, such as a binder resin, has been predominantly sourced from fossil fuels. Carbon dioxide generated from disposal of toners has been emitted to the atmosphere, which may contribute to global warming. A shift from fossil fuels, which are limited resources, to biomass resins or recycled resins, which are renewable materials, is a shift towards use of a material that is sustainably renewed. Therefore, such technology is desired.

To this end, as a binder resin of a toner, use of an environmentally friendly resin, such as polylactic acid (PLA), rosin compounds, and recycled polyethylene terephthalate (PET), has been studied. For example, a toner including recycled polyethylene terephthalate (PET) is proposed (see Japanese Unexamined Patent Application Publication No. 2014-098149).

Moreover, proposed is a toner where formation of shells is improved by improving stability of a shell material using sulfo group-containing resin particles as the shell material (see Japanese Unexamined Patent Application Publication No. 2010-66651). As the stability of the shell material improves, long-term storage stability of the shell material improves as well as improving formation of shells. Therefore, the stability of the shell material is an important indicator for productivity of a toner.

### SUMMARY OF THE INVENTION

In one embodiment, an amorphous polyester resin includes an environmentally friendly component, where an environmentally friendly component content of the amorphous polyester resin is 40% by mass or greater and 80% by mass or less. The amorphous polyester resin is a sulfo group-containing amorphous polyester resin, where a sulfo group content of the sulfo group-containing amorphous polyester resin is 2 mol % or greater and 10 mol % or less.

### BRIEF DESCRIPTION OF THE DRAWINGS

FIG. 1 is a schematic view illustrating an example of the image forming apparatus of the present disclosure;

FIG. 2 is a schematic view illustrating another example of the image forming apparatus of the present disclosure;

FIG. 3 is a schematic view illustrating yet another example of the image forming apparatus of the present disclosure;

FIG. 4 is an enlarged partial view of FIG. 3; and

FIG. 5 is a schematic view illustrating an example of a process cartridge serving as the toner storage of the present disclosure.

### DESCRIPTION OF THE PREFERRED EMBODIMENTS

In the following, embodiments of the present invention will be described with reference to the accompanying drawings.

Further, the present invention is not limited to these embodiments, but various variations and modifications may be made without departing from the scope of the present invention.

Specifically, embodiments of an amorphous polyester resin, an aqueous dispersion liquid of an amorphous polyester resin, a method for producing an aqueous dispersion liquid of an amorphous polyester resin, resin particles, a method for producing resin particles, toner resin particles, a toner, a method for producing a toner, a developer, a toner storage, and an image forming apparatus according to the present disclosure will be described hereinafter. The present disclosure is not limited to the embodiments described below, and the embodiments may be modified, for example, by substitution with another embodiment, addition, variation, and omission, without departing from the scope of the present invention. These modified embodiments are also included within the scope of the present disclosure as long as the embodiments display the functions and effects of the present disclosure.

The amorphous polyester resin of the present disclosure includes an environmentally friendly component, where an environmentally friendly component content of the amorphous polyester resin is 40% by mass or greater and 80% by mass or less. The amorphous polyester resin is a sulfo group-containing amorphous polyester resin, where a sulfo group content of the sulfo group-containing amorphous polyester resin is 2 mol % or greater and 10 mol % or less.

An aqueous dispersion liquid, in which the amorphous polyester resin of the present disclosure is dispersed in an aqueous medium, has high stability and forms a coating film having excellent durability. Moreover, the aqueous dispersion liquid, in which the amorphous polyester resin of the present disclosure is dispersed in the aqueous medium, is suitably used as a raw material of a shell material for toner particles.

The aqueous dispersion liquid of the amorphous polyester resin of the present disclosure includes the amorphous polyester resin of the present disclosure as dispersed particles, and an aqueous medium as a dispersion medium.

The method for producing an aqueous dispersion liquid of an amorphous polyester resin of the present disclosure includes the following steps A and B.

Step A: dissolving or dispersing the amorphous polyester resin of the present disclosure in an organic solvent to prepare an oil phase; and

Step B: adding an aqueous medium to the oil phase to cause phase inversion from a water-in-oil dispersion liquid to an oil-in-water dispersion liquid to obtain an aqueous dispersion liquid including the amorphous polyester resin as dispersed particles, and the aqueous medium as a dispersion medium.

The resin particles of the present disclosure each include a core layer and a shell layer including the amorphous polyester resin of the present disclosure, where the core layer and the shell layer constitute a core-shell structure of each of the resin particles.

The toner resin particles of the present disclosure include the resin particles of the present disclosure, each including at least one selected from the group consisting of a crystalline resin, a release agent, and a colorant.

The toner of the present disclosure includes the toner resin particles of the present disclosure and an external additive.

An object of the present disclosure is to provide an amorphous polyester resin that is significantly environmentally friendly, has excellent durability, and can form an aqueous dispersion liquid having excellent stability.

According to the present disclosure, an amorphous polyester resin that is significantly environmentally friendly, has excellent durability, and can form an aqueous dispersion liquid having excellent stability can be provided.

### (Aqueous Polyester Resin)

### <Environmentally Friendly Component>

First, as an environmentally friendly component, polyethylene terephthalate or polybutylene terephthalate, which is a recycled resin, and a plant-derived resin will be described.

### <<Polyethylene Terephthalate or Polybutylene Terephthalate-Derived Component>>

The polyethylene terephthalate (PET)-derived component or polybutylene terephthalate (PBT)-derived component is not particularly limited, except that the PET or PBT-derived component is a component derived from PET or PBT. The PET-derived component and the PBT-derived component may be appropriately selected according to the intended purpose.

The PET is typically composed of ethylene glycol and terephthalic acid. Moreover, the PBT is typically composed of butylene glycol and terephthalic acid. Therefore, examples of the PET-derived component and the PBT-derived component include monomer units of ethylene glycol, butylene glycol, and terephthalic acid.

Recycled PET and recycled PBT are preferably used as the PET and PBT, respectively, in view of environmental friendliness.

The recycled PET and the recycled PBT are not particularly limited, and may be appropriately selected according to the intended purpose. For example, recycled products of the PET or PBT, discarded off-specification fibers of the PET or PBT, or pellets of the PET or PBT may be used. Among the above-listed examples, recycled products (may be referred to as “recycled resin(s)” hereinafter) processed into flakes are preferred.

A molecular weight distribution, composition, production method, and embodiment of the PET or PBT that is a raw material of the PET-derived component or the PBT-derived component are not particularly limited, and may be appropriately selected according to the intended purpose.

A weight average molecular weight (Mw) of the PET or PBT is not particularly limited, and may be appropriately selected according to the intended purpose. The weight average molecular weight (Mw) is preferably from 30,000 to 100,000.

In recent years, many different applications of recycled resins have been attempted in various fields. Polyesters have been recycled in the following manner. Collected polyester molded products, such as PET bottles, are melted, or molecular weights of polyesters constituting the collected polyester molded products are reduced, the processed product is polymerized again to form chips, and the chips are used to produce fibers, films, or molded products. In the above-described manner, a recycling flow of the recycled PET or recycled PBT has been established as readily available recycled resins. Use of such materials can contribute reduction in industrial waste and improves environmental friendliness. The contribution to recycling of resources is one of the most important activities for many corporations.

The PET and the PBT are both semi-aromatic polyesters formed through a reaction between an aromatic dicarboxylic acid and an aliphatic diol. Specifically, the PET is a compound having an aromatic ring skeleton, where the number of carbon atoms in the moiety derived from the aliphatic diol is 2 (C2). The PBT is a compound having an aromatic ring skeleton, where the number of carbon atoms in the moiety derived from the aliphatic diol is 4 (C4). As described above, chemical properties of PET and PBT are similar. Therefore, it is generally considered in the present technical field that, if PET can achieve a certain task, the same task can be also almost certainly performed with PBT. In the resin particles of the present disclosure, PET and PBT can be interchangeably used. In the resin particles, particularly, a PET or PBT-derived component having an aromatic ring skeleton is particularly effective for improving mechanical strength of the resin particles.

Among the above-listed examples, a component where the moiety derived from the aliphatic diol has a small number of carbon atoms is preferred in view of improvement in mechanical strength of resulting resin particles, and the PET-derived component is particularly preferred.

### <<Plant-Derived Component>>

The plant-derived component is not particularly limited, except that the plant-derived component is a component derived from plants. The plant-derived component may be appropriately selected according to the intended purpose. Examples of the plant-derived component include monomers derived from plants and monomers that can be substituted with plant-derived components. The above-listed examples may be used alone or in combination.

Recently, materials derived from petroleum have been able to be replaced with plant-derived materials. Plant-derived materials of ethylene glycol, propylene glycol, 1,3-propanediol, 1,4-butanediol, neopentyl glycol, glycerin, succinic acid, itaconic acid, sebacic acid, and dodecanedioic acid have been already commercialized.

In the present specification, the plant-derived monomers that can replace petroleum-derived monomers are not particularly limited, and may be appropriately selected according to the intended purpose. Examples of the plant-derived monomers include ethylene glycol, propylene glycol, 1,3-propanediol, 1,4-butanediol, neopentyl glycol, glycerin, succinic acid, itaconic acid, sebacic acid, and dodecanedioic acid. The above-listed examples may be used alone or in combination. The monomers replaced with the plant-derived component are preferably already commercialized plant-derived monomers in view of ready availability, but the monomers may be acquired by appropriately separating from plants.

When a plant-derived polyester resin is used as a shell material of particles of a toner, it is difficult to achieve desired mechanical strength, as constituent monomers of the plant-derived resin do not include an aromatic ring skeleton. A resulting toner therefore has low strength, which may cause filming on a photoconductor. There is a problem in use of an environmentally friendly component such that it is difficult to achieve both high environmental friendliness and adequate durability desired as properties of the toner at the same time.

When a plant-derived polyester resin is used as a shell material of particles of a toner, moreover, the shell material has low stability to cause aggregation between the particles of the shell material so that the shell material may not be able to cover the particles of the toner. Therefore, there is a problem that it is difficult to achieve both high environmental friendliness and adequate durability desired as properties of the toner at the same time.

Considering the above-described problems, the amorphous polyester resin of the present disclosure is significantly environmentally friendly, has excellent durability, and can be formed into an aqueous dispersion liquid having excellent stability, as the amorphous polyester resin of the present disclosure has an environmentally friendly component content of 40% by mass or greater and 80% by mass or less, and a sulfo group content of 2 mol % or greater and 10 mol % or less.

In the present specification, the recycled PET-derived component and the recycled PBT-derived component, and the plant-derived component may be collectively referred to as an “environmentally friendly component” hereinafter.

The environmentally friendly component can be separated as a chloroform-soluble component from the amorphous polyester resin included in the aqueous dispersion liquid. Therefore, the environmentally friendly component content of the amorphous polyester resin included in the aqueous dispersion liquid can be measured from the chloroform-soluble component content.

### —Method for Preparing Chloroform-Soluble Component—

When the amorphous polyester resin of the present disclosure is used to form a shell layer of a core-shell structure of resin particles, the amorphous polyester resin is used in a form of an aqueous dispersion liquid of the amorphous polyester resin (may be referred to as an “amorphous polyester aqueous dispersion liquid” hereinafter) obtained by the below-described method for producing an aqueous dispersion liquid of an amorphous polyester resin.

The chloroform-soluble component of the amorphous polyester resin in the amorphous polyester aqueous dispersion liquid can be obtained in the following manner.

To 100 mL of chloroform, 1 g of a dried product of the amorphous polyester aqueous dispersion liquid is added. The dried product is obtained by drying the amorphous polyester aqueous dispersion liquid by a vacuum dryer for 6 hours. The resulting mixture is stirred for 30 minutes at 25° C. to prepare a solution in which a soluble component is dissolved. The resulting solution is filtered with a membrane filter having an opening size of 0.2 μm to obtain a chloroform-soluble component of the amorphous polyester resin.

### —Measuring Method of Environmentally Friendly Component Content of Amorphous Polyester Resin in Amorphous Polyester Aqueous Dispersion Liquid—

The chloroform-soluble component obtained in the above-described manner is dissolved in chloroform to prepare a sample for gel permeation calorimetry (GPC). The sample is then injected into a gel permeation calorimeter (GPC). A fraction collector is disposed at an eluate outlet of the GPC. The eluate is fractionated per the predetermined count (the fractions corresponding to the desired molecular weight range are collectively collected based on the entire area region of the elution curve) to collect the eluate per 5% from the elution onset of the elution curve (a rise of the elution curve). After condensing and drying each of the fractions of the eluate by an evaporator to prepare a sample, 30 mg of each of the prepared samples is dissolved in 1 mL of deuterated chloroform. To the resulting solution, 0.05% by volume of tetramethylsilane (TMS) is added as a standard material. The resulting solution is added to a 5 mm-diameter glass tube for nuclear magnetic resonance (NMR) spectroscopy, and a spectrum of the sample is obtained by a nuclear magnetic resonance spectrometer (JNM-AL400, available from JEOL Ltd.) by integrating 128 times at a temperature of from 23° C. to 25° C. The monomer composition of the eluted component of the amorphous polyester resin in the amorphous polyester aqueous dispersion liquid and the composition ratios of the constituent components of the eluted component are determined from the peak integration ratios of the obtained spectra.

As another method, after condensing the eluate, hydrolysis is performed using sodium hydroxide etc. The resulting decomposed components are subjected to identification and quantification analysis, such as high-performance liquid chromatography (HPLC), to calculate constituent monomer ratios of the eluted component of the amorphous polyester resin.

In the present specification, a sum of the composition ratios of the plant-derived monomer component, the PET-derived monomer component, and the PBT-derived monomer component is determined as an “environmentally friendly component content (%).” The environmentally friendly component content is preferably from 40% to 80%. When the environmentally friendly component content is less than 40%, the amorphous polyester resin is generally regarded as having low environmental friendliness, and use of such an amorphous polyester resin may not reduce adverse impacts to the environment at a desired level. When the environmentally friendly component content is greater than 80%, the amorphous polyester resin has a high solubility parameter (SP) and high hydrophilicity so that the amorphous polyester resin is easily swollen, thus durability is impaired when the amorphous polyester resin is used as a coating material or a shell of a toner particle. This is because, the environmentally friendly component is typically composed of a component that is likely to increase the SP.

### (Resin Particles)

Each of the resin particles of the present disclosure has a core-shell structure composed of a core layer and a shell layer. The shell layer includes the amorphous polyester resin of the present disclosure, and may further include other components, such as a crystalline resin, a release agent, and a colorant, as necessary.

### <Amorphous Polyester Resin>

The amorphous polyester resin constituting a shell layer of the core-shell structure of the resin particles is preferably an amorphous polyester resin A. An amorphous polyester resin included in a core of the core-shell structure of the resin particles is preferably a below-described amorphous polyester resin B.

### <<Amorphous Polyester Resin A>>

The amorphous polyester resin A is preferably a linear polyester resin. Moreover, the amorphous polyester resin A is preferably an unmodified polyester resin. The amorphous polyester resin A is a polyester resin soluble in tetrahydrofuran (THF) and in chloroform.

The unmodified polyester resin is a polyester resin synthesized from a multivalent alcohol and a multivalent carboxylic acid or a derivative of the multivalent carboxylic acid, and is a polyester resin that is not modified with another compound. The amorphous polyester resin A is preferably free from a urethane bond and a urea bond. The amorphous polyester resin A can be formed as an environmentally friendly component-containing resin by using the environmentally friendly component as at least any one of the multivalent alcohol isocyanate and the multivalent carboxylic acid or the derivative of the multivalent carboxylic acid. Moreover, the amorphous polyester resin A is preferably a sulfo group-containing amorphous polyester resin. Since a sulfo group is included in the amorphous polyester resin, stability of the amorphous polyester resin is improved when the amorphous polyester resin is formed into an aqueous dispersion liquid. The environmentally friendly component content of the amorphous polyester resin A is 40% by mass or greater and 80% by mass or less, and the sulfo group content of the sulfo group-containing amorphous polyester resin is 2 mol % or greater and 10 mol % or less.

### —Multivalent Alcohol—

The multivalent alcohol is not particularly limited, and may be appropriately selected according to the intended purpose. Examples of the multivalent alcohol include diols.

Examples of the diols include bisphenol A C2-C3 alkylene oxide adducts (average number of moles added: from 1 to 10), ethylene glycol, butylene glycol, propylene glycol, hydrogenated bisphenol A, and hydrogenated bisphenol A C2-C3 alkylene oxide adducts (average number of moles added: from 1 to 10).

Examples of the bisphenol A C2-C3 alkylene oxide adducts (average number of moles added: from 1 to 10) include polyoxypropylene (2.2)-2,2-bis(4-hydroxyphenyl) propane and polyoxyethylene (2.2)-2,2-bis(4-hydroxyphenyl) propane.

The above-listed examples may be used alone or in combination. Among the above-listed examples, the multivalent alcohol preferably includes plant-derived or recycled PET-derived ethylene glycol, plant-derived or recycled PBT-derived butylene glycol, plant-derived propylene glycol, plant-derived 1,3-propanediol, plant-derived 1,4-butanediol, and/or plant-derived neopentyl glycol in view of improved environmental friendliness.

To adjust an acid value or a hydroxyl value, the amorphous polyester resin A may include a trivalent or higher alcohol at a terminal of a molecular chain of the amorphous polyester resin A.

Examples of the trivalent or higher alcohol include glycerin, pentaerythritol, and trimethylolpropane. Use of the plant-derived glycerin can improve environmental friendliness.

### —Multivalent Carboxylic Acid and Derivative of Multivalent Carboxylic Acid—

The multivalent carboxylic acid is not particularly limited, and may be appropriately selected according to the intended purpose. Examples of the multivalent carboxylic acid include dicarboxylic acids.

Examples of the dicarboxylic acids include adipic acid, phthalic acid, isophthalic acid, terephthalic acid, fumaric acid, maleic acid, succinic acid, sebacic acid, dodecanedioic acid, and succinic acid substituted with a C1-C20 alkyl group or a C2-C20 alkenyl group.

Examples of the succinic acid substituted with a C1-C20 alkyl group or a C2-C20 alkenyl group include dodecenyl succinic acid and octyl succinic acid.

The derivative of the multivalent carboxylic acid is not particularly limited, and may be appropriately selected according to the intended purpose. Examples of the derivative of the multivalent carboxylic acid include anhydrides of the multivalent carboxylic acid, and esters of the multivalent carboxylic acid.

The above-listed examples may be used alone or in combination.

Among the above-listed examples, the multivalent carboxylic acid preferably includes, as the environmentally friendly component, plant-derived, recycled PET-derived, or recycled PBT-derived saturated aliphatic succinic acid, sebacic acid, and/or dodecanedioic acid. Since the multivalent carboxylic acid is derived from plants, recycled PET, or recycled PBT, environmental friendliness can be improved.

### <<Amorphous Polyester Resin B>>

The amorphous polyester resin B is preferably a linear polyester resin. Moreover, the amorphous polyester resin B is preferably an unmodified polyester resin. The amorphous polyester resin B is a polyester resin soluble in tetrahydrofuran (THF) and in chloroform.

The unmodified polyester resin is a polyester resin synthesized from a multivalent alcohol and a multivalent carboxylic acid or a derivative of the multivalent carboxylic acid, and is a polyester resin that is not modified with another compound, such as an isocyanate compound. The amorphous polyester resin B is preferably free from a urethane bond and a urea bond. The amorphous polyester resin A can be formed as an environmentally friendly component-containing resin by using the environmentally friendly component as at least any one of the multivalent alcohol and the multivalent carboxylic acid or the derivative of the multivalent carboxylic acid.

### —Multivalent Alcohol—

The multivalent alcohol is not particularly limited, and may be appropriately selected according to the intended purpose. Examples of the multivalent alcohol include diols.

Examples of the diols include bisphenol A C2-C3 alkylene oxide adducts (average number of moles added: from 1 to 10), ethylene glycol, butylene glycol, propylene glycol, hydrogenated bisphenol A, and hydrogenated bisphenol A C2-C3 alkylene oxide adducts (average number of moles added: from 1 to 10).

Examples of the bisphenol A C2-C3 alkylene oxide adducts (average number of moles added: from 1 to 10) include polyoxypropylene (2.2)-2,2-bis(4-hydroxyphenyl) propane and polyoxyethylene (2.2)-2,2-bis(4-hydroxyphenyl) propane.

The above-listed examples may be used alone or in combination. Among the above-listed examples, the multivalent alcohol preferably includes plant-derived or recycled PET-derived ethylene glycol, plant-derived or recycled PBT-derived butylene glycol, plant-derived propylene glycol, plant-derived 1,3-propanediol, and/or plant-derived 1,4-butanediol in view of improved environmental friendliness.

To adjust an acid value or a hydroxyl value, the amorphous polyester resin B may include a trivalent or higher alcohol at a terminal of a molecular chain of the amorphous polyester resin B.

Examples of the trivalent or higher alcohol include glycerin, pentaerythritol, and trimethylolpropane. Use of the plant-derived glycerin can improve environmental friendliness.

### —Multivalent Carboxylic Acid and Derivative of Carboxylic Acid—

The multivalent carboxylic acid is not particularly limited, and may be appropriately selected according to the intended purpose. Examples of the multivalent carboxylic acid include dicarboxylic acids.

Examples of the dicarboxylic acids include adipic acid, phthalic acid, isophthalic acid, terephthalic acid, fumaric acid, maleic acid, succinic acid, sebacic acid, dodecanedioic acid, and succinic acid substituted with a C1-C20 alkyl group or a C2-C20 alkenyl group.

Examples of the succinic acid substituted with a C1-C20 alkyl group or a C2-C20 alkenyl group include dodecenyl succinic acid and octyl succinic acid.

The derivative of the multivalent carboxylic acid is not particularly limited, and may be appropriately selected according to the intended purpose. Examples of the derivative of the multivalent carboxylic acid include anhydrides of the multivalent carboxylic acid, and esters of the multivalent carboxylic acid.

The above-listed examples may be used alone or in combination.

Among the above-listed examples, the multivalent carboxylic acid preferably includes, as the environmentally friendly component, plant-derived, recycled PET-derived, or recycled PBT-derived saturated aliphatic succinic acid, sebacic acid, and/or dodecanedioic acid. Since the multivalent carboxylic acid is derived from plants, recycled PET, or recycled PBT, environmental friendliness can be improved.

The amorphous polyester resin B includes a dicarboxylic acid component as a constituent component of the amorphous polyester resin B. The dicarboxylic acid component preferably includes 50 mol % or greater of terephthalic acid. The dicarboxylic acid component including terephthalic acid in an amount of 50 mol % or greater is advantageously used in view of heat resistant storage stability of resulting resin particles.

To adjust an acid value or a hydroxyl value, the amorphous polyester resin B may include a trivalent or higher carboxylic acid at a terminal of a molecular chain of the amorphous polyester resin B.

Examples of the trivalent or higher carboxylic acid include trimellitic acid, pyromellitic acid, and acid anhydrides of the foregoing carboxylic acids.

A molecular weight of the amorphous polyester resin B is not particularly limited, and may be appropriately selected according to the intended purpose. The molecular weight of the amorphous polyester resin B as measured by GPC is preferably within the following ranges.

A weight average molecular weight (Mw) of the amorphous polyester resin B is preferably from 3,000 to 10,000, more preferably from 4,000 to 10,000.

A number average molecular weight (Mn) of the amorphous polyester resin B is preferably from 1,000 to 4,000, more preferably from 1,500 to 3,000.

A molecular weight ratio (Mw/Mn) of the amorphous polyester resin B is preferably from 1.0 to 4.0, more preferably from 1.0 to 3.5.

When the weight average molecular weight (Mw) and number average molecular weight (Mn) of the amorphous polyester resin B are equal to or greater than the lower limits of the preferred ranges, respectively, desired heat-resistant storage stability of resulting resin particles and desired durability of the resin particles against stress, such as stirring performed inside a developing device, are achieved. When the weight average molecular weight (Mw) and number average molecular weight (Mn) of the amorphous polyester resin B are equal to or less than the upper limits of the preferred ranges, respectively, viscoelasticity of the resin particles when melted may be maintained at an appropriate level, and desirable low-temperature fixability is achieved.

An acid value of the amorphous polyester resin B is not particularly limited, and may be appropriately selected according to the intended purpose. The acid value is preferably from 1 mgKOH/g to 50 mgKOH/g, more preferably from 5 mgKOH/g to 30 mgKOH/g. When the acid value of the amorphous polyester resin B is 1 mgKOH/g or greater, a toner including resulting resin particles tends to be negatively charged, and affinity between the toner and a recording medium, such as paper, is improved during fixing to the recording medium, consequently improving low-temperature fixability. When the acid value of the amorphous polyester resin B is 50 mgKOH/g or less, moreover, desirable charging stability, especially charging stability against fluctuations of environmental conditions, is achieved.

The acid value of the amorphous polyester resin B can be measured according to the measuring method specified in JIS K0070-1992.

A hydroxyl value of the amorphous polyester resin B is not particularly limited, and may be appropriately selected according to the intended purpose. The hydroxyl value is preferably 5 mgKOH/g or greater. Moreover, the upper limit of the hydroxyl value of the amorphous polyester resin B is not particularly limited, and may be appropriately selected according to the intended purpose. The upper limit is preferably 30 mgKOH/g or less. The lower limit and upper limit of the hydroxyl value of the amorphous polyester resin B may be appropriately selected, and preferably from 5 mgKOH/g to 30 mgKOH/g.

The hydroxyl value of the amorphous polyester resin B can be measured according to the measuring method specified in JIS K0070-1966.

A glass transition temperature (Tg) of the amorphous polyester resin B is not particularly limited, and may be appropriately selected according to the intended purpose. The glass transition temperature (Tg) is preferably 40° C. or higher and 80° C. or lower, more preferably 50° C. or higher and 70° C. or lower. When the glass transition temperature (Tg) of the amorphous polyester resin B is 40° C. or higher, a toner including the resulting resin particles has desirable heat resistant storage stability, and desirable durability against stress, such as stirring performed inside a developing device, improving filming resistance. When the glass transition temperature (Tg) of the amorphous polyester resin B is 80° C. or lower, a toner including the resin particles is sufficiently deformed by heat and pressure applied during fixing, improving low-temperature fixability.

The molecular structure of the amorphous polyester resin B can be determined by solution or solid nuclear magnetic resonance spectroscopy (NMR), X-ray diffraction spectroscopy, gas chromatography-mass spectrometry (GC-MS), liquid chromatography-mass spectrometry (LC-MS), or infrared (IR) spectroscopy. Among the above-listed measuring methods, the measuring method used may be a method where a compound having no absorption, which is based on OCH (out of plane bending vibrations) of an olefin, at 965±10 cm⁻¹ or 990±10 cm⁻¹ on an infrared absorption spectrum of the compound as measured by IR spectroscopy is detected as the amorphous polyester resin B.

An amount of the amorphous polyester resin B is not particularly limited, and may be appropriately selected according to the intended purpose. The amount of the amorphous polyester resin B relative to 100 parts by mass of the resin particles is preferably 50 parts by mass or greater and 90 parts by mass or less, more preferably 60 parts by mass or greater and 80 parts by mass or less. When the amount of the amorphous polyester resin B relative to 100 parts by mass of the resin particles is 50 parts by mass or greater, a colorant (e.g., a pigment) or release agent can be desirably dispersed inside each of the resin particles, minimizing image fogging or formation of defective images. When the amount of the amorphous polyester resin B relative to 100 parts by mass of the resin particles is 90 parts by mass or less, moreover, an adequate amount of a crystalline resin can be included in the resin particles so that desirable low-temperature fixability can be achieved. The amount of the amorphous polyester resin B within the above-mentioned more preferred range is advantageous in view of high image quality and excellent low-temperature fixability.

### <<Core-Shell Structure>>

Each of the resin particles has a core-shell structure. A shell material (a shell resin) constituting the shell layer is preferably the amorphous polyester resin A, and an amorphous polyester resin included in the core is preferably the amorphous polyester resin B.

In the present specification, the term “a core-shell structure” encompasses a structure including a core layer and a shell layer, where the “shell layer” is a layer formed on a region of the outermost layer of each resin particle, and the “core layer” is a region of the resin particle excluding the shell layer.

The core layer and the shell layer are not completely compatible to each other and are not homogeneously distributed.

As a preferred embodiment of the core-shell structure, the core-shell structure has a structure where a surface of the core layer is covered with the shell layer.

In the core-shell structure, the surface of the core layer may be completely covered with the shell layer, or may not be completely covered with the shell layer. Examples of the embodiment where the surface of the core layer is not completely covered with the shell layer include: an embodiment where a core layer is covered with a net-like shell layer; and an embodiment where a core layer is partially exposed from a shell layer. Among the above-listed examples, the surface of the core layer is preferably completely covered with the shell layer in view of filming resistance.

### —Shell Material—

The amorphous polyester resin A is used as a shell material. As described above, the amorphous polyester resin A is, for example, obtained through polycondensation between a multivalent alcohol and a multivalent carboxylic acid, and includes the environmentally friendly component. The shell material may be a resin including only the recycled PET-derived component or the recycled PBT-derived component, or a resin including only the plant-derived component. The shell material is preferably a resin including both the recycled PET-derived component or the recycled PBT-derived component and the plant-derived component.

Examples of a method for measuring a volume average particle diameter of particles of the amorphous polyester resin in the amorphous polyester aqueous dispersion liquid include a method where the particles are measured by a particle size distribution analyzer, Nanotrac (UPA-EX150, available from NIKKISO CO., LTD., dynamic light scattering/laser doppler velocimetry).

First, only a solvent of the dispersion liquid of each of the samples is measured in advance as a background measurement. Next, the dispersion liquid, in which each of the samples is dispersed, is measured by adjusting a concentration of the dispersion liquid to the predetermined measuring concentration range, to measure a volume average particle diameter of the sample.

A method for confirming the composition of the shell layer is not particularly limited, and may be appropriately selected according to the intended purpose. Examples of the method include a method where the composition of the shell layer is confirmed by a composition analysis of a surface layer (the shell layer) using nanoIR (also referred to as “AMF-IR”).

An IR spectrum of the surface layer (the shell layer) of each of the resin particles is obtained according to an analysis method using a combination of an atomic force microscope (AFM) of nanoIR and IR to achieve nanoscale resolution. A composition structure of the surface layer can be determined from the obtained IR spectrum.

Specifically, the composition analysis may be performed in the following manner. The resin particles are embedded in an epoxy resin (S-31, available from DEVCON), and the epoxy resin is cured. The cured epoxy resin is cut with a knife to expose cross-sections of the resin particles, and the resulting epoxy resin is sliced into a thickness of 60 nm by an ultrasonic ultramicrotome (Leica EM UC7, available from Leica Microsystems) to prepare an ultra-thin cut piece of the resin particles. The prepared ultra-thin cut piece of the resin particles is collected on a substrate (ZnS), and a measuring point (the shell layer) is measured by a nanoscale infrared spectrometer (e.g., nanoIR2, available from Anasys Instruments Corp.) according to AFM-IR. A measuring range is set in the range of 1,900 cm⁻¹ to 910 cm⁻¹, and resolution is set at 2 cm⁻¹. From the obtained AFM-IR absorption spectrum, a chemical structure of the measuring point (the shell layer) is determined. As a result of the above-described analysis, the composition of the surface layer (the shell layer) can be confirmed.

Moreover, a chemical structure of the core layer may be also determined by setting the core layer as the measuring point.

An average thickness of the shell layer is not particularly limited, and may be appropriately selected according to the intended purpose. The average thickness is preferably from 50 nm to 500 nm, more preferably from 100 nm to 200 nm. When the average thickness of the shell layer is 50 nm or greater, the core layer inside each of the resin particles is sufficiently protected, improving mechanical strength of resulting resin particles. When the average thickness of the shell layer is 200 nm or less, adequate mechanical strength is obtained without impairing low-temperature fixability.

In the present specification, the “average thickness of the shell layer” is an average thickness of the shell layer determined in the following manner. Among the resin particles having diameters within a range of a weight average particle diameter of the resin particles±2.0 μm, 50 resin particles are randomly selected. A thickness of a shell layer of each of the selected 50 resin particles is measured in the manner described later. The arithmetic mean of the thickness values measured from the 50 resin particles is determined as the average thickness of the shell layer.

A coverage rate of the surface of the core layer with the shell layer is not particularly limited, and may be appropriately selected according to the intended purpose. The coverage rate is preferably from 50% to 100%, more preferably from 80% to 100%. The coverage rate being 100% means that the entire surface of the core layer of each of the resin particles is covered with the shell layer.

The coverage rate (%) of the surface of the core layer with the shell layer may be calculated according to Equation (3) below.

$$Coverage rate ( \% ) = \qquad Equation ( 3 )$$

$$( area of covered region ) / ( entire surface area of resin particle ) \times 100$$

In Equation (3), the “entire surface area of resin particle” means a sum of the area of the covered region and an area of a region where the core layer is exposed; the “area of covered region” means an area of a region or regions of the core layer covered with the shell layer; the “area of a region where the core layer is exposed” is an area of a region or regions where the core layer is not covered with the shell layer.

A method for confirming the presence of the core-shell structure of the resin particles is not particularly limited, and may be appropriately selected according to the intended purpose. For example, the core-shell structure of the resin particles may be confirmed in the following manner. The resin particles are embedded in an epoxy resin (S-31, available from DEVCON), and the epoxy resin is cured. The cured epoxy resin is cut with a knife to expose cross-sections of the resin particles, and the resulting epoxy resin is sliced into a thickness of 60 nm by an ultrasonic ultramicrotome (Leica EM UC7, available from Leica Microsystems) to prepare an ultra-thin cut piece of the resin particles. The prepared ultra-thin cut piece of the resin particles is exposed to a ruthenium tetroxide (RuO₄) gas to dye the resin particles to identify shell layers and core layers. The gas exposure time may be appropriately adjusted according to a desired contrast for observation. Then, the cross-sectional image of the resin particles is observed under a transmission electron microscope (H-7500, available from Hitachi High-Tech Corporation) at acceleration voltage of 120 kV to confirm the presence of the core-shell structure.

On the TEM image observed in the above-described method, the covered region of the core layer at a surface of each of the resin particles (a region of the core layer covered with the shell layer within the resin particle), and the exposed region of the core layer (a region of the core layer without being covered with the shell layer within the resin particle) may be distinguished according to a difference in brightness. Therefore, the TEM image observed in the above-described method is binarized using image processing software, and a shell layer is identified with a contrast in the binarized image to measure a thickness of the shell layer.

As the image processing software, Image-J may be used. A calculation method of an average thickness of the shell layer using Image-J is as described below.
(1) A scale is traced using a “Straight Line” function to draw a straight line. An actual length and unit of the straight line are set using a “Set Scale” function on an “Analyze” window.
(2) A periphery of one resin particle is traced with the “Freehand-sections” function on a cross-sectional image of the one resin particle to set “Region 1.”
(3) A periphery of a region of the cross-sectional image of the one resin particle excluding the shell layer (a boundary between the shell layer and the core layer) is traced with the “Freehand-sections” function to set “Region 2.”
(4) A center of gravity of the “Region 1” is determined with an “Analyze” function.
(5) Using the originally developed plug-in, straight lines are drawn from coordinates towards the center of gravity of the resin particle determined in (4). The coordinates are created by evenly dividing the line tracing the periphery of the “Region 1”, i.e., the periphery of the resin particle in (2), into 100.
(6) On each of the 100 straight lines drawn in (5), a length obtained by subtracting the length of the straight line passing through “Region 2” from the length of the straight line passing through “Region 1” is calculated using the straight line created by tracing the scale in (1). An average length of the calculated lengths from the 100 straight lines is determined as a thickness of the shell layer of the resin particle.
(7) The processes of (2) to (6) are carried out on 50 resin particles, and an arithmetic mean of the thicknesses of the shell layers of the 50 resin particles is calculated. The calculated mean is determined as an average thickness of the shell layer in the resin particles of the present disclosure.

Moreover, a method for calculating the coverage rate with the shell layer using Image-J is as follows.
(1) A section of a periphery of one resin particle covered with a shell layer on a cross-sectional image of the one resin particle is traced with a “Freehand Line” function, and a length of the traced line is measured by an “Analyze” function. The measured length is determined as “Length 1.”
(2) The periphery of the resin particle on the cross-sectional image of the resin particle is traced with the “Freehand Line” function, and a length of the traced line is measured by the “Analyze” function. The measured length is determined as “Length 2.”
(3) A value of Length 1/Length 2×100 is calculated. The calculated value is determined as a coverage rate of the resin particle with the shell layer.
(4) The processes of (1) to (3) are carried out on 50 resin particles, and an arithmetic mean of the coverage rates of the 50 resin particles with the shell layers. The arithmetic mean is determined as a coverage rate with the shell layer in the resin particles of the present disclosure.

### <Other Components>

The above-mentioned other components in the resin particles are not particularly limited, and may be appropriately selected according to the intended purpose. Examples of the above-mentioned other components include crystalline resins, colorants, release agents, charge control agents, flowability improvers, cleaning improvers, magnetic materials, and shape modifiers. The above-listed examples may be used alone or in combination.

### <Crystalline Resin>

The crystalline resin is not particularly limited, except that the crystalline resin has crystallinity. The crystalline resin may be appropriately selected according to the intended purpose. Examples of the crystalline resin include polyester resins, polyurethane resins, polyurea resins, polyamide resins, polyether resins, vinyl resins, and modified crystalline resins. The above-listed examples may be used alone or in combination. Among the above-listed examples, the crystalline resin is preferably a crystalline polyester resin.

### <<Crystalline Polyester Resin>>

The crystalline polyester resin (may be referred to as a “crystalline polyester resin C” hereinafter) has high crystallinity, thus the crystalline polyester resin has thermal melting characteristics such that viscosity of the crystalline polyester resin drastically changes at a temperature close to a fixing onset temperature. The crystalline polyester resin C is insoluble in tetrahydrofuran (THF), but is soluble in chloroform.

Use of the crystalline polyester resin having the above-described characteristics and the amorphous polyester resin in combination can form resin particles having both desirable heat resistant storage stability and desirable low-temperature fixability. As the crystalline polyester resin C and the amorphous polyester resin are used in combination, for example, resulting resin particles have desirable heat resistant storage stability owing to crystallinity of the crystalline polyester resin C until a temperature of the resin particles reaches just below the melt onset temperature. At the melt onset temperature, the resin particles cause a drastic reduction in viscosity (sharp melting) due to melting of the crystalline polyester resin C. The melted crystalline polyester resin C increases affinity with the amorphous polyester resin B and is mixed with the amorphous polyester resin B to drastically decrease the viscosity of the resin particles, improving fixability. Moreover, the resulting resin particles has a desirable release range (a difference between the minimum fixing temperature and the hot-offset onset temperature).

The crystalline polyester resin C is synthesized from a multivalent alcohol and a multivalent carboxylic acid or a derivative of the multivalent carboxylic acid. The crystalline polyester resin can be formed as an environmentally friendly component-containing resin by using the plant-derived component, or the recycled PET-derived component or the recycled PBT-derived component as at least any one of the multivalent alcohol and the multivalent carboxylic acid or the derivative of the multivalent carboxylic acid. The above-listed examples may be used alone or in combination.

In the present specification, the crystalline polyester resin C is a resin synthesized from the multivalent alcohol and the multivalent carboxylic acid or the derivative of the multivalent carboxylic acid, as described above. Therefore, a modified polyester resin, such as a prepolymer, and a resin obtained through at least any of a cross-linking reaction and an elongation reaction of the prepolymer, is not classified as the crystalline polyester resin C.

### —Multivalent Alcohol—

The multivalent alcohol is not particularly limited, and may be appropriately selected according to the intended purpose. Examples of the multivalent alcohol include diols and trivalent or higher alcohols.

Examples of the diols include saturated aliphatic diols.

Examples of the saturated aliphatic diols include straight-chain saturated aliphatic diols and branched-chain saturated aliphatic diol. Among the above-listed examples, the saturated aliphatic diol is preferably a straight-chain saturated aliphatic diol, and more preferably a C2-C12 straight-chain saturated aliphatic diol. Use of a straight-chain saturated aliphatic diol as the saturated aliphatic diol is preferable because a resulting crystalline polyester resin C has high crystallinity and a high melting point. When the number of carbon atoms of the saturated aliphatic diol is greater than 12, it is practically difficult to source such a saturated aliphatic diol. The number of carbon atoms of the saturated aliphatic diol is preferably 12 or less. Specific examples of the saturated aliphatic diols include ethylene glycol, butylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. The above-listed examples may be used alone or in combination. Among the above-listed examples, ethylene glycol, butylene glycol, 1,4-butanediol, 1,6-hexanediol, 1,8-octanediol, 1,10-decanediol, and 1,12-dodecanediol are preferred in view of high crystallinity and excellent sharp melting properties imparted to a resulting crystalline polyester resin C.

Examples of the trivalent or higher alcohols include glycerin, trimethylolethane, trimethylolpropane, and pentaerythritol.

The above-listed multivalent alcohols may be used alone or in combination.

### —Multivalent Carboxylic Acid and Derivative of Multivalent Carboxylic Acid—

The multivalent carboxylic acid is not particularly limited, and may be appropriately selected according to the intended purpose. Examples of the multivalent carboxylic acid includes dicarboxylic acids.

Examples of the dicarboxylic acids include saturated aliphatic dicarboxylic acids, unsaturated aliphatic dicarboxylic acids, and aromatic dicarboxylic acids.

Examples of the saturated aliphatic dicarboxylic acids include oxalic acid, malonic acid, succinic acid, glutaric acid, sebacic acid, adipic acid, and dodecanedioic acid.

Examples of the unsaturated aliphatic dicarboxylic acids include fumaric acid and maleic acid.

Examples of the aromatic dicarboxylic acids include terephthalic acid.

The above-listed examples may be used alone or in combination.

The dicarboxylic acid is preferably a plant-derived C4-C12 saturated aliphatic dicarboxylic acid. Since the dicarboxylic acid is derived from a plant, resulting resin particles contribute carbon neutrality. When the number of carbon atoms of the dicarboxylic acid is 12 or less, compatibility with the amorphous polyester resin is improved, improving low-temperature fixability of resulting resin particles.

The derivative of the multivalent carboxylic acid is not particularly limited, and may be appropriately selected according to the intended purpose. Examples of the derivative of the multivalent carboxylic acid include anhydrides of the multivalent carboxylic acid, and esters of the multivalent carboxylic acid.

A melting point of the crystalline polyester resin C is not particularly limited, and may be appropriately selected according to the intended purpose. The melting point is preferably 60° C. or higher and 80° C. or lower. When the melting point of the crystalline polyester resin C is 60° C. or higher, the crystalline polyester resin C does not melt at a low temperature, leading to desirable heat-resistant storage stability of the resin particles. When the melting point of the crystalline polyester resin C is 80° C. or lower, moreover, the crystalline polyester resin C is sufficiently melted by heat applied during fixing, achieving desirable low-temperature fixability.

A molecular weight of the crystalline polyester resin C is not particularly limited, and may be appropriately selected according to the intended purpose. The crystalline polyester resin C having a sharp molecular weight distribution imparts excellent low-temperature fixability to resulting resin particles, and a large amount of the crystalline polyester resin C component having a large molecular weight contained improves heat resistant storage stability of the resin particles. To this end, a molecular weight of an ortho-dichlorobenzene-soluble component of the crystalline polyester resin C as measured by gel permeation chromatography (GPC) is preferably within the following ranges.

A weight average molecular weight (Mw) of the crystalline polyester resin C is preferably from 3,000 to 30,000, more preferably from 5,000 to 25,000.

A number average molecular weight (Mn) of the crystalline polyester resin C is preferably from 1,000 to 10,000, more preferably from 2,000 to 10,000.

A molecular weight ratio (Mw/Mn) of the crystalline polyester resin C is preferably from 1.0 to 10, more preferably from 1.0 to 5.0.

An acid value of the crystalline polyester resin C is not particularly limited, and may be appropriately selected according to the intended purpose. To achieve desirable low-temperature fixability considering the affinity between a recording medium and the resin particles, the lower limit of the acid value is preferably 5 mgKOH/g or greater, more preferably 10 mgKOH/g or greater, In view of improvement in hot offset resistance, moreover, the upper limit of the acid value of the crystalline polyester resin C is preferably 45 mgKOH/g or less.

The acid value of the crystalline polyester resin C can be measured according to the measuring method specified in JIS K0070-1992.

A hydroxyl value of the crystalline polyester resin C is not particularly limited, and may be appropriately selected according to the intended purpose. To achieve desired low-temperature fixability and excellent charging characteristics, the hydroxyl value is preferably 0 mgKOH/g or greater and 50 mgKOH/g or less, more preferably 0 mgKOH/g or greater and 10 mgKOH/g or less.

The hydroxyl value of the crystalline polyester resin C can be measured according to the measuring method specified in JIS K0070-1966.

The molecular structure of the crystalline polyester resin C can be determined by solution or solid nuclear magnetic resonance spectroscopy (NMR), X-ray diffraction spectroscopy, gas chromatography-mass spectrometry (GC-MS), liquid chromatography-mass spectrometry (LC-MS), or infrared (IR) spectroscopy. Among the above-listed examples, a simple method is method where a compound having absorption, which is based on OCH (out of plane bending vibrations) of an olefin, at 965±10 cm⁻¹ and 990±10 cm⁻¹ on an infrared absorption spectrum of the compound as measured by IR spectroscopy is detected as the crystalline polyester resin C.

An amount of the crystalline polyester resin C in the resin particles is not particularly limited, and may be appropriately selected according to the intended purpose. The amount of the crystalline polyester resin C relative to 100 parts by mass of the resin particles is preferably 3 parts by mass or greater and 20 parts by mass or less, more preferably 5 parts by mass or greater and 15 parts by mass or less. When the amount of the crystalline polyester resin C in the resin particles is 3 parts by mass or greater, sharp melting properties of the crystalline polyester resin C can be improved so that low-temperature fixability of resulting resin particles can be improved. When the amount of the crystalline polyester resin C in the resin particles is 20 parts by mass or less, moreover, desirable heat resistant storage stability of resulting resin particles is achieved, and occurrences of image fogging are minimized. The amount of the crystalline polyester resin C within the above-mentioned more preferred range relative to the resin particles is advantageous in view of high image quality, and excellent low-temperature fixability.

### <<Colorant>>

The colorant is not particularly limited, and may be appropriately selected according to the intended purpose. Examples of the colorant include carbon black, nigrosine dyes, iron black, Naphthol yellow S, Hansa yellow (10G, 5G, and G), cadmium yellow, yellow iron oxide, yellow ocher, yellow lead, titanium yellow, polyazo yellow, oil yellow, Hansa yellow (GR, A, RN, and R), Pigment Yellow L, Benzidine Yellow (G and GR), Permanent Yellow (NCG), Vulcan Fast Yellow (5G and R), tartrazine lake, quinoline yellow lake, anthracene yellow BGL, isoindolinon yellow, red iron oxide, red lead, lead vermilion, cadmium red, cadmium mercury red, antimony vermilion, Permanent Red 4R, parared, fire red, p-chloro-o-nitroaniline red, Lithol Fast Scarlet G, brilliant fast scarlet, Brilliant Carmine BS, Permanent Red (F2R, F4R, FRL, FRLL, and F4RH), Fast Scarlet VD, Vulcan Fast Rubin B, Brilliant Scarlet G, Lithol Rubin GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, eosin lake, Rhodamine B Lake, Rhodamine Y Lake, alizarin lake, Thioindigo Red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, Indanthrene Blue (RS and BC), indigo, ultramarine, iron blue, anthraquinone blue, Fast Violet B, methyl violet lake, cobalt purple, manganese violet, dioxane violet, anthraquinone violet, chrome green, zinc green, chromium oxide, viridian, emerald green, Pigment Green B, Naphthol Green B, green gold, acid green lake, malachite green lake, phthalocyanine green, anthraquinone green, titanium oxide, zinc flower, and lithopone. The above-listed examples may be used alone or in combination.

An amount of the colorant in the resin particles is not particularly limited, and may be appropriately selected according to the intended purpose. The amount of the colorant relative to 100 parts by mass of the resin particles is preferably 1 part by mass or greater and 15 parts by mass or less, more preferably 3 parts by mass or greater and 10 parts by mass or less.

The colorant may be used as master batch in which the colorant forms a composite with a resin.

The resin used for production of the master batch or the resin kneaded together with the master batch is not particularly limited, and may be appropriately selected according to the intended purpose. Examples of the resin include, as well as the amorphous polyester resin, polymers of styrene or substituted styrene, styrene-based copolymers, polymethyl methacrylate, polybutyl methacrylate, polyvinyl chloride, polyvinyl acetate, polyethylene, polypropylene, polyester, epoxy resins, epoxypolyol resins, polyurethane, polyamide, polyvinyl butyral, polyacrylic acid resins, rosin, modified rosin, terpene resins, aliphatic or alicyclic hydrocarbon resins, aromatic petroleum resins, chlorinated paraffin, and paraffin wax. The above-listed examples may be used alone or in combination.

Examples of the polymers of styrene or substituted styrene include polystyrene, poly-p-chlorostyrene, and polyvinyl toluene.

Examples of the styrene-based copolymers include styrene-p-chlorostyrene copolymers, styrene-propylene copolymers, styrene-vinyl toluene copolymers, styrene-vinyl naphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl-α-chloromethacrylate copolymers, styrene-acrylonitrile copolymers, styrene-methyl vinyl ketone copolymers, styrene-butadiene copolymers, styrene-isoprene copolymers, styrene-acrylonitrile-indene copolymers, styrene-maleic acid copolymers, and styrene-maleic acid ester copolymers.

A method for producing the master batch is not particularly limited, and may be appropriately selected according to the intended purpose. Examples of the method include a method where a high shearing force is applied to mix and knead the resin for the master batch and the colorant. During the mixing and kneading, an organic solvent may be used to enhance interaction between the colorant and the resin. Moreover, a flashing method is preferably used. The flashing method is a method where an aqueous paste including a colorant and water is mixed and kneaded with a resin and an organic solvent to transfer the colorant to the side of the resin, followed by removing the water and the organic solvent. According to the flashing method, a wet cake of the colorant can be used as the master batch so that it is not necessary to dry the colorant. A high-shearing disperser, such as a three-roll mill, is preferably used for the mixing and kneading.

### <<Release Agent>>

The release agent is not particularly limited, and may be appropriately selected from release agents known in the related art. Examples of the release agent include wax, fatty acid amides, homopolymers or copolymers of polyacrylate, and crystalline polymers each having a long alkyl group at a side chain. The above-listed examples may be used alone or in combination. The above-listed release agents are soluble in chloroform.

Examples of the wax include natural wax, synthetic hydrocarbon wax, and synthetic wax.

Examples of the natural wax include vegetable wax, animal wax, mineral wax, and petroleum wax.

Examples of the vegetable wax include carnauba wax, cotton wax, and Japan wax.

Examples of the animal wax include beeswax and lanoline wax.

Examples of the mineral wax include ozokerite and ceresin.

Examples of the petroleum wax include paraffin wax, microcrystalline wax, and petrolatum wax.

Examples of the synthetic hydrocarbon wax include Fischer-Tropsch wax and polyethylene wax.

Examples of the synthetic wax include esters, ketones, and ethers.

Examples of the fatty acid amides include 12-hydroxystearic acid amide, stearic acid amide, phthalimide, and chlorinated hydrocarbon.

Examples of the polyacrylate include low-molecular-weight crystalline polymer resins, such as poly-n-stearyl methacrylate and poly-n-lauryl methacrylate.

Examples of the homopolymers or copolymers of the polyacrylate include a n-stearyl acrylate-ethyl methacrylate copolymer.

Among the above-listed examples, the release agent is preferably vegetable wax or ester wax using a plant-derived material. Use of the plant-derived release agent can improve carbon neutrality of the resin particles.

A melting point of the release agent is not particularly limited, and may be appropriately selected according to the intended purpose. The melting point is preferably 60° C. or higher and 80° C. or lower. When the melting point of the release agent is 60° C. or higher, the release agent does not melt at a low temperature, leading to desirable heat-resistant storage stability. When the melting point of the release agent is 80° C. or lower, moreover, the release agent is sufficiently melted in the case where the resin of the resin particles is melted at a fixing temperature region. In this case, fixing offset does not occur, hence formation of defective images can be minimized.

An amount of the release agent in the resin particles is not particularly limited, and may be appropriately selected according to the intended purpose. The amount of the release agent relative to 100 parts by mass of the resin particles is preferably 2 parts by mass or greater and 10 parts by mass or less, more preferably 3 parts by mass or greater and 8 parts by mass or less. When the amount of the release agent is 2 parts by mass or greater, desirable hot offset resistance during fixing and low-temperature fixability are achieved. When the amount of the release agent is 10 parts by mass or less, desirable heat-resistant storage stability is achieved, and occurrences of image fogging are minimized. The amount of the release agent within the more preferred range is advantageous in view of high image quality and improvement in fixing stability.

### <<Charge Control Agent>>

The charge control agent is not particularly limited, and may be appropriately selected according to the intended purpose. Examples of the charge control agent include nigrosine-based dyes, triphenylmethane-based dyes, chrome-containing metal complex dyes, molybdic acid chelate pigments, rhodamine-based dyes, alkoxy-based amines, quaternary ammonium salts (including fluorine-modified quaternary ammonium salts), alkylamides, phosphorus or phosphorus compounds, fluorine-based active agents, metal salts of salicylic acid, metal salts of salicylic acid derivatives, oxynaphthoic acid metal salts, phenol-based condensates, azo-pigments, boron complexes, and functional group (e.g., a sulfonic acid group, a carboxyl group, and a quaternary ammonium salt)-containing polymer-based compounds. The above-listed examples may be used alone or in combination.

Specific examples of the charge control agent include: a nigrosine dye BONTRON 03, a quaternary ammonium salt BONTRON P-51, a metal-containing azo dye BONTRON S-34, an oxynaphthoic acid-based metal complex E-82, a salicylic acid-based metal complex E-84, and a phenol condensate E-89 (all manufactured by ORIENT CHEMICAL INDUSTRIES CO., LTD); quaternary ammonium salt molybdenum complexes TP-302 and TP-415 (all manufactured by Hodogaya Chemical Co., Ltd.); LRA-901 and a boron complex LR-147 (manufactured by Japan Carlit Co., Ltd.); copper phthalocyanine; perylene; quinacridone; and azo-pigments.

An amount of the charge control agent is not particularly limited, and may be appropriately selected according to the intended purpose. The amount of the charge control agent relative to 100 parts by mass of the resin particles is preferably 0.1 parts by mass or greater and 10 parts by mass or less, more preferably from 0.2 parts by mass to 5 parts by mass. When the amount of the charge control agent is 10 parts by mass or less relative to 100 parts by mass of the resin particles, desirable chargeability is imparted to a toner including resulting resin particles, and the desired chargeability assures a main effect as the charge control agent. As a result, an appropriate electrostatic suction force between the toner and a developing roller is maintained, and desirable flowability of a developer including the toner and desirable image density are achieved. The charge control agent may be melt-kneaded with a master batch or resin, followed by dissolving or dispersing the resulting mixture in an organic solvent, or may be directly added to an organic solvent when the master batch or resin is dissolved or dispersed in the organic solvent. Alternatively, the charge control agent may be fixed on surfaces of resin particles after producing the resin particles.

### <<Flowability Improver>>

The flowability improver is not particularly limited, except that the flowability improver is capable of increasing hydrophobicity to prevent degradation of flowability and charging characteristics in high humidity conditions. The flowability improver may be appropriately selected according to the intended purpose. Examples of the flowability improver include silane coupling agents, silylating agents, fluoroalkyl group-containing silane coupling agents, organic titanate-based coupling agents, aluminum-based coupling agents, silicone oil, and modified silicone oil. The above-listed examples may be used alone or in combination. An amount of the flowability improver is not particularly limited, and may be appropriately selected according to the intended purpose. The amount of the flowability improver relative to 100 parts by mass of the resin particles is preferably 0.01 parts by mass or greater and 5.00 parts by mass or less, and more preferably 0.10 parts by mass or greater and 2.00 parts by mass or less.

### <<Cleaning Improver>>

The cleaning improver is an agent to aid removal of a developer remaining on a photoconductor or a primary transferring member after transferring. The cleaning improver is not particularly limited, and may be appropriately selected according to the intended purpose. Examples of the cleaning improver include fatty acid metal salts and polymer particles. The above-listed examples may be used alone or in combination.

Examples of the fatty acid metal salts include zinc stearate, calcium stearate, and other metal salts of stearic acid.

The polymer particles are preferably polymer particles produced by soap-free emulsion polymerization. Examples of the polymer particles include polymethyl methacrylate particles and polystyrene particles.

A volume average particle diameter of the polymer particles is not particularly limited, and may be appropriately selected according to the intended purpose. The polymer particles preferably have a relatively narrow particle size distribution. The polymer particles having the volume average particle diameter of from 0.01 μm to 1 μm are preferred.

An amount of the cleaning improver is not particularly limited, and may be appropriately selected according to the intended purpose. The amount of the cleaning improver relative to 100 parts by mass of the resin particles is preferably 0.01 parts by mass or greater and 5.00 parts by mass or less, more preferably 0.10 parts by mass or greater and 2.00 parts by mass or less.

### <<Magnetic Material>>

The magnetic material is not particularly limited, and may be appropriately selected according to the intended purpose. Examples of the magnetic material include iron powder, magnetite, and ferrite. The above-listed examples may be used alone or in combination. Among the above-listed examples, the magnetic material is preferably a white magnetic material in view of color tone.

An amount of the magnetic material is not particularly limited, and may be appropriately selected according to the intended purpose. The amount of the magnetic material relative to 100 parts by mass of the resin particles is preferably 20 parts by mass or greater and 200 parts by mass or less, more preferably 40 parts by mass or greater and 150 parts by mass or less.

### <<<Shape Modifier>>>

The shape modifier is added to modify shapes of the resin particles.

The shape modifier is not particularly limited, and may be appropriately selected according to the intended purpose. The shape modifier preferably includes a layered inorganic mineral, in which at least some of ions present between layers of the layered inorganic mineral are modified with organic ions.

The layered inorganic mineral, in which at least some of ions present between layers of the layered inorganic mineral are modified with organic ions, is not particularly limited, and may be appropriately selected according to the intended purpose. Examples of the above-mentioned layered inorganic mineral include layered inorganic minerals each of which has a smectite-based basic crystal structure and is modified with organic cations. Within a structure of smectite clay minerals, layers are negatively charged, and cations are present between the layers to compensate the negative charge of the layers. An interlayer compound may be formed through ion exchange of the cations or adsorption of polar molecules. Moreover, metal ions can be introduced by substituting some of divalent metals of the layered inorganic mineral with trivalent metals. Since hydrophilicity increases through introduction of metal anions, a layered inorganic compound, in which at least some of the metal anions are modified with organic anions, is preferable.

The layered inorganic mineral, in which at least some of the ions present between layers of the layered inorganic mineral are modified with organic ions, is obtained using an organic cationic modifier or an organic anionic modifier.

The organic cationic modifier is not particularly limited, except that the organic cationic modifier can modify the layered inorganic mineral with organic ions in the manner as described above. Examples of the organic cationic modifier include quaternary alkyl ammonium salts, phosphonium salts, and imidazolium salts. The above-listed examples may be used alone or in combination. Among the above-listed examples, the organic cationic modifier is preferably a quaternary alkyl ammonium salt.

The quaternary alkyl ammonium of the quaternary alkyl ammonium salt is not particularly limited. Examples of the quaternary alkyl ammonium include trimethylstearylammonium, dimethylstearylbenzylammonium, and oleyl bis(2-hydroxyethyl)methyl ammonium.

The organic anionic modifier is not particularly limited, except that the organic anionic modifier can modify the layered inorganic mineral with organic ions in the manner as described above. Examples of the organic anionic modifier include sulfuric acid salts, sulfonic acid salts, carboxylic acid salts, and phosphoric acid salts, each having a C1-C44 branched, non-branched, or cyclic alkyl group, a C1-C22 branched, non-branched, or cyclic alkenyl group, a C8-C32 branched, non-branched, or cyclic alkoxy group, a C2-C22 branched, non-branched, or cyclic hydroxyalkyl group, an ethylene oxide skeleton, or a propylene oxide skeleton. The above-listed examples may be used alone or in combination. Among the above-listed examples, the organic anionic modifier is preferably a carboxylic acid salt having an ethylene oxide skeleton.

In the case where the resin particles are produced by the method described in the section of (Method for producing resin particles) below, the shape modifier is preferably added during the below-described <Oil phase preparation step>.

Since at least some of the ions present between the layers of the layered inorganic mineral are modified with organic ions, the layered inorganic mineral has appropriate hydrophobicity. As the layered inorganic mineral is added, therefore, the oil phase including constituent materials of the resin particles has non-Newtonian viscosity, consequently deforming the oil droplets that will be formed into resin particles. An amount of the shape modifier in the constituent materials of the resin particles is preferably from 0.05% by mass to 10% by mass, more preferably from 0.05% by mass to 5% by mass, relative to a total amount of the constituent materials of the resin particles.

Moreover, the layered inorganic mineral is not particularly limited, and may be appropriately selected according to the intended purpose. Examples of the layered inorganic mineral include montmorillonite, bentonite, hectorite, attapulgite, sepiolite, and a mixture of any combination of the foregoing minerals.

Among the above-listed examples, the layered inorganic mineral, in which at least some of the ions present between the layers of the layered inorganic mineral are modified with organic ions, is preferably organic-modified montmorillonite or organic-modified bentonite. This is because, when resulting resin particles are used for a toner, a viscosity of the oil phase can be easily adjusted without adversely affecting properties of the toner, and an adequate shape-modifying effect can be achieved with a small amount of the layered inorganic mineral.

Examples of a commercial product of the layered inorganic mineral, in which at least some of the ions present between the layers of the layered inorganic mineral are modified with organic ions, include: quaternium-18 bentonite, such as Bentone 3 (available from ELEMENTIS PLC.), Bentone 38 (available from ELEMENTIS PLC.), Bentone 38V (available from ELEMENTIS PLC.), Tixogel VP (available from United catalyst), Claytone 34 (available from Southern Clay (ECKART)), Claytone 40 (available from Southern Clay (ECKART)), and Claytone XL (available from Southern Clay (ECKART)); stearalkonium bentonite, such as Bentone 27 (available from ELEMENTIS PLC.), Tixogel LG (available from United catalyst), Claytone AF (available from Southern Clay (ECKART)), and Claytone APA (available from Southern Clay (ECKART)); and quaternium-18/benzalkonium bentonite, such as Claytone HT (available from Southern Clay (ECKART)) and Claytone PS (available from Southern Clay (ECKART)). Among the above-listed examples, Claytone AF and Claytone APA are preferred.

Moreover, the layered inorganic mineral, in which at least some of the ions present between the layers of the layered inorganic mineral are modified with organic ions, is preferably DHT-4A® (available from Kyowa Chemical Industry Co., Ltd.) that is modified with an organic anionic modifier represented by General Formula (III) below. Examples of the organic anionic modifier represented by General Formula (III) include HITENOL® 330T (available from DKS Co., Ltd.).

$${R}_{1} ( {OR}_{2} ) {}_{n} {OSO}_{3} M \qquad General Formula ( III )$$

In General Formula (III), R₁ is a C13 alkyl group, R₂ is a C2-C6 alkylene group, n is an integer of from 2 to 10, and M is a monovalent metal element.

### —Volume Average Particle Diameter of Resin Particles—

A volume average particle diameter (D4) of the resin particles is not particularly limited, and may be appropriately selected according to the intended purpose. The volume average particle diameter (D4) is preferably 3 μm or greater and 7 μm or less.

Moreover, a ratio (D4/Dn) of the volume average particle diameter (D4) of the resin particles to a number average particle diameter (Dn) of the resin particles is not particularly limited, and may be appropriately selected according to the intended purpose. The ratio (D4/Dn) is preferably 1.2 or less.

Moreover, the resin particles preferably include the population of the resin particles having the volume average particle diameter of 2 μm or less in an amount of 1% by number or greater and 10% by number or less.

The volume average particle diameter (D4), number average particle diameter (Dn), and ratio (D4/Dn) of the resin particles may be measured, for example, by COULTER COUNTER TA-II or COULTER MULTISIZER II (both available from Beckman Coulter, Inc.). In the present specification, the volume average particle diameter (D4), number average particle diameter (Dn), and ratio (D4/Dn) are values measured by COULTER MULTISIZER II. A measuring method for the volume average particle diameter (D4), number average particle diameter (Dn), and ratio (D4/Dn) will be described hereinafter.

First, 0.1 mL to 5 mL of a surfactant (preferably polyoxyethylene alkyl ether (a nonionic surfactant)) serving as a dispersing agent is added to 100 mL to 150 mL of an electrolyte aqueous solution to prepare a mixed solution. To the mixed solution, 2 mg to 20 mg of a sample is added. The electrolyte aqueous solution, in which the sample is suspended, is dispersed for about 1 minute to about 3 minutes by an ultrasonic disperser, and the volume and number of the resin particles are measured by the measuring device (COULTER MULTISIZER II) using a 100 μm-aperture as an aperture to calculate a volume distribution and number distribution of the resin particles. A volume average particle diameter (D4) and number average particle diameter (Dn) of the resin particles can be determined from the obtained distributions.

The electrolyte aqueous solution is prepared as a 18 by mass sodium chlorate aqueous solution using first grade sodium chloride. For example, ISOTON-II (available from Beckman Coulter, Inc.) may be used as the electrolyte aqueous solution.

As channels, the following 13 channels are used: 2.00 μm or greater and less than 2.52 μm; 2.52 μm or greater and less than 3.17 μm; 3.17 μm or greater and less than 4.00 μm; 4.00 μm or greater and less than 5.04 μm; 5.04 μm or greater and less than 6.35 μm; 6.35 μm or greater and less than 8.00 μm; 8.00 μm or greater and less than 10.08 μm; 10.08 μm or greater and less than 12.70 μm; 12.70 μm or greater and less than 16.00 μm; 16.00 μm or greater and less than 20.20 μm; 20.20 μm or greater and less than 25.40 μm; 25.40 μm or greater and less than 32.00 μm; and 32.00 μm or greater and less than 40.30 μm. The particles having particle diameters of 2.00 μm or greater and less than 40.30 μm are the target for the measurement.

### —Glass Transition Temperature (Tg) and Melting Point (Tm)—

### —Measuring Method of Glass Transition Temperature (Tg) and Melting Point (Tm)—

The glass transition temperature (Tg) and melting point (Tm) described in the present specification can be measured, for example, by a differential scanning calorimeter (DSC) system (“Q-200,” available from TA Instruments Japan Inc.).

Specifically, a glass transition temperature (Tg) and melting point (Tm) of a sample (the resin particles) are measured in the following manner.

First, approximately 5.0 mg of a sample is placed in a sample container formed of aluminum, the sample container is placed on a holder, and the holder is set in an electric furnace. Subsequently, the sample is heated from −80° C. to 150° C. in a nitrogen atmosphere at a heating rate of 10° C./min (first heating). Then, the sample is cooled from 150° C. down to −80° C. at a cooling rate of 10° C./min, followed by again heating up to 150° C. at a heating rate of 10° C./min (second heating). DSC curves of the first heating and the second heating are each measured by a differential scanning calorimeter (Q-200, available from TA Instruments Japan Inc.).

The DSC curve of the first heating is selected from the obtained DSC curves, and a glass transition temperature of the sample from the first heating can be determined using an analysis program installed in the Q-200 system. In a similar manner, the DSC curve of the second heating is selected from the obtained DSC curves, and a glass transition temperature of the sample from the second heating can be determined using the analysis program installed in the Q-200 system.

The DSC curve of the first heating is selected from the obtained DSC curves, and an endothermic peak top temperature of the sample from the first heating can be determined as a melting point using the analysis program installed in the Q-200 system. In a similar manner, the DSC curve of the second heating is selected from the obtained DSC curves, and an endothermic peak top temperature of the sample from the second heating can be determined as a melting point using the analysis program installed in the Q-200 system.

In the present specification, when the resin particles are used as the sample, the glass transition temperature of the resin particles from the first heating is determined as [Tg1st], and the glass transition temperature of the resin particles from the second heating is determined as [Tg2nd]. For a glass transition temperature and melting point of each of other constituent components, such as the amorphous polyester resin A, the amorphous polyester resin B, the crystalline polyester resin C, and the release agent, an endothermic peak top temperature of each sample from the second heating is determined as a melting point, and Tg of each sample from the second heating is determined as Tg in the present specification, unless otherwise stated.

### —Tg1st (Resin Particles)—

A glass transition temperature [Tg1st (resin particles)] of the resin particles measured from first heating of differential scanning calorimetry (DSC) is not particularly limited, and may be appropriately selected according to the intended purpose. In view of low-temperature fixability, the glass transition temperature [Tg1st (resin particles)] is preferably 20° C. or higher and 50° C. or lower, more preferably 35° C. or higher and 45° C. or lower. When the glass transition temperature [Tg1st (resin particles)] is 20° C. or higher, desirable heat resistant storage stability is achieved, and occurrences of blocking inside a developing device and filming on a photoconductor are minimized. When the glass transition temperature [Tg1st (resin particles)] is 50° C. or lower, desirable low-temperature fixability of resulting resin particles is achieved.

If a glass transition temperature (Tg) of a typical toner available in the related art is 50° C. or lower, particles of such a toner tend to aggregate due to temperature fluctuations that occur during transportation of the toner or in a storage environment, such as during summer or in tropical regions. As a result, the toner particles are fused and solidified with one another inside a toner bottle, or are adhered to an interior wall of a developing device. Moreover, a toner-supply failure may occur due to clogging of the toner bottle with the toner, and defective images may be formed due to adhesion of the toner inside the developing device.

The toner including the resin particles can maintain desirable heat resistant storage stability even if a glass transition temperature (Tg) of the toner is lower than a glass transition temperature of a typical toner available in the related art, as long as the amorphous polyester resin A, which is a low Tg component in the resin particles, has a non-linear structure. Especially when the amorphous polyester resin A includes a urethane bond or urea bond having a high cohesive force, an effect of retaining heat-resistant storage stability becomes more significant.

### —[Tg2nd (Resin Particles)]—

A glass transition temperature [Tg2nd (resin particles)] of the resin particles measured from second heating of differential scanning calorimetry (DSC) is not particularly limited, and may be appropriately selected according to the intended purpose. The glass transition temperature [Tg2nd (resin particles)] is preferably 0° C. or higher and 30° C. or lower, more preferably 0° C. or higher and 15° C. or lower. When the glass transition temperature [Tg2nd (resin particles)] is 0° C. or higher, desirable blocking resistance of fixed images (printed products) can be achieved. When the glass transition temperature [Tg2nd (resin particles)] is 30° C. or lower, desirable low-temperature fixability or glossiness can be achieved.

For example, the glass transition temperature [Tg2nd (resin particles)] may be adjusted by adjusting Tg and an amount of the crystalline resin.

### —Difference [[Tg1st (Resin Particles)]−[Tg2nd (Resin Particles)]]—

A difference [[Tg1st (resin particles)]-[Tg2nd (resin particles)]] between the glass transition temperature of the resin particles [Tg1st (resin particles)] as measured from the first heating of the differential scanning calorimetry (DSC) and the glass transition temperature of the resin particles [Tg2nd (resin particles)] as measured from the second heating of the DSC is not particularly limited, and may be appropriately selected according to the intended purpose. The difference [[Tg1st (resin particles)]−[Tg2nd (resin particles)]] is preferably 10° C. or greater. The upper limit of the difference [[Tg1st (resin particles)]−[Tg2nd (resin particles)]] is not particularly limited, and may be appropriately selected according to the intended purpose. The upper limit is preferably 50° C. or less.

The difference [Tg1st (resin particles)]-[Tg2nd (resin particles)] being 10° C. or greater is advantageous because excellent low-temperature fixability of the resin particles is achieved. Moreover, the difference [Tg1st (resin particles)]−[Tg2nd (resin particles)] being 10° C. or greater indicates that the crystalline polyester resin C and a combination of the amorphous polyester resin A and the amorphous polyester resin B present in a non-compatible state before heating (before the first heating) turns into a compatible state (co-melted state) after heating (after the first heating). The compatible state (co-melted state) after heating does not need to be a completely compatible state.

### —Tg2nd (THF-Insoluble Component)—

The glass transition temperature of the tetrahydrofuran (THF)-insoluble component of the resin particles [Tg2nd (THF-insoluble component)] as measured from the second heating of the differential scanning calorimetry (DSC) is not particularly limited, and may be appropriately selected according to the intended purpose. The glass transition temperature of the THF-insoluble component [Tg2nd (THF-insoluble component)] is preferably −40° C. or higher and 30° C. or lower, more preferably 0° C. or higher and 20° C. or lower. When the glass transition temperature of the THF-insoluble component [Tg2nd (THF-insoluble component)] is −40° C. or higher, desirable blocking resistance of fixed images (printed products) can be achieved. When the glass transition temperature of the THF-insoluble component [Tg2nd (THF-insoluble component)] is 30° C. or lower, desirable low-temperature fixability or glossiness can be achieved.

The glass transition temperature of the THF-insoluble component [Tg2nd (THF-insoluble component)] can be adjusted, for example, by changing the number of carbon atoms in the multivalent alcohol or multivalent carboxylic acid of the amorphous polyester resin A.

### —Melting Point (Tm)—

A melting point (Tm) of the resin particles is not particularly limited, and may be appropriately selected according to the intended purpose. The melting point is preferably 60° C. or higher and 80° C. or lower.

### —Storage Elastic Modulus—

### —Measuring Method of Storage Elastic Modulus G′—

Storage elastic moduli (G′) under various conditions may be measured, for example, by a dynamic viscoelastic measuring device (ARES, available from TA Instruments Japan Inc.). A frequency used for the measurement is 1 Hz.

Specifically, a sample is molded into a pellet having a diameter of 8 mm and a thickness of from 1 mm to 2 mm. After fixing the prepared pellet sample onto a parallel plate having a diameter of 8 mm, the sample is stabilized at 40° C. and heated to 200° C. at a heating rate of 2.0° C./min at a frequency of 1 Hz (6.28 rad/s) and deformation of 0.1% (with a deformation control mode) to measure a storage elastic modulus.

In the present specification, a storage elastic modulus measured at 40° C. may be represented as [G′ (40)], and a storage elastic modulus measured at 100° C. may be represented as [G′ (100)].

### —[G′ (100) (THF-Insoluble Component)] and [[G′ (40) (THF-Insoluble Component)]/[G′ (100) (THE-Insoluble Component)]]—

The storage elastic modulus of the tetrahydrofuran (THF)-insoluble component of the resin particles at 100° C.[G′ (100) (THF-insoluble component)] is not particularly limited, and may be appropriately selected according to the intended purpose. The storage elastic modulus [G′ (100) (THF-insoluble component)] is preferably from 1.0×10⁵ Pa to 1.0×10⁷ Pa, more preferably from 5.0×10⁵ Pa to 5.0×10⁶ Pa. The storage elastic modulus [G′ (100) (THF-insoluble component)] in the more preferred range is advantageous because excellent low-temperature fixability is achieved.

A ratio [[G′ (40) (THF-insoluble component)]/[G′ (100) (THF-insoluble component)]] of the storage elastic modulus of the THF-insoluble component of the resin particles at 40° C. [G′ (40) (THF-insoluble component)] to the storage elastic modulus of the THF-insoluble component of the resin particles at 100° C.[G′ (100) (THF-insoluble component)] is not particularly limited, and may be appropriately selected according to the intended purpose. The ratio [[G′ (40) (THF-insoluble component)]/[G′ (100) (THF-insoluble component)]] is preferably 3.5×10 or less. When the ratio [[G′ (40) (THF-insoluble component)]/[G′ (100) (THF-insoluble component)]] is 3.5×10 or less, desirable low-temperature fixability is achieved.

Moreover, the resin particles having the [G′ (100) (THF-insoluble component)] of from 1.0×10⁵ Pa to 1.0×10⁷ Pa and the ratio [[G′ (40) (THF-insoluble component)]/[G′ (100) (THF-insoluble component)]] of 3.5×10 or less are advantageous because compatibility between the crystalline polyester resin and the amorphous polyester resin, which is a high Tg component, is improved, a ½ method temperature as measured by a capillary rheometer (Flow tester) is lowered, and gloss of images formed with the resin particles is improved.

For example, the [G′ (100) (THF-insoluble component)] and the [G′ (40) (THF-insoluble component)] can be adjusted with the composition of the resin (a bifunctional or higher multivalent alcohol component and a bifunctional or higher multivalent acid component).

Specifically, the [G′ (100) (THF-insoluble component)] and the [G′ (40) (THF-insoluble component)] can be adjusted, for example, in the following manner. In order to increase a value of the storage elastic modulus [G′], an adjustment is made by shortening a distance between ester bonds in a molecular structure of the resin, or changing a composition of the resin to include aromatic rings. In order to decrease a value of the storage elastic modulus [G′], an adjustment is made by using a linear polyester resin, or using a multivalent alcohol including an alkyl group at a side chain as one of constituent components of a polyester resin.

### —THF-Insoluble Component—

The THF-insoluble component contained in the resin particles can be obtained in the following manner.

To 100 parts of tetrahydrofuran (THF), 1 part of the resin particles are added. After refluxing the resulting mixture for 6 hours, the mixture is subjected to centrifuge separation by a centrifuge to precipitate an insoluble component to separate the mixture into the insoluble component and a supernatant to thereby obtain the THF-insoluble component.

### —Measurement of Molecular Weight—

A molecular weight of each constituent component of the resin particles can be measured, for example, under the following analysis conditions.

### [Analysis Conditions]

Gel permeation chromatography (GPC) system: GPC-8220GPC (available from Tosoh Corporation)
Columns: 3 columns connected, TSKgel® SuperHZM-H 15 cm (available from Tosoh Corporation)
Temperature: 40° C.
Detector: refractive index (RI) detector
Solvent: chloroform
Feeding rate: 0.35 mL/min
Sample: injecting 100 μL of a 0.1% by mass sample
Pretreatment of sample: The resin particles are dissolved in chloroform at a concentration of 0.1% by mass, followed by stirring for 30 minutes at 25° C. to prepare a solution in which the soluble component of the resin particles is dissolved. The prepared solution is filtered with a membrane filter having an opening size of 0.2 μm, and the obtained filtrate is used as a chloroform sample solution. The chloroform sample solution (100 μL) is injected to carry out measurement.

To measure a molecular weight of the sample, a molecular weight distribution of the sample is calculated from a relation between logarithmic values and count numbers of calibration curves prepared using several monodisperse polystyrene standard samples. As standard polystyrene samples for preparing calibration curves, for example, Showdex® STANDARD (available from SHOWA DENKO K. K.) Std. Nos. S-6550, S-1700, S-740, S-321, S-129, S-10, S-2.9, and S-0.6 are used.

A production method for the amorphous polyester aqueous dispersion liquid is not particularly limited, and is preferably the below-described method for producing an aqueous dispersion liquid of an amorphous polyester resin of the present disclosure.

### (Method for Producing Aqueous Dispersion Liquid of Amorphous Polyester Resin)

As described above, the method for producing an aqueous dispersion liquid of an amorphous polyester resin includes: Step A) dissolving or dispersing the amorphous polyester resin of the present disclosure in an organic solvent to prepare an oil phase (may be referred to as an “oil phase preparation step” hereinafter), and Step B) adding an aqueous medium to the oil phase to cause phase inversion from a water-in-oil dispersion liquid to an oil-in-water dispersion liquid to obtain an aqueous dispersion liquid including the amorphous polyester resin as dispersed particles, and the aqueous medium as a dispersion medium (may be referred to as a “phase inversion emulsification step” hereinafter). The method may further include other steps, such as an aqueous phase preparation step and a solvent removing step, as necessary.

### <Oil Phase Preparation Step>

The oil phase preparation step includes dissolving or dispersing of at least the amorphous polyester resin of the present disclosure in an organic solvent to prepare an oil phase. The amorphous polyester resin is a sulfo group-containing amorphous polyester resin.

The amorphous polyester resin of the present disclosure is as described in the section of <Amorphous polyester resin A> of (Resin particles). The oil phase includes the amorphous polyester resin A.

The organic solvent is not particularly limited, and may be appropriately selected according to the intended purpose. The organic solvent is preferably an organic solvent having a boiling point of lower than 150° C. because such an organic solvent can be removed easily.

The organic solvent having a boiling point of lower than 150° C. is not particularly limited, and may be appropriately selected according to the intended purpose. Examples of the organic solvent having a boiling point of lower than 150° C. include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. The above-listed examples may be used alone or in combination. Among the above-listed examples, the organic solvent is preferably ethyl acetate, toluene, xylene, benzene, methylene chloride, 1,2-dichloroethane, chloroform, or carbon tetrachloride, more preferably ethyl acetate.

An amount of the organic solvent used is not particularly limited, and may be appropriately selected according to the intended purpose. The amount of the organic solvent relative to 100 parts by mass of the raw materials of the resin particles is preferably from 40 parts by mass to 300 parts by mass, more preferably from 60 parts by mass to 140 parts by mass, and yet more preferably from 80 parts by mass to 120 parts by mass.

A production method of the oil phase is not particularly limited, and may be appropriately selected according to the intended purpose. Examples of the production method include a method where materials for the oil phase are gradually added into the organic solvent, while stirring the organic solvent, to dissolve or disperse the materials in the organic solvent.

For the dispersing, any of devices available in the related art may be used. For example, a disperser, such as a bead mill and a disk mill, may be used.

### <Aqueous Phase (Aqueous Medium) Preparation Step>

The aqueous phase preparation step includes preparation of an aqueous phase (aqueous medium).

The aqueous medium is not particularly limited, and may be appropriately selected according to the intended purpose. Examples of the aqueous medium include water, solvents miscible with water, and mixtures of any combination of the foregoing media. The above-listed examples may be used alone or in combination. Among the above-listed examples, water is preferred.

The solvents miscible with water are not particularly limited, and may be appropriately selected according to the intended purpose. Examples of the solvents miscible with water include alcohols, dimethyl formamide, tetrahydrofuran, ethyl acetate, cellosolves, and lower ketones.

The alcohols are not particularly limited, and may be appropriately selected according to the intended purpose. Examples of the alcohols include methanol, isopropanol, and ethylene glycol.

The lower ketones are not particularly limited, and may be appropriately selected according to the intended purpose. Examples of the lower ketones include acetone and methyl ethyl ketone.

### <Phase Inversion Emulsification Step>

The phase inversion emulsification step includes addition of an aqueous medium to the oil phase to cause phase inversion from a water-in-oil dispersion liquid to an oil-in-water dispersion liquid to obtain an aqueous dispersion liquid including the amorphous polyester resin as dispersed particles (oil droplets), and the aqueous medium as a dispersion medium.

A method for causing phase inversion emulsification of the amorphous polyester resin A in the aqueous medium is not particularly limited, and may be appropriately selected according to the intended purpose. Examples of the method include a method where the oil phase is neutralized with a base, followed by adding the aqueous phase to the neutralized oil phase, to cause phase inversion emulsification from the water-in-oil dispersion liquid to the oil-in-water dispersion liquid to obtain an aqueous dispersion liquid of the amorphous polyester resin.

The base used for neutralizing the oil phase may be a basic inorganic compound or a basic organic compound. Examples of the basic inorganic compound include sodium hydroxide, potassium hydroxide, lithium hydroxide, ammonia, sodium carbonate, sodium bicarbonate, potassium carbonate, and potassium bicarbonate. Examples of the basic organic compound include N, N-dimethylethanolamine, N, N-diethylethanolamine, triethanolamine, tripropanolamine, tributanolamine, triethylamine, n-propylamine, n-butylamine, isopropylamine, monomethanolamine, morpholine, methoxypropylamine, pyridine, vinyl pyridine, and isophoronediamine.

The neutralization of the oil phase may be performed, while the oil phase is homogeneously mixed or dispersed by a typical stirrer or disperser. The disperser is not particularly limited. Examples of the disperser include ultrasonic dispersers, bead mills, ball mills, roll mills, homomixers, ultramixers, disperse mixers, penetration-type high-pressure dispersers, collision-type high-pressure dispersers, porous-type high-pressure dispersers, ultrahigh-pressure homogenizers, and ultrasonic homogenizers. A typical stirrer and a typical disperser may be used in combination.

When the phase inversion emulsification of the oil phase including the amorphous polyester resin A is performed, an amount of the aqueous medium used is not particularly limited, and may be appropriately selected according to the intended purpose. The amount of the aqueous medium relative to 100 parts by mass of the amorphous polyester resin A is preferably 50 parts by mass or greater and 2,000 parts by mass or less, more preferably 100 parts by mass or greater and 1,000 parts by mass or less. When the amount of the aqueous medium is 50 parts by mass or greater relative to 100 parts by mass of the amorphous polyester resin A, a desirable dispersion state of the amorphous polyester resin A is achieved so that the aqueous dispersion liquid of the amorphous polyester resin, in which the dispersed particles having the predetermined particle diameters are dispersed, is obtained. When the amount of the aqueous medium is 2,000 parts by mass or less relative to 100 parts by mass of the amorphous polyester resin A, the production cost remains the minimum.

When the phase inversion emulsification of the oil phase including the amorphous polyester resin A is carried out, a dispersing agent may be used to stabilize dispersed particles, such as oil droplets, to form desired shapes of the dispersed particles and to achieve a sharp particle size distribution of the dispersed particles.

The dispersing agent is not particularly limited, and may be appropriately selected according to the intended purpose. Examples of the dispersing agent include surfactants, poorly water-soluble inorganic compound dispersing agents, and polymer-based protective colloids. The above-listed examples may be used alone or in combination. Among the above-listed examples, the dispersing agent is preferably a surfactant.

The surfactant is not particularly limited, and may be appropriately selected according to the intended purpose. For example, the surfactant is an anionic surfactant, a cationic surfactant, a nonionic surfactant, or an amphoteric surfactant.

The anionic surfactant is not particularly limited, and may be appropriately selected according to the intended purpose. Examples of the anionic surfactant include alkyl benzene sulfonic acid salts, α-olefin sulfonic acid salts, and phosphoric acid esters. Among the above-listed examples, the anionic surfactant is preferably a fluoroalkyl group-containing anionic surfactant.

The phase inversion emulsification can be performed using a stirring blade.

The stirring blade is not particularly limited, and may be appropriately selected according to a viscosity of a solution to be stirred. Examples of the stirring blade include anchor blades, turbine blades, Pfaudler blades, FULLZONE blades, MAXBLEND blades, and semicircular blades.

When the stirring blade is used, a circumferential speed of the stirring blade is not particularly limited, and may be appropriately selected according to the intended purpose. The circumferential speed is preferably from 0.4 m/sec to 2.0 m/sec, more preferably from 0.7 m/sec to 1.5 m/sec.

A volume average particle diameter of the dispersed particles (oil droplets) of the amorphous polyester resin is not particularly limited, and may be appropriately selected according to the intended purpose. The volume average particle diameter is preferably from 20 nm to 200 nm, more preferably from nm to 100 nm.

### <Solvent Removing Step>

The solvent removing step includes removal of the organic solvent from the dispersed particles of the amorphous polyester resin A obtained in the phase inversion emulsification step.

A method for removing the organic solvent from the dispersed particles of the amorphous polyester resin is not particularly limited, and may be appropriately selected according to the intended purpose. Examples of the method include: a method where an entire reaction system is gradually heated to evaporate the organic solvent included in the dispersed particles (oil droplets); a method where the aqueous dispersion liquid is sprayed into a dry atmosphere to remove the organic solvent in the dispersed particles (oil droplets); and a method where the pressure of the aqueous dispersion liquid is reduced to evaporate the organic solvent in the dispersed particles. The above-listed examples may be used alone or in combination.

The dry atmosphere into which the dispersion liquid is sprayed is not particularly limited, and may be appropriately selected according to the intended purpose. Examples of the dry atmosphere include heated gases, such as air, nitrogen, carbon dioxide, and a combustion gas. Any of various gas flows, which is heated to a temperature equal to or higher than the highest boiling point among boiling points of solvents used, is typically used.

The solvent removing step may be performed by a device. For example, a spray drier, a belt drier, or a rotary kiln may be used. As the device is used, the intended quality is sufficiently achieved with a short process time.

### (Method for Producing Resin Particles)

The method for producing resin particles of the present disclosure includes: Step a) dissolving or dispersing at least an amorphous polyester resin in an organic solvent to prepare an oil phase (may be referred to as an “oil phase preparation step” hereinafter); Step b) adding an aqueous medium to the oil phase to cause phase inversion from a water-in-oil dispersion liquid to an oil-in-water dispersion liquid where the oil phase is dispersed as dispersed particles in the aqueous medium (may be referred to as a “phase inversion emulsification step” hereinafter); Step c) aggregating the dispersed particles in the oil-in-water dispersion liquid (may be referred to as an “aggregating step” hereinafter); and Step d) after Step c), adding the aqueous dispersion liquid of the amorphous polyester resin of the present disclosure to aggregate the amorphous polyester resin in the aqueous dispersion liquid to form a shell layer on each of the aggregated particles obtained in Step c) (may be referred to as a “shell layer forming step” hereinafter). The method may further include other steps, such as an aqueous phase preparation step, a solvent removing step, a fusing step, a washing step, a drying step, a classification step, an annealing step, as necessary.

### <Oil Phase Preparation Step>

The oil phase preparation step includes dissolving or dispersing of at least an amorphous polyester resin in an organic solvent.

The amorphous polyester resin is described in the section of <Amorphous polyester resin B> of (Resin particles). The oil phase includes the amorphous polyester resin B.

The oil phase may further include the crystalline polyester resin, the colorant, and the release agent, as necessary.

The organic solvent is not particularly limited, and may be appropriately selected according to the intended purpose. The organic solvent is preferably an organic solvent having a boiling point of lower than 150° C. because such an organic solvent can be removed easily.

The organic solvent having a boiling point of lower than 150° C. is not particularly limited, and may be appropriately selected according to the intended purpose. Examples of the organic solvent having a boiling point of lower than 150° C. include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. The above-listed examples may be used alone or in combination. Among the above-listed examples, the organic solvent is preferably ethyl acetate, toluene, xylene, benzene, methylene chloride, 1,2-dichloroethane, chloroform, or carbon tetrachloride, more preferably ethyl acetate.

An amount of the organic solvent used is not particularly limited, and may be appropriately selected according to the intended purpose. The amount of the organic solvent relative to 100 parts by mass of the raw materials of the resin particles is preferably from 40 parts by mass to 300 parts by mass, more preferably from 60 parts by mass to 140 parts by mass, and yet more preferably from 80 parts by mass to 120 parts by mass.

A production method of the oil phase is not particularly limited, and may be appropriately selected according to the intended purpose. Examples of the production method include a method where materials for the oil phase are gradually added into the organic solvent, while stirring the organic solvent, to dissolve or disperse the materials in the organic solvent.

For the dispersing, any of devices known in the related art may be used. For example, a disperser, such as a bead mill and a disk mill, may be used.

### <Aqueous Phase (Aqueous Medium) Preparation Step>

The aqueous phase preparation step includes preparation of an aqueous phase (aqueous medium).

The aqueous medium is not particularly limited, and may be appropriately selected according to the intended purpose. Examples of the aqueous medium include water, solvents miscible with water, and mixtures of any combination of the foregoing media. The above-listed examples may be used alone or in combination. Among the above-listed examples, water is preferred.

The solvents miscible with water are not particularly limited, and may be appropriately selected according to the intended purpose. Examples of the solvents miscible with water include alcohols, dimethyl formamide, tetrahydrofuran, ethyl acetate, cellosolves, and lower ketones.

The alcohols are not particularly limited, and may be appropriately selected according to the intended purpose. Examples of the alcohols include methanol, isopropanol, and ethylene glycol.

The lower ketones are not particularly limited, and may be appropriately selected according to the intended purpose. Examples of the lower ketones include acetone and methyl ethyl ketone.

### <Phase Inversion Emulsification Step>

The phase inversion emulsification step includes addition of an aqueous medium to the oil phase to cause phase inversion from a water-in-oil dispersion liquid to an oil-in-water dispersion liquid. As a result, a particle dispersion liquid (the oil-in-water dispersion liquid), in which the oil phase is dispersed as dispersed particles (oil droplets) in the aqueous medium, is obtained.

A method for causing phase inversion emulsification of the dispersion liquid including the amorphous polyester resin B in the aqueous medium is not particularly limited, and may be appropriately selected according to the intended purpose. Examples of the method include a method where the oil phase is neutralized with a base, followed by adding the aqueous phase to the neutralized oil phase, to cause phase inversion emulsification from the water-in-oil dispersion liquid to the oil-in-water dispersion liquid to obtain a particle dispersion liquid.

The base used for neutralizing the oil phase may be a basic inorganic compound or a basic organic compound. Examples of the basic inorganic compound include sodium hydroxide, potassium hydroxide, lithium hydroxide, ammonia, sodium carbonate, sodium bicarbonate, potassium carbonate, and potassium bicarbonate. Examples of the basic organic compound include N, N-dimethylethanolamine, N, N-diethylethanolamine, triethanolamine, tripropanolamine, tributanolamine, triethylamine, n-propylamine, n-butylamine, isopropylamine, monomethanolamine, morpholine, methoxypropylamine, pyridine, vinyl pyridine, and isophoronediamine.

The neutralization of the oil phase may be performed, while the oil phase is homogeneously mixed or dispersed by a typical stirrer or disperser. The disperser is not particularly limited. Examples of the disperser include ultrasonic dispersers, bead mills, ball mills, roll mills, homomixers, ultramixers, disperse mixers, penetration-type high-pressure dispersers, collision-type high-pressure dispersers, porous-type high-pressure dispersers, ultrahigh-pressure homogenizers, and ultrasonic homogenizers. A typical stirrer and a typical disperser may be used in combination.

When the phase inversion emulsification of the oil phase including constituent materials of the resin particles is performed, an amount of the aqueous medium used is not particularly limited, and may be appropriately selected according to the intended purpose. The amount of the aqueous medium relative to 100 parts by mass of the constituent materials of the resin particle material is preferably 50 parts by mass or greater and 2,000 parts by mass or less, more preferably 100 parts by mass or greater and 1,000 parts by mass or less. When the amount of the aqueous medium is 50 parts by mass or greater relative to 100 parts by mass of the constituent materials of the resin particles, a desirable dispersion state of the constituent materials of the resin particles is achieved so that the resin particles having the predetermined particle diameters can be obtained. When the amount of the aqueous medium is 2,000 parts by mass or less relative to 100 parts by mass of the constituent materials of the resin particles, the production cost remains the minimum.

When the phase inversion emulsification of the oil phase including the constituent materials of the resin particles is carried out, a dispersing agent may be used to stabilize dispersed particles, such as oil droplets, to form desired shapes of the dispersed particles and to achieve a sharp particle size distribution of the dispersed particles.

The dispersing agent is not particularly limited, and may be appropriately selected according to the intended purpose. Examples of the dispersing agent include surfactants, poorly water-soluble inorganic compound dispersing agents, and polymer-based protective colloids. The above-listed examples may be used alone or in combination. Among the above-listed examples, the dispersing agent is preferably a surfactant.

The surfactant is not particularly limited, and may be appropriately selected according to the intended purpose. For example, the surfactant is an anionic surfactant, a cationic surfactant, a nonionic surfactant, or an amphoteric surfactant.

The anionic surfactant is not particularly limited, and may be appropriately selected according to the intended purpose. Examples of the anionic surfactant include alkyl benzene sulfonic acid salts, α-olefin sulfonic acid salts, and phosphoric acid esters. Among the above-listed examples, the anionic surfactant is preferably a fluoroalkyl group-containing anionic surfactant.

The phase inversion emulsification can be performed using a stirring blade.

The stirring blade is not particularly limited, and may be appropriately selected according to a viscosity of a solution to be stirred. Examples of the stirring blade include anchor blades, turbine blades, Pfaudler blades, FULLZONE blades, MAXBLEND blades, and semicircular blades.

When the stirring blade is used, a circumferential speed of the stirring blade is not particularly limited, and may be appropriately selected according to the intended purpose. The circumferential speed is preferably from 0.4 m/sec to 2.0 m/sec, more preferably from 0.7 m/sec to 1.5 m/sec.

A volume average particle diameter of the dispersed particles (oil droplets) in the particle dispersion liquid is not particularly limited, and may be appropriately selected according to the intended purpose. The volume average particle diameter is preferably from 50 nm to 2,000 nm, more preferably from 50 nm to 500 nm.

### <Solvent Removing Step>

The solvent removing step includes removal of the organic solvent from the dispersed particles in the particle dispersion liquid obtained in the phase inversion emulsification step to obtain base particles.

A method for removing the organic solvent from the dispersed particles in the particle dispersion liquid is not particularly limited, and may be appropriately selected according to the intended purpose. Examples of the method include: a method where an entire reaction system is gradually heated to evaporate the organic solvent included in the dispersed particles (oil droplets); a method where the particle dispersion liquid is sprayed into a dry atmosphere to remove the organic solvent in the dispersed particles (oil droplets); and a method where the pressure of the particle dispersion liquid is reduced to evaporate the organic solvent in the dispersed particles. The above-listed examples may be used alone or in combination.

The dry atmosphere into which the dispersion liquid is sprayed is not particularly limited, and may be appropriately selected according to the intended purpose. Examples of the dry atmosphere include heated gases, such as air, nitrogen, carbon dioxide, and a combustion gas. Any of various gas flows, which is heated to a temperature equal to or higher than the highest boiling point among boiling points of solvents used, is typically used.

The solvent removing step may be performed by a device. For example, a spray drier, a belt drier, or a rotary kiln may be used. As the device is used, the intended quality is sufficiently achieved with a short process time.

### <Aggregating Step>

The aggregating step includes aggregation of the particles in the oil-in-water dispersion liquid to form aggregated particles.

A method for aggregating the oil droplets or the base particles is not particularly limited, and may be appropriately selected from methods available in the related art according to the intended purpose. Examples of the method include a method of adding an aggregating agent and a method of adjusting pH.

The aggregating agent is not particularly limited, and may be appropriately selected according to the intended purpose. Examples of the aggregating agent include aluminum chloride, zinc sulfate, magnesium sulfate, aluminum sulfate, aluminum potassium sulfate, sodium chloride, sodium bromide, sodium iodide, sodium fluoride, sodium acetate, sodium acetoacetate, lithium chloride, lithium bromide, lithium iodide, lithium fluoride, lithium acetate, lithium acetoacetate, potassium chloride, potassium bromide, potassium iodide, potassium fluoride, potassium acetoacetate, magnesium bromide, magnesium chloride, magnesium iodide, magnesium fluoride, magnesium acetate, magnesium acetoacetate, calcium chloride, calcium bromide, barium bromide, barium chloride, barium iodide, barium fluoride, barium acetate, barium acetoacetate, strontium bromide, strontium chloride, strontium iodide, strontium fluoride, strontium acetate, strontium acetoacetate, zinc bromide, zinc chloride, zinc iodide, zinc fluoride, zinc acetate, zinc acetoacetate, copper bromide, copper chloride, copper iodide, copper fluoride, copper acetate, copper acetoacetate, iron bromide, iron chloride, iron iodide, iron fluoride, iron acetate, and iron acetoacetate. The above-listed examples may be used alone or in combination. Among the above-listed examples, the aggregating agent is preferably a divalent or higher metal salt, more preferably a trivalent metal salt. Since the divalent or higher metal salt is used, carboxyl groups included in the amorphous polyester resin B and the metal salt form a three-dimensional structure through metal ionic cross-linking. As a result, strength of the aggregated particles is improved, leading to improved filming resistance.

When the aggregating agent is added, the aggregating agent may be added as it is, but the aggregating agent is preferably added as an aqueous solution of the aggregating agent because the aggregating agent can be distributed evenly without leaving highly concentrated areas. Moreover, the aggregating agent (e.g., the metal salt) is preferably added gradually while carefully monitoring the particle diameters of the aggregated particles.

A temperature of the reaction system for carrying out the aggregating step (a temperature of the particle dispersion liquid during aggregating) is not particularly limited, and may be appropriately selected according to the intended purpose. The temperature is preferably a temperature close to a glass transition temperature (Tg) of the amorphous polyester resin B. When the temperature is too low, aggregation progresses very slowly, which may lead to inadequate production efficiency. When the temperature is too high, the aggregation speed is too fast, which may cause formation of aggregated particles having an undesirable particle size distribution, such as formation of coarse particles.

The aggregating step includes termination of the aggregation after the aggregated particles reach the predetermined particle diameters.

A method for terminating the aggregation is not particularly limited, and may be appropriately selected according to the intended purpose. Examples of the method include: a method where a salt having an ionic valence lower than the ionic valence of the aggregating agent (e.g., the metal salt) or a chelating agent is added; a method where pH is adjusted; a method where a temperature of the reaction system (particle dispersion liquid) during the aggregation is reduced; and a method where a large amount of the aqueous medium is added to reduce a concentration of the reaction system (particle dispersion liquid) during the aggregation. The above-listed examples may be used alone or in combination.

A volume average particle diameter of the aggregated particles is not particularly limited, and may be appropriately selected according to the intended purpose. The volume average particle diameter is preferably from 3.0 μm to 6.0 μm, more preferably from 4.0 μm to 5.0 μm.

During the aggregation step, a release agent may be added, or the crystalline resin may be added to impart low-temperature fixability.

As the release agent, any of the release agents described in the section of <<Release agent>> of (Resin particles) may be used.

As the crystalline resin, any of the crystalline resins described in the section of <Crystalline resin> of (Resin particles) may be used.

When the release agent or the crystalline resin is added during the aggregating step, a dispersion liquid, in which the release agent is dispersed in an aqueous medium, or a dispersion liquid, in which the crystalline polyester resin C is dispersed in an aqueous medium, is prepared, the prepared dispersion liquid of the release agent or the crystalline polyester resin C is mixed with the particle (oil droplet) dispersion liquid, followed by aggregating the particles, to obtain aggregated particles in each of which the release agent or the crystalline polyester resin C is homogeneously dispersed.

The particle diameter of the release agent dispersed in the dispersion liquid is not particularly limited, and may be appropriately selected according to the intended purpose. The dispersed particle diameter of the release agent is preferably 50 nm or greater and 600 nm or less, more preferably 50 nm or greater and 300 nm or less.

In the present specification, the particle diameter of the release agent dispersed in the dispersion liquid is represented by a volume average particle diameter.

A particle diameter of the crystalline resin dispersed in the dispersion liquid is not particularly limited, and may be appropriately selected according to the intended purpose. The dispersed particle diameter of the crystalline resin is preferably 50 nm or greater and 600 nm or less, more preferably 50 nm or greater and 300 nm or less.

In the present specification, the particle diameter of the crystalline resin dispersed in the dispersion liquid is represented by a volume average particle diameter.

The dispersed particle diameters of the release agent and the crystalline resin can be measured, for example, by a particle size distribution analyzer, Nanotrac (UPA-EX150, available from NIKKISO CO., LTD., dynamic light scattering/laser doppler velocimetry).

Specifically, the dispersed particle diameter can be measured in the following manner. The concentration of the dispersion liquid, in which the release agent or the crystalline resin is dispersed, is adjusted to the predetermined measuring concentration range. For the measurement, only a dispersion solvent of the dispersion liquid is measured in advance as a background measurement. According to the above-described measuring method, the particle size as small as several tens of nanometers to several micrometers can be measured.

### (Shell Layer Forming Step)

In order to form a shall layer on each of the aggregated particles serving as core particles, the shell layer forming step includes, after the aggregating step, addition of the aqueous dispersion liquid of the amorphous polyester resin of the present disclosure to aggregate the amorphous polyester resin contained in the aqueous dispersion liquid to form a shell layer on each of the aggregated particles obtained in the aggregating step. The aqueous dispersion liquid of the amorphous polyester resin is the aqueous dispersion liquid of the amorphous polyester resin of the present disclosure and is as described above. Since a shell layer is formed on each of the aggregated particles serving as core layers of resin particles, the crystalline resin or release agent, which may cause filming, can be encapsulated to improve filming resistance.

A method for forming the shell layer is not particularly limited, and may be appropriately selected according to the intended purpose. Examples of the method include a method where, after forming the aggregated particles in the above-described manner, the aqueous dispersion liquid of the amorphous polyester resin is added to the aggregated particles that have reached the predetermined particle diameters.

In the case where the method for producing resin particles includes the solvent removing step, the aqueous dispersion liquid of the amorphous polyester resin may be added after forming aggregated particles of base particles obtained in the solvent removing step.

### <Fusing Step>

The fusing step includes fusing of the aggregated particles to reduce surface irregularities to obtain spherical resin particles. In the case where the aqueous dispersion liquid of the amorphous polyester resin is added to form a shell layer on each of the aggregated particles formed in the aggregating step, the shell layer is formed over a surface of each of the aggregated particles by fusing in the fusing step.

A method for fusing the aggregated particles is not particularly limited, and may be appropriately selected according to the intended purpose. Examples of the method include a method where the dispersion liquid of the aggregated particles is heated while stirring the dispersion liquid.

The heating temperature is not particularly limited, and may be appropriately selected according to the intended purpose. The heating temperature is preferably a temperature that is equal to or higher than Tg of the amorphous polyester resin B and equal to or lower than the Tg of the amorphous polyester resin B+20° C., more preferably a temperature that is equal to or higher than the Tg and equal to or lower than the Tg+10° C. When the heating temperature is the Tg of the amorphous polyester resin B+20° C. or lower, desired affinity between the amorphous polyester resin and the crystalline resin is achieved so that heat resistant storage stability of resulting resin particles is improved.

An average circularity of the resin particles is not particularly limited, and may be appropriately selected according to the intended purpose. When the resin particles are used as a toner, as the average circularity of the resin particles increases, the resin particles roll more smoothly at a developing nip. Therefore, the average circularity of the resin particles is preferably 0.95 or greater, and more preferably 0.96 or greater, because a large amount of the resin particles can be transferred to an electrostatic latent image bearer.

### —Measurement of Average Circularity—

In the present embodiment, an average particle diameter and average circularity may be measured, for example, by a flow particle image analyzer (FPIA-3000, available from SYSMEX CORPORATION).

As a specific measuring method, an average particle diameter and average circularity are measured in the following manner. To 100 mL to 150 mL of water in a container, 0.1 mL to 0.5 mL of a surfactant (preferably an alkyl benzene sulfonic acid salt) serving as a dispersing agent is added. Impure solids have been removed from the water prior to the addition of the surfactant. Then, approximately 0.1 g to approximately 0.5 g of a sample is added to the resulting solution. The resulting suspension liquid, in which the sample is dispersed, is dispersed for approximately 1 minute to approximately 3 minutes by an ultrasonic disperser, and the concentration of the dispersion liquid is adjusted to the range of 3,000 particles/μL to 10,000 particles/μL. The resulting dispersion liquid is measured by the above-mentioned device to determine an average particle diameter, average circularity, and standard deviation (SD) of circularity.

Note that, a circle equivalent diameter is determined as a particle diameter, an average particle diameter is determined using the circle equivalent diameters (number basis), and analysis conditions of the flow particle image analyzer are as follows.

### [Analysis Conditions]

Particle diameter range: 0.5 μm≤ circle equivalent diameter (number basis)≤ 200.0 μm
Particle shape range: 0.93<circularity≤1.00

In the present embodiment, the definition of the average circularity is as follows.

(Average circularity)=(peripheral length of circle having area identical to area of projected image of particle)/(peripheral length of projected image of particle)

### <Washing Step>

The washing step includes washing of the resin particles obtained in the aggregating step or the fusing step.

The dispersion liquid of the resin particles obtained in the above-described manner may include subsidiary materials, such as the aggregating agent, in addition to the resin particles. Therefore, washing is preferably performed to collect only the resin particles from the dispersion liquid of the resin particles.

A method for washing the resin particles is not particularly limited, and may be appropriately selected according to the intended purpose. Examples of the method include centrifugation, filtration under reduced pressure (vacuum filtration), and filter pressing.

A cake of the resin particles may be obtained by any of the above-mentioned washing methods. If washing cannot be adequately performed with one process, the obtained cake may be again dispersed in an aqueous solvent to prepare slurry, and the slurry may be washed by any of the washing methods to collect the resin particles. This series of the processes may be repeated.

When the washing is performed by the vacuum filtration or the filter pressing, an aqueous solvent is penetrated into the cake to wash out subsidiary materials attached to the resin particles.

The aqueous solvent used in the washing step is not particularly limited, and may be appropriately selected according to the intended purpose. Examples of the aqueous solvent include water, and a mixed solvent of water and an alcohol.

Examples of the alcohol include methanol and ethanol.

Among the above-listed examples, the aqueous solvent is preferably water in view of a cost of production and reduction in adverse environmental impacts due to waste water processing.

### <Drying Step>

The drying step includes drying of the resin particles obtained in the washing step.

The resin particles washed in the washing step may include a large amount of the aqueous medium. As the drying is performed to remove the aqueous medium in the drying step, only the resin particles can be collected.

A method for drying is not particularly limited, and may be appropriately selected according to the intended purpose. Examples of the method include a method using a dryer, such as a spray dryer, a vacuum freeze dryer, a vacuum dryer, a static tray dryer, a movable tray dryer, a fluidized bed dryer, a rotary dryer, and a stirring dryer. The final moisture content of the dried resin particles is not particularly limited, and may be appropriately selected according to the intended purpose. The moisture content is preferably less than 1% by mass.

The resin particles dried in the drying step are loosely aggregated. If the aggregation of the resin particles may cause a problem during use, the loosely aggregated resin particles may be crushed to release loose aggregation.

A method for crushing is not particularly limited, and may be appropriately selected according to the intended purpose. Examples of the method include a method using a device, such as a jet mill, HENSCHEL MIXER, a super mixer, a coffee mill, OSTER BLENDER, and a food processor.

### <Classification Step>

The classification step includes classification of the resin particles obtained in the washing step or the drying step.

A method for the classification is not particularly limited, and may be appropriately selected according to the intended purpose. Examples of the method include: a method where a fine particle component is removed by cyclone in a liquid, a decanter, or centrifugation; and a method where the classification is performed according to any of classification methods available in the related art after the drying.

### <Annealing Step>

The annealing step includes annealing performed after the drying step, when the crystalline resin is added. The annealing step is performed to cause phase separation between the crystalline resin and the amorphous polyester resin.

A method for performing the annealing is not particularly limited, and may be appropriately selected according to the intended purpose. Examples of the method include a method where the resin particles are stored at a temperature close to a glass transition temperature (Tg) of the crystalline resin for 10 hours or longer.

When heating is performed at a temperature higher than glass transition temperatures (Tg) of the used resins in the fusing step, the crystalline resin and the amorphous polyester resin may be melted together to form a co-melted state (compatible state) so that both heat resistant storage stability and low-temperature fixability may not be achieved at the same time. As the annealing is performed, however, phase separation between the crystalline resin and the amorphous polyester resin occurs to eliminate the co-melted state. Therefore, the annealing is preferably performed.

### (Toner Resin Particles)

The toner resin particles of the present disclosure include the resin particles of the present disclosure. The toner resin particles each include, as well as the above-described amorphous polyester resin, other components, such as a crystalline resin, a release agent, and a colorant, as necessary.

The toner resin particles of the present disclosure are suitably used for a toner.

### (Toner)

The toner of the present disclosure includes the toner resin particles of the present disclosure, preferably further includes an external additive, and may further include other components, as necessary.

### <Toner Resin Particles>

The toner resin particles are as described in the sections of (Resin particles) and (Toner resin particles), thus detailed description of the toner resin particles is omitted here.

Within the toner, the toner resin particles function as toner base particles.

An amount of the toner resin particles in the toner is not particularly limited, and may be appropriately selected according to the intended purpose. Particles of the toner may be the toner resin particles themselves.

### <External Additive(s)>

The external additives are not particularly limited, and may be appropriately selected according to the intended purpose. Examples of the external additives include inorganic particles, oxide particles, fatty acid metal salts, and any of the foregoing additives to which hydrophobicity is imparted by a hydrophobicity processing. The above-listed examples may be used alone or in combination.

An average particle diameter of primary particles of the inorganic particles is not particularly limited, and may be appropriately selected according to the intended purpose. The average particle diameter of the primary particles of the inorganic particles is preferably 100 nm or less, more preferably 1 nm or greater and 100 nm or less, yet more preferably 3 nm or greater and 70 nm or less, and particularly preferably 5 nm or greater and 70 nm or less. When the average particle diameter of the primary particles of the inorganic particles is 1 nm or greater, the inorganic particles are less likely to become embedded in each of the toner resin particles so that an effect of the inorganic particles may be adequately exhibited. When the average particle diameter of the primary particles of the inorganic particles is 100 nm or less, the inorganic particles are less likely to scratch a surface of a photoconductor unevenly.

Moreover, the inorganic particles preferably include at least one group of inorganic particles that are comprised of primary particles having an average particle diameter of 20 nm or less, and at least another group of inorganic particles that are comprised of primary particles having an average particle diameter of 30 nm or greater.

A BET specific surface area of the inorganic particles is not particularly limited, and may be appropriately selected according to the intended purpose. The BET specific surface area of the inorganic particles is preferably 20 m²/g or greater and 500 m²/g or less.

The inorganic particles are not particularly limited, and may be appropriately selected according to the intended purpose. Examples of the inorganic particles include silica, alumina, titanium oxide, barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. The above-listed examples may be used alone or in combination. Among the above-listed examples, silica or titanium dioxide is preferred.

The oxide particles are not particularly limited, and may be appropriately selected according to the intended purpose. Examples of the oxide particles include titania, alumina, tin oxide, and antimony oxide.

Examples of the fatty acid metal salts include zinc stearate and aluminum stearate. Among the above-listed examples, the external additive is preferably hydrophobized silica particles, hydrophobized titania particles, hydrophobized titanium oxide particles, or hydrophobized alumina particles.

Examples of the silica particles include R972, R974, RX200, RY200, R202, R805, and R812 (all available from NIPPON AEROSIL CO., LTD.).

Examples of the titania particles include: P-25 (available from NIPPON AEROSIL CO., LTD.); STT-30 and STT-65C-S (both available from Titan Kogyo, Ltd.); TAF-140 (available from Fuji Titanium Industry Co., Ltd.); and MT-150W, MT-500B, MT-600B, and MT-150A (all available from TAYCA CORPORATION).

Examples of the hydrophobized titanium oxide particles include: T-805 (available from NIPPON AEROSIL CO., LTD.); STT-30A and STT-65S-S (both available from Titan Kogyo, Ltd.); TAF-500T and TAF-1500T (both available from Fuji Titanium Industry Co., Ltd.); MT-100S and MT-100T (both available from TAYCA CORPORATION); and IT-S (available from ISHIHARA SANGYO KAISHA, LTD.).

For example, the hydrophobized oxide particles, hydrophobized silica particles, hydrophobized titania particles, or hydrophobized alumina particles may be obtained by processing hydrophilic particles with a silane coupling agent (e.g., methyltrimethoxysilane, methyltriethoxysilane, and octyltrimethoxysilane). Moreover, silicone oil-processed oxide particles or silicone oil-processed inorganic particles are suitably used. The silicone oil-processed oxide particles or silicone oil-processed inorganic particles may be obtained by processing oxide particles or inorganic particles with silicone oil, optionally with application of heat. Moreover, the external additive may be subjected to a surface treatment with any of the agents described in <<Flowability improver>> of (Resin particles).

The silicone oil is not particularly limited, and may be appropriately selected according to the intended purpose. Examples of the silicone oil include dimethyl silicone oil, methylphenyl silicone oil, chlorophenyl silicone oil, methyl hydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether-modified silicone oil, phenol-modified silicone oil, carboxy-modified silicone oil, mercapto-modified silicone oil, methacryl-modified silicone oil, and α-methylstyrene-modified silicone oil.

An amount of the external additive(s) is not particularly limited, and may be appropriately selected according to the intended purpose. The amount of the external additive(s) relative to 100 parts by mass of the toner is preferably 0.1 parts by mass or greater and 5 parts by mass or less, more preferably 0.3 parts by mass or greater and 3 parts by mass or less.

A production method for the toner is not particularly limited, and may be appropriately selected from methods known in the related art. The toner is preferably produced by the below-described method for producing a toner of the present disclosure.

### (Method for Producing Toner)

The method for producing a toner of the present disclosure includes a mixing step, and may further include other steps, as necessary. The mixing step includes addition of external additive(s) to the toner resin particles of the present disclosure.

The toner resin particles are as described in the sections of (Resin particles) and (Toner resin particles). The external additive(s) is as described in the section of <External additive(s)> of (Toner). Therefore, the detailed description for the toner resin particles and external additive(s) is omitted here.

### <Mixing Step>

The mixing step includes addition of the external additive(s) to the toner resin particles serving as toner base particles to mix the external additive(s) and the toner resin particles together. In the mixing step, mechanical impacts are preferably applied so that detachment of the external additive(s) from surfaces of the toner base particles can be minimized.

A method for applying the mechanical impacts is not particularly limited, and may be appropriately selected according to the intended purpose. Examples of the method include: a method where an impact force is applied to the mixture of the toner resin particles and the external additive(s) using a blade rotated at high speed; a method where the mixture of the toner resin particles and the external additive(s) is added to a high-speed air flow to accelerate the motion of the particles to make the particles collide with one another or to make the particles collide with a suitable impact board.

A device used in the method for applying mechanical impacts is not particularly limited, and may be appropriately selected according to the intended purpose. Examples of the device include Angmill (available from HOSOKAWA MICRON CORPORATION), devices obtained by modifying an I-type mill (available from Nippon Pneumatic Mfg. Co., Ltd.) to reduce pulverization air pressure, a hybridization system (available from NARA MACHINERY CO., LTD.), Kryptron System (available from Kawasaki Heavy Industries, Ltd.), and automatic mortars.

### (Developer)

The developer of the present disclosure includes at least the toner of the present disclosure, further includes a carrier, and may further include appropriately selected other components, as necessary.

The toner included in the developer of the present disclosure includes the toner resin particles of the present disclosure. Therefore, the developer is environmentally friendly, achieves a high level of carbon neutrality, and has excellent heat-resistant storage stability. Moreover, the developer has excellent characteristics such as transfer properties and charging properties, and can stably form high quality images.

The developer may be a one-component developer or two-component developer. In a case where the developer is used for high-speed printers corresponding to information processing speed that has been improved in recent years, the developer is preferably a two-component developer considering improvement in a service life of the developer.

In a case where the developer is used as a one-component developer without including a carrier, particle diameters of the toner resin particles do not noticeably vary even after replenishing the toner. Therefore, filming of the toner to a developing roller is minimized, or fusion of the toner to a member used for leveling the toner into a thin layer, such as a blade, is minimized. As a result, excellent and stable developing performance and formation of excellent images are achieved even after stirring the developer in a developing device over a long period.

In a case where the developer is used as a two-component developer, particle diameters of the toner resin particles do not noticeably vary even after performing replenishment of the toner over a long period, and excellent and stable developing performance and formation of excellent images are achieved even after stirring the developer in a developing device over a long period.

### <Carrier>

The carrier is not particularly limited, and may be appropriately selected according to the intended purpose. The carrier preferably includes carrier particles, each including a core particle and a resin layer covering the core particle.

### <<Core Particles>>

A material of the core particles is not particularly limited, and may be appropriately selected according to the intended purpose. Examples of the material include manganese-strontium-based materials of from 50 emu/g to 90 emu/g and manganese-magnesium-based materials of from 50 emu/g to 90 emu/g. To achieve adequate image density, a hard-magnetic material, such as iron powder of 100 emu/g or greater and magnetite of from 75 emu/g to 120 emu/g, is preferably used. Moreover, a soft-magnetic material, such as a copper-zinc-based magnetic material of from 30 emu/g to 80 emu/g, is preferably used because an impact of the developer constituting a magnetic brush can be reduced against the photoconductor, and a high image quality can be achieved.

The above-listed examples may be used alone or in combination.

A volume average particle diameter of the core particles is not particularly limited, and may be appropriately selected according to the intended purpose. The volume average particle diameter of the core particles is preferably 10 μm or greater and 150 μm or less, more preferably 40 μm or greater and 100 μm or less. When the volume average particle diameter of the core particles is 10 μm or greater, a proportion of fine particles to the entire amount of the core particles decreases, and the decreased proportion of the fine particles leads to improvement in magnetization per particle, consequently minimizing carrier scattering. When the volume average particle diameter of the core particles is 150 μm or less, a resulting carrier has a sufficient specific surface area to securely carry a toner without causing toner scattering, so that excellent reproducibility of a solid image, especially a full-color solid image having a large solid image area, can be achieved.

When the toner is used for a two-component developer, the toner is mixed with the carrier. An amount of the carrier in the two-component developer is not particularly limited, and may be appropriately selected according to the intended purpose. The amount of the carrier is preferably 90 parts by mass or greater and 98 parts by mass or less, more preferably 93 parts by mass or greater and 97 parts by mass or less, relative to 100 parts by mass of the two-component developer.

The developer is suitably used for image formation according to various electrophotographic methods known in the art, such as a magnetic one-component developing method, a non-magnetic one-component developing method, and a two-component developing method.

### (Image Forming Apparatus and Image Forming Method)

The image forming apparatus of the present disclosure includes an electrostatic latent image bearer, an electrostatic latent image forming mechanism configured to form an electrostatic latent image on the electrostatic latent image bearer, and a developing device that contains a toner and is configured to develop the electrostatic latent image formed on the electrostatic latent image bearer with the toner to form a visible image. The image forming apparatus may further include other devices or members, as necessary. The toner contained in the developing device is the toner of the present disclosure.

An image forming method described in association with the present disclosure includes formation of an electrostatic latent image formed on an electrostatic latent image bearer (electrostatic latent image forming step), and development of the electrostatic latent image formed on the electrostatic latent image bearer with a toner to form a visible image (developing step). The image forming method may further include other steps, as necessary. The toner used in the developing step is the toner of the present disclosure.

The image forming method is suitably performed by the image forming apparatus. The electrostatic latent image forming step is suitably performed by the electrostatic latent image forming mechanism. The developing step is suitably performed by the developing device. The above-mentioned other steps are suitably performed by the above-mentioned other devices or members.

### <Electrostatic Latent Image Bearer>

A material, structure, and size of the electrostatic latent image bearer (may be referred to as a “photoconductor” hereinafter) are not particularly limited, and may be appropriately selected from materials, structures, and sizes available in the related art.

Examples of the material of the electrostatic latent image bearer include inorganic photoconductors and organic photoconductors.

Examples of the inorganic photoconductor include amorphous silicon and selenium.

Examples of the organic photoconductors include polysilane and phthalopolymethine.

Among the above-listed examples, the electrostatic latent image bearer is preferably amorphous silicon in view of a long service life.

As the amorphous silicon photoconductor, an amorphous silicon photoconductor including a support and a photoconductive layer formed of a-Si is used. For example, the photoconductive layer is formed by heating the support at 50° C. to 400° C., and forming a photoconductive layer of a-Si according to a film formation method, such as vacuum vapor deposition, sputtering, ion plating, thermal chemical vapor deposition (CVD), photo CVD, and plasma CVD. Among the above-listed examples, the film formation method is preferably plasma CVD where a raw material gas is decomposed by direct-current, high frequency, or microwave glow discharge to deposit an a-Si film on a support.

A shape of the electrostatic latent image bearer is not particularly limited, and may be appropriately selected according to the intended purpose. The electrostatic latent image bearer preferably a cylindrical shape.

An outer diameter of the cylindrical electrostatic latent image bearer is not particularly limited, and may be appropriately selected according to the intended purpose. The outer diameter is preferably 3 mm or greater and 100 mm or less, more preferably 5 mm or greater and 50 mm or less, and particularly preferably 10 mm or greater and 30 mm or less.

### <Electrostatic Latent Image Forming Mechanism and Electrostatic Latent Image Forming Step>

The electrostatic latent image forming mechanism is configured to form an electrostatic latent image on the electrostatic latent image bearer.

The electrostatic latent image forming step is a step including formation of an electrostatic latent image on the electrostatic latent image bearer.

The electrostatic latent image forming step is suitably performed by the electrostatic latent image forming mechanism.

The electrostatic latent image forming mechanism is not particularly limited, and may be appropriately selected according to the intended purpose. Examples of the electrostatic latent image forming mechanism include a mechanism including at least a charger configured to charge a surface of the electrostatic latent image bearer and an exposure device configured to expose the charged surface of the electrostatic latent image bearer to light corresponding to an image to be formed.

The electrostatic latent image forming step is not particularly limited, and may be appropriately selected according to the intended purpose. For example, the electrostatic latent image forming step includes charging of a surface of the electrostatic latent image bearer and exposure of the charged surface of the electrostatic latent image bearer with light corresponding to an image to be formed.

### <<Charger and Charging>>

The charger is not particularly limited, and may be appropriately selected from chargers available in the related art according to the intended purpose. Examples of the charger include: contact chargers; and non-contact chargers utilizing corona discharge, such as corotron, and scorotron. The contact charger is preferably equipped with a conductor or semiconductor roller, brush, film, or rubber blade.

For example, the charging is performed by applying voltage to a surface of the electrostatic latent image bearer using the charger.

A shape of the charger may be any shape, such as a magnetic brush and a fur brush, as well as a roller. The form of the charger may be selected depending on specifications or an embodiment of the image forming apparatus.

The charger is not limited to the contact charger, but the contact charger is preferably used because an image forming apparatus using the contact charger discharges less ozone compared to an image forming apparatus using a non-contact charger.

### <<Exposure Device and Exposure>>

The exposure device is not particularly limited, as long as the exposure device can expose the surface of the electrostatic latent image bearer to light corresponding to an image to be formed. The exposure device may be appropriately selected according to the intended purpose. Examples of the exposure device include various exposure devices, such as copy optical exposure devices, rod lens array exposure devices, laser optical exposure devices, and liquid crystal shutter optical exposure devices.

A light source used in the exposure device is not particularly limited, and may be appropriately selected according to the intended purpose. Examples of the light source include general light emitters, such as fluorescent lamps, tungsten lamps, halogen lamps, mercury lamps, sodium vapor lamps, light emitting diodes (LED), semiconductor lasers (LD), and electroluminescent lights (EL).

For applying only light having a desired wavelength range, various filters, such as sharp-cut filters, band-pass filters, near infrared ray-cut filters, dichroic filters, interference filters, and color temperature conversion filters, may be used.

For example, the exposure can be performed by exposing the charged surface of the electrostatic latent image bearer to light corresponding to an image to be formed using the exposure device.

In the present disclosure, a back-exposure system may be employed. The back-exposure system is a system where the back side of the electrostatic latent image bearer is exposed to light corresponding to an image to be formed.

### <Developing Device and Developing Step>

The developing device contains the toner of the present disclosure and is configured to develop the electrostatic latent image formed on the electrostatic latent image bearer with the toner to form a visible image.

The developing step is a step including development of the electrostatic latent image formed on the electrostatic latent image bearer with the toner of the present disclosure to form a visible image.

The developing step is suitably performed by the developing device.

The developing device is not particularly limited, and may be appropriately selected according to the intended purpose. The developing device may employ a dry developing system or a wet developing system. Moreover, the developing device may be a developing device for a single color or a developing device for multiple colors. Among the above-listed examples, the developing device is preferably a developing device including a stirrer and a rotatable developer bearer, where the stirrer is configured to stir the toner to charge the toner with friction, and the developer bearer includes a magnetic field generator inside of the developer bearer and is configured to bear the toner on a surface of the developer bearer.

In the developing device, the toner and the carrier are mixed and stirred to charge the toner with friction, the charged toner is held on the rotating magnetic roller in the form of a brush to form a magnetic brush. The magnetic roller is disposed close to the electrostatic latent image bearer, thus part of the toner constituting the magnetic brush formed on the surface of the magnetic roller is moved onto a surface of the electrostatic latent image bearer by an electric suction force. As a result, the electrostatic latent image is developed with the toner to form a visible image formed of the toner on the surface of the electrostatic latent image bearer.

The carrier is not particularly limited, and may be appropriately selected according to the intended purpose. For example, the carrier described in the section of (Developer) may be used.

### <Other Devices or Members and Other Steps>

The above-mentioned other devices or members are not particularly limited, and may be appropriately selected according to the intended purpose. Examples of the above-mentioned other devices and members include a transferring member, a fixing device, a cleaner, a static charge eliminator, a recycling member, and a controller.

The above-mentioned other steps are not particularly limited, and may be appropriately selected according to the intended purpose. Examples of the above-mentioned other steps include a transferring step, a fixing step, a cleaning step, a static charge eliminating step, a recycling step, and a controlling step.

### <<Transferring Member and Transferring Step>>

The transferring member is configured to transfer the visible image formed by the developing device onto a recording medium.

The transferring step is a step including transfer of the visible image formed in the developing step onto a recording medium.

The transferring step is suitably performed by the transferring member.

The transferring member is not particularly limited, and may be appropriately selected according to the intended purpose. A preferred embodiment of the transferring member includes a primary transferring member and a secondary transferring member. The primary transferring member is configured to transfer the visible images onto an intermediate transfer member to form a composite transfer image. The secondary transferring member is configured to transfer the composite transfer image to a recording medium.

The transferring step is not particularly limited, and may be appropriately selected according to the intended purpose. A preferred embodiment of the transferring includes primary transfer of a visible image on an intermediate transfer member, followed by secondary transfer of the visible image onto a recording medium. Specifically, the transferring step may be performed, for example, by charging the photoconductor using a transfer charger to transfer the visible image, where the transferring step may be performed by the transferring member.

In a case where an image secondarily transferred onto the recording medium is a color image made up of two or more color-toners, single-color toners of different colors are sequentially superimposed on the intermediate transfer member by the transferring member to form images on the intermediate transfer member, and the images formed on the intermediate transfer member are collectively secondarily transferred onto the recording medium.

The intermediate transfer member is not particularly limited, and may be appropriately selected from transfer members know in the art according to the intended purpose. Suitable examples of the intermediate transfer member include a transfer belt.

The transferring member (the primary transferring member and the secondary transferring member) preferably includes at least a transfer member configured to charge and release the visible image formed on the photoconductor to the side of the recording medium.

The transfer member is not particularly limited, and may be appropriately selected according to the intended purpose. Examples of the transfer member include corona transfer chargers using corona discharge, transfer belts, transfer rollers, pressure transfer rollers, and adhesion transfer members.

The recording medium is typically plain paper. The recording medium is not particularly limited, except that an unfixed image before fixing can be transferred onto the recording medium. The recording medium may be appropriately selected according to the intended purpose. A PET base for an overhead projector (OHP) may also be used as the recording medium.

### <<Fixing Device and Fixing Step>>

The fixing device is configured to fix the transferred toner image (visible image) on the recording medium.

The fixing step is a step including fixing of the transferred toner image (visible image) on the recording medium.

The fixing step is suitably performed by the fixing device.

The fixing device is not particularly limited, and may be appropriately selected according to the intended purpose. The fixing device is preferably any of heat-press members available in the related art.

The heat-press members are not particularly limited, and may be appropriately selected according to the intended purpose. Examples of the heat-press members include a combination of a heat roller and a press roller, and a combination of a heat roller, a press roller, and an endless belt.

In the present disclosure, for example, any of optical fixing devices available in the related art may be used in combination with or instead of the fixing device according to the intended purpose.

The fixing step is not particularly limited, and may be appropriately selected according to the intended purpose. For example, the fixing step may be performed every time an image of each color toner is transferred to the recording medium, or may be performed once after all images of color toners are superimposed on the recording medium.

A heating temperature of the heat-press member is not particularly limited, and may be appropriately selected according to the intended purpose. The heating temperature is preferably 80° C. or higher and 200° C. or lower.

A surface pressure applied during the fixing step is not particularly limited, and may be appropriately selected according to the intended purpose. The surface pressure is preferably 10 N/cm² or greater and 80 N/cm² or less.

### <<Cleaner and Cleaning Step>>

The cleaner is configured to remove the toner remaining on the photoconductor.

The cleaning step is a step including removal of the toner remaining on the photoconductor.

The cleaning step is suitably performed by the cleaner.

The cleaner is not particularly limited, and may be appropriately selected according to the intended purpose. Examples of the cleaner include magnetic brush cleaners, electrostatic brush cleaners, magnetic roller cleaners, blade cleaners, brush cleaners, and web cleaners.

### <<Recycling Member and Recycle Step>>

The recycling member is configured to transport the toner removed by the cleaner to the developing device to recycle the toner.

The recycling step is a step including transportation of the toner removed in the cleaning step to the developing device to recycle the toner.

The recycling step is suitably performed by the recycling member.

The recycling member is not particularly limited, and may be appropriately selected according to the intended purpose. Examples of the recycling member include transporting members available in the related art.

### <<Controller and Controlling Step>>

The controller is configured to control operation of each device or member.

The controlling step is a step including control of operation of each device or member in each step.

The controlling step is suitably performed by the controller.

The controller is not particularly limited, and may be appropriately selected according to the intended purpose. Examples of the controller include devices, such as sequencers and computers.

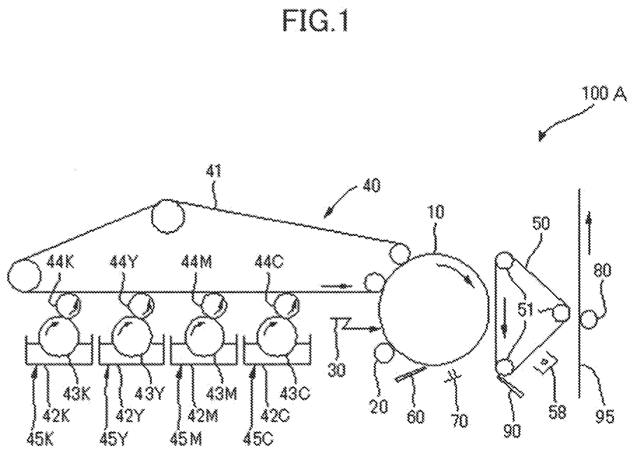

Next, embodiments of the image forming apparatus of the present disclosure and image forming method associated with the present disclosure will be described with reference to FIGS. 1 to 5.

The color image forming apparatus 100A illustrated in FIG. 1 includes a photoconductor drum (may be referred to as a “photoconductor 10” hereinafter) serving as the electrostatic latent image bearer, a charging roller 20 serving as the charger, an exposure device 30 serving as the exposure device, a developing device 40 serving as the developing device, an intermediate transfer member 50, a cleaning device 60 serving as the cleaner having a cleaning blade, and a static charge eliminating lamp 70 serving as the static charge eliminator.

The intermediate transfer member 50 is an endless belt. The intermediate transfer member 50 in the form of the endless belt is supported and driven in a direction indicated with the arrow in FIG. 1 by three rollers 51 disposed inside the loop of the endless belt. Part of the three rollers 51 may also function as a transfer bias roller capable of applying predetermined transfer bias (or primary transfer bias) to the intermediate transfer member 50. The cleaning device 90 including the cleaning blade is disposed close to the intermediate transfer member 50. Moreover, the transfer roller 80 is disposed close to the intermediate transfer member 50 in a manner that the transfer roller 80 faces the intermediate transfer member 50. The transfer roller 80 serves as the transferring member capable of applying transfer bias for transferring (or secondary transferring) the developed image (also referred to as the visible image or the toner image) to transfer paper 95 serving as the recording medium. The corona charger 58 configured to apply charge to the toner image on the intermediate transfer member 50 is disposed in a position at the periphery of the intermediate transfer member 50, where the position is located between a contact area between the photoconductor 10 and the intermediate transfer member 50, and the contact area between the intermediate transfer member 50 and the transfer paper 95 relative to the rotational direction of the intermediate transfer member 50.

The developing device 40 includes a developing belt 41 serving as the developer bearing member, and a black developing device 45K, a yellow developing device 45Y, a magenta developing device 45M, and a cyan developing device 45C, which are disposed in series at the periphery of the developing belt 41. The black developing device 45K includes a developer storage 42K, a developer supply roller 43K, and a developing roller 44K. The yellow developing device 45Y includes a developer storage 42Y, a developer supply roller 43Y, and a developing roller 44Y. The magenta developing device 45M includes a developer storage 42M, a developer supply roller 43M, and a developing roller 44M. The cyan developing device 45C includes a developer storage 42C, a developer supply roller 43C, and a developing roller 44C. Moreover, the developing belt 41 is an endless belt rotatably supported by two or more belt rollers. Part of the developing belt 41 comes into contact with the electrostatic latent image bearer 10.

In the color image forming apparatus 100A of FIG. 1, for example, the charging roller 20 uniformly charges a surface of the photoconductor drum 10. The exposure device 30 exposes the charged surface of the photoconductor drum 10 to light to correspond to an image to be formed, thus, forming an electrostatic latent image. The toner is supplied from the developing device 40 to develop the electrostatic latent image formed on the photoconductor drum 10, thus, forming a toner image. Voltage is applied from the roller 51 to the toner image to transfer (primary transfer) the toner image onto the intermediate transfer member 50, followed by transferring (secondary transferring) onto transfer paper 95. As a result, the transferred image is formed on the transfer paper 95. The residual toner on the photoconductor 10 is removed by the cleaning device 60. The residual charge of the photoconductor is temporarily removed by the static charge eliminating lamp 70.

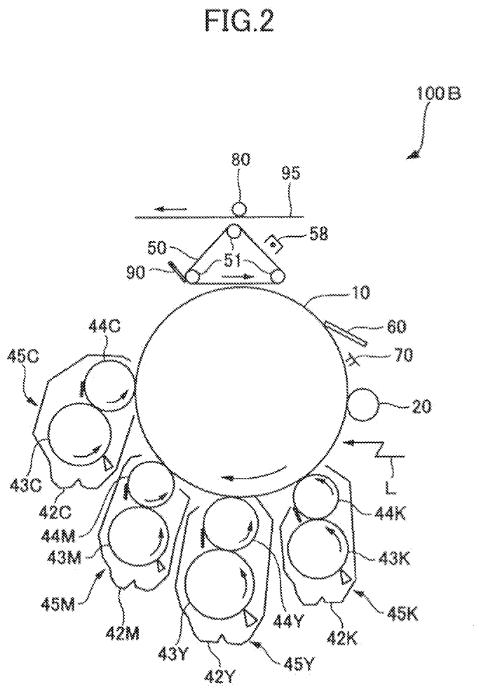

FIG. 2 illustrates another example of the image forming apparatus of the present disclosure. The image forming apparatus 100B has the structure identical to the structure of the image forming apparatus 100A of FIG. 1, except that the black developing device 45K, the yellow developing device 45Y, the magenta developing device 45M, and the cyan developing device 45C are disposed at the periphery of the photoconductor drum 10 to directly face the photoconductor drum 10 without disposing the developing belt 41.

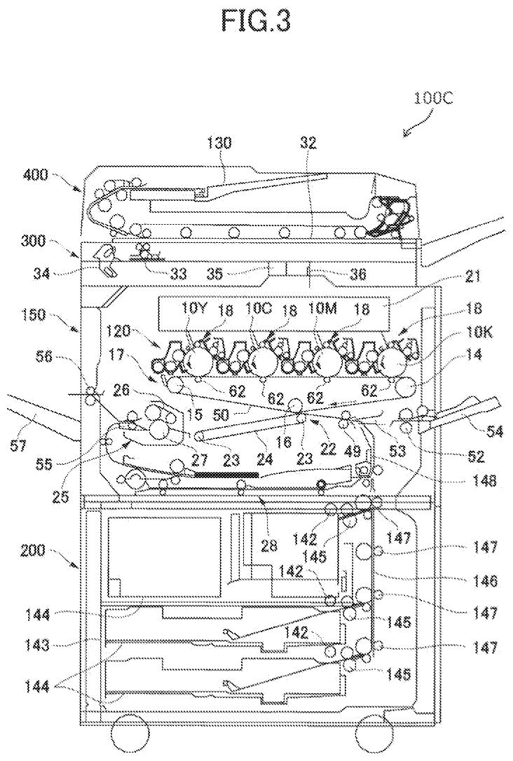

FIG. 3 illustrates yet another example of the image forming apparatus of the present disclosure. The image forming apparatus 100C of FIG. 3 includes a photocopier main body 150, a paper feeding table 200, a scanner 300, and an automatic document feeder (ADF) 400.

The photocopier main body 150 includes an intermediate transfer member 50 that is an endless belt. The intermediate transfer member 50 is disposed at a central part of the photocopier main body 150. The intermediate transfer member is rotatably supported by support rollers 14, 15, and 16 in the clockwise direction in FIG. 3. An intermediate transfer member cleaning device 17 is disposed close to the support roller 15. The intermediate transfer member cleaning device 17 is configured to remove the residual toner on the intermediate transfer member 50. A tandem developing device 120 is disposed to face the section of the intermediate transfer member 50 supported by the support rollers 14 and 15. In the tandem developing device 120, four image forming mechanisms 18, i.e., a yellow image forming mechanism, a cyan image forming mechanism, a magenta image forming mechanism, and a black image forming mechanism, are arranged in series along the traveling direction of the intermediate transfer member 50. An exposure device 21 serving as the exposing device is disposed close to the tandem developing device 120. A secondary transfer device 22 is disposed at the opposite side of the intermediate transfer member 50 to the side where the tandem developing device 120 is disposed. The secondary transfer device 22 includes a secondary transfer belt 24. The secondary transfer belt 24 is an endless belt and is supported by a pair of rollers 23. Transfer paper borne on and transported by the secondary transfer belt 24 comes into contact with the intermediate transfer member 50. A fixing device serving as the fixing device is disposed close to the secondary transfer device 22. The fixing device includes a fixing belt 26, which is an endless belt, and a press roller 27 disposed to press against the fixing belt 26.

The tandem image forming apparatus includes a sheet reverser 28 disposed close to the secondary transfer device 22 and to the fixing device 25. The sheet reverser 28 is configured to reverse transfer paper to perform image formation on both sides of the transfer paper.

Next, formation of a full-color image (a color copy) using the tandem developing device 120 will be described. First, a document is set on a document table 130 of the automatic document feeder (ADF) 400. Alternatively, a document is set on contact glass 32 of a scanner 300 by opening the automatic document feeder 400. Once the document is set, the automatic document feeder 400 is closed.

Once a start switch is pressed, if the document is set on the automatic document feeder 400, the document is transported onto the contact glass 32, and then the scanner 300 is driven. If the document is initially set on the contact glass 32, the scanner 300 is immediately driven once the start switch is pressed. Then, a first carriage 33 and a second carriage 34 are driven to scan the document. During the scanning, the first carriage 33 irradiates a surface of the document with light emitted from a light source, and the light reflected from the surface of the document is again reflected by a mirror of the second carriage 34 to pass the light through an imaging forming lens 35. The light is then received by a reading sensor 36 to read the color document (e.g., the color image) to acquire image information of black, yellow, magenta, and cyan.

The image information of each of black, yellow, magenta, and cyan is transmitted to the corresponding image forming mechanism 18 (the black image forming mechanism, the yellow image forming mechanism, the magenta image forming mechanism, or the cyan image forming mechanism) of the tandem developing device 120. By each image forming mechanism, a toner image of each color (black, yellow, magenta, or cyan) is formed.

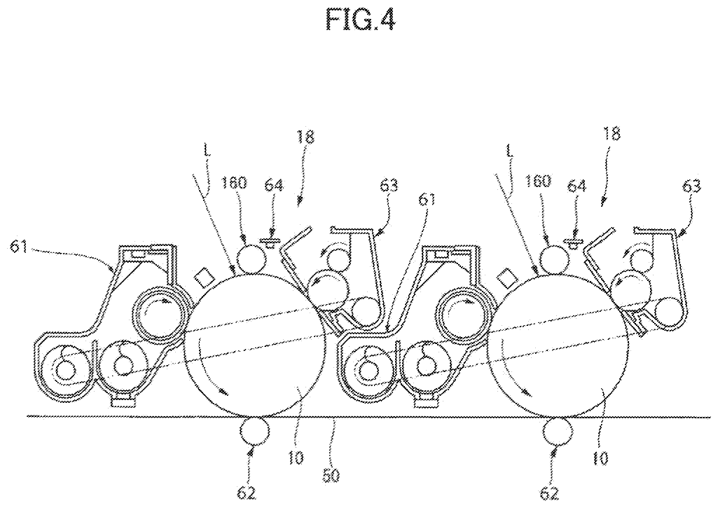

Specifically, as illustrated in FIG. 4, each image forming mechanism 18 (the black image forming mechanism, the yellow image forming mechanism, the magenta image forming mechanism, or the cyan image forming mechanism) of the tandem developing device 120 includes an electrostatic latent image bearer 10 (a black electrostatic latent image bearer 10K, a yellow electrostatic latent image bearer 10Y, a magenta electrostatic latent image bearer 10M, and a cyan electrostatic latent image bearer 10C), a charging device 160 that is the charger configured to uniformly charge a surface of the electrostatic latent image bearer 10, an exposing device configured to expose the electrostatic latent image bearer to light (L in FIG. 4) to correspond to each color image based on the corresponding color image information, to thereby form an electrostatic latent image on the electrostatic latent image bearer to correspond to each color image to be formed, a developing device 61 that is the developing device configured to develop the electrostatic latent image with the corresponding color toner (the black toner, the yellow toner, the magenta toner, or the cyan toner), to thereby form a toner image of the corresponding color toner, a transfer charger 62 configured to transfer the toner images onto an intermediate transfer member 50, a cleaning device 63, and a static charge eliminator 64.

Each image forming mechanism 18 can form an image of a single color (e.g., a black image, a yellow image, a magenta image, and a cyan image) based on the corresponding color image information. The black image formed on the black electrostatic latent image bearer 10K, the yellow image formed on the yellow electrostatic latent image bearer 10Y, the magenta image formed on the magenta electrostatic latent image bearer 10M, and the cyan image formed on the cyan electrostatic latent image bearer 10C in the above-described manner are sequentially transferred (or primary transferred) onto the intermediate transfer member 50 that is rotatably supported by the support rollers 14, 15, and 16. The black image, the yellow image, the magenta image, and the cyan image are superimposed on the intermediate transfer member 50 to form a composite color image (a transferred color image).

While the toner images are formed in the above-described manner, in the paper feeding table 200, one of paper feeding rollers 142 is selectively driven to rotate to feed sheets (recording paper or recording media) from one of paper feeding cassettes 144 stacked in a paper bank 143. The sheets are separated one by one by a separation roller 145 to feed each sheet into a paper feeding path 146, and the fed sheet is transported by a transport roller 147 to guide the sheet into a paper feeding path 148 inside the photocopier main body 150. The sheet is then caused to collide with a registration roller 49 to stop. Alternatively, a paper feeding roller 142 is driven to rotate to feed sheets (recording paper or recording media) on a manual feed tray 54, and the sheets are separated and fed into a manual paper feeding path 53 one by one with a separation roller 52. Similarly, the fed sheet is caused to collide with a registration roller 49 to stop. The registration roller 49 is typically grounded during use, but the registration roller 49 may be used in the state where bias is applied to the registration roller 49 to remove paper dust from sheets.

Synchronizing with the timing of the composite color image (the transferred color image) formed on the intermediate transfer member 50, the registration roller 49 is driven to rotate to feed the sheet (the recording paper or recording medium) between the intermediate transfer member 50 and the secondary transfer device 22. The composite color image (the transferred color image) is then transferred (or secondarily transferred) onto the sheet (the recording paper or recording medium) by the secondary transfer device 22. In the manner as described above, the color image is transferred and formed onto the sheet (the recording paper or recording medium). After transferring the image, the residual toner on the intermediate transfer member 50 is cleaned by the intermediate transfer member cleaning device 17.

The sheet (the recording paper or recording medium) on which the color image has been transferred is transported by the secondary transfer device 22 to send the sheet to the fixing device 25. Heat and pressure are applied to the composite color image (the transferred color image) by the fixing device 25 to fix the composite color image onto the sheet (the recording paper or recording medium). Thereafter, the traveling direction of the sheet (the recording paper) is switched by the switching claw 55 to eject the sheet (the recording paper or recording medium) with an ejection roller 56 to stack the sheet (the recording paper or recording medium) on the paper ejection tray 57. Alternatively, the traveling direction of the sheet (the recording paper or recording medium) is switched by the switching claw 55, and the sheet is flipped by the sheet reverser 28 and is returned to the transfer position. After forming an image also on the back side of the sheet, the sheet is ejected by the ejection roller 56 to stack on the paper ejection tray 57.

### (Toner Storage)

The toner storage of the present disclosure includes a storage configured to store a toner, and a toner stored in the storage.

The toner stored in the toner storage is the toner of the present disclosure. Therefore, the toner storage of the present disclosure is highly environmentally friendly. When the toner storage is mounted in the image forming apparatus of the present disclosure and image formation is performed by the image forming apparatus, images are formed with the toner of the present disclosure. Therefore, a high level of carbon neutrality and excellent storage stability are achieved.

An embodiment of the toner storage is not particularly limited, as long as the toner storage can store the toner inside. The embodiment of the toner storage may be appropriately selected according to the intended purpose. Examples of the embodiment include toner storage containers, developing devices, and process cartridges.

### <Toner Storage Container>

The toner storage container is a container in which the toner is stored.

The toner storage container is not particularly limited, and may be appropriately selected from toner storage containers available in the related art. Examples of the toner storage container include a combination of a container main body and a cap.

A size of the container main body is not particularly limited, and may be appropriately adjusted.

A shape of the container main body is not particularly limited, and may be appropriately selected. The shape of the container main body is preferably a cylinder.

A structure of the container main body is not particularly limited, and may be appropriately selected. The container main body preferably has a structure where a groove is spirally formed along an inner circumferential surface of the container main body, and part of or the whole of the groove is pleated like a bellows. As the container main body having the above-described structure is rotated, the toner, which is the content of the container, moves towards an outlet of the container main body. A material of the container main body is not particularly limited, and may be appropriately selected. The material of the container main body is preferably a material capable of achieving great precision in size. Examples of the material of the container main body include resin materials, such as polyester resins, polyethylene resins, polypropylene resins, polystyrene resins, polyvinyl chloride resins, polyacrylic acids, polycarbonate resins, ABS resins, and polyacetal resins. The above-listed examples may be used alone or in combination.

Since the toner storage container facilitates easy storage and transportation of the toner, and allows effortless handling, the toner storage container is detachably mounted in a process cartridge or an image forming apparatus, and is used for replenishing the toner.

### <Developing Device>

The developing device includes a developing device in which the toner is stored.

The developing device is not particularly limited, and may be appropriately selected according to the intended purpose. For example, the developing device includes at least the toner storage container, and a toner bearer configured to bear and transport the toner stored in the toner storage container.

The developing device may further include a regulating member configured to regulate a thickness of a layer of the toner borne on the toner bearer.

### <Process Cartridge>

The process cartridge includes an electrostatic latent image bearer and a developing device as an integrated unit, stores the toner inside, and is detachably mounted in an image forming apparatus. The process cartridge may further include at least one selected from the group consisting of a charger, an exposure device, a cleaner, and a static charge eliminator, as necessary.

As an example of the process cartridge, suitably used is a process cartridge that is configured such that the process cartridge is detachably mounted in various image forming apparatuses, and includes at least an electrostatic latent image bearer and a developing device, where the electrostatic latent image bearer is configured to bear an electrostatic latent image thereon, and the developing device is configured to develop the electrostatic latent image borne on the electrostatic latent image bearer with the toner to form a toner image. The process cartridge may further include other devices or members, as necessary.

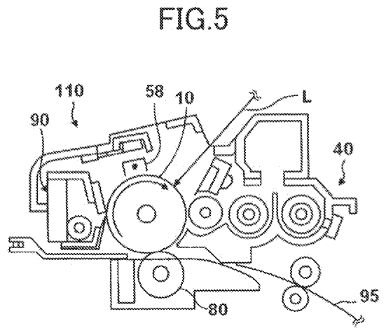

Next, an embodiment of the process cartridge is illustrated in FIG. 5. As illustrated in FIG. 5, the process cartridge 110 of the present disclosure includes an electrostatic latent image bearer 10, which is mounted inside the process cartridge 110. The process cartridge 110 further includes a charger 58 serving as the charger, a developing device 40 serving as the developing device, and a cleaning device 90 serving as the cleaner, and may further include other devices or members, as necessary. In FIG. 5, the reference L denotes exposure light emitted from an exposing device (not illustrated) and the numerical reference 95 denotes recording paper (a recording medium).

As the electrostatic latent image bearer 10, an electrostatic latent image bearer identical to the electrostatic latent image bearer in the above-described image forming apparatus may be used. Moreover, an appropriately selected charger may be used as the charger 58.

According to an image forming process performed by the process cartridge illustrated in FIG. 5, an image is formed in the following manner. The electrostatic latent image bearer 10 is charged by the charger 58 while rotating the electrostatic latent image bearer 10 in the direction indicated with the arrow, and the charged surface of the electrostatic latent image bearer 10 is exposed to exposure light L emitted by the exposure device to form an electrostatic latent image corresponding to the exposure image formed of the exposure light L.

The electrostatic latent image is developed with the toner by the developing device 40 to form a toner image, the toner image is transferred to recording paper 95 by the transfer roller 80, and the recording paper 95 on which the toner image is printed is discharged. After transferring the image, the surface of the electrostatic latent image bearer is cleaned by the cleaning device 90, and the residual charge of the electrostatic latent image bearer 10 is eliminated by a static charge eliminator (not illustrated). Then, the above-described processes are repeated again.

### EXAMPLES

The present disclosure will be concretely described below by way of Production Examples, Examples, and Comparative Examples. The present disclosure should not be construed as being limited to these Production Examples and Examples. In Production Examples, Examples, and Comparative Examples, “%” denotes “% by mass” and “part(s)” denotes “part(s) by mass” unless otherwise stated. Moreover, each amount in Examples and Comparative Examples denotes an amount of each starting material on solid basis.

### Production Example A-1: Synthesis of Amorphous Polyester Resin A-1

A four-necked flask equipped with a nitrogen-inlet tube, a dehydration tube, a stirrer, and a thermocouple was charged with 21 parts of plant-derived propylene glycol (available from DuPont de Nemours, Inc.), 395 parts of a bisphenol A propylene oxide (2 mol) adduct (available from Sanyo Chemical Industries, Ltd.), 322 parts of recycled PET (available from Kyoei J&T Recycling Corporation), 146 parts of plant-derived succinic acid (available from BASF), and 116 parts of sodium 5-sulfoisophthalate (available from Tokyo Chemical Industry Co., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-1]. The composition and physical properties of [Amorphous Polyester Resin A-1] are presented in Tables 1-1 to 1-3 below.

### Production Example A-2: Synthesis of Amorphous Polyester Resin A-2

A four-necked flask equipped with a nitrogen-inlet tube, a dehydration tube, a stirrer, and a thermocouple was charged with 11 parts of plant-derived neopentyl glycol (available from Perstorp), 386 parts of a bisphenol A propylene oxide (2 mol) adduct (available from Sanyo Chemical Industries, Ltd.), 363 parts of recycled PET (available from Kyoei J&T Recycling Corporation), 126 parts of plant-derived succinic acid (available from BASF), and 113 parts of sodium 5-sulfoisophthalate (available from Tokyo Chemical Industry Co., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-2]. The composition and physical properties of [Amorphous Polyester Resin A-2] are presented in Tables 1-1 to 1-3 below.

### Production Example A-3: Synthesis of Amorphous Polyester Resin A-3

A four-necked flask equipped with a nitrogen-inlet tube, a dehydration tube, a stirrer, and a thermocouple was charged with 58 parts of a bisphenol A ethylene oxide (2 mol) adduct (available from Sanyo Chemical Industries, Ltd.), 306 parts of a bisphenol A propylene oxide (2 mol) adduct (available from Sanyo Chemical Industries, Ltd.), 406 parts of recycled PET (available from Kyoei J&T Recycling Corporation), 173 parts of adipic acid (available from Hayashi Pure Chemical Ind., Ltd.), and 56 parts of sodium 5-sulfoisophthalate (available from Tokyo Chemical Industry Co., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-3]. The composition and physical properties of [Amorphous Polyester Resin A-3] are presented in Tables 1-1 to 1-3 below.

### Production Example A-4: Synthesis of Amorphous Polyester Resin A-4

A four-necked flask equipped with a nitrogen-inlet tube, a dehydration tube, a stirrer, and a thermocouple was charged with 30 parts of plant-derived propylene glycol (available from DuPont de Nemours, Inc.), 195 parts of a bisphenol A propylene oxide (2 mol) adduct (available from Sanyo Chemical Industries, Ltd.), 514 parts of recycled PET (available from Kyoei J&T Recycling Corporation), 238 parts of plant-derived sebacic acid (available from Kokura Gosei Kogyo, Ltd.), and 24 parts of sodium 5-sulfoisophthalate (available from Tokyo Chemical Industry Co., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-4]. The composition and physical properties of [Amorphous Polyester Resin A-4] are presented in Tables 1-1 to 1-3 below.

### Production Example A-5: Synthesis of Amorphous Polyester Resin A-5

A four-necked flask equipped with a nitrogen-inlet tube, a dehydration tube, a stirrer, and a thermocouple was charged with 409 parts of a bisphenol A propylene oxide (2 mol) adduct (available from Sanyo Chemical Industries, Ltd.), 278 parts of recycled PET (available from Kyoei J&T Recycling Corporation), 293 parts of plant-derived sebacic acid (available from Kokura Gosei Kogyo, Ltd.), and 20 parts of sodium 5-sulfoisophthalate (available from Tokyo Chemical Industry Co., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-5]. The composition and physical properties of [Amorphous Polyester Resin A-5] are presented in Tables 1-1 to 1-3 below.

### Production Example A-6: Synthesis of Amorphous Polyester Resin A-6

A four-necked flask equipped with a nitrogen-inlet tube, a dehydration tube, a stirrer, and a thermocouple was charged with 307 parts of a bisphenol A propylene oxide (2 mol) adduct (available from Sanyo Chemical Industries, Ltd.), 470 parts of recycled PET (available from Kyoei J&T Recycling Corporation), 166 parts of isophthalic acid (available from MITSUBISHI GAS CHEMICAL COMPANY, INC.), and 56 parts of sodium 5-sulfoisophthalate (available from Tokyo Chemical Industry Co., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-6]. The composition and physical properties of [Amorphous Polyester Resin A-6] are presented in Tables 1-1 to 1-3 below.

### Production Example A-7: Synthesis of Amorphous Polyester Resin A-7

A four-necked flask equipped with a nitrogen-inlet tube, a dehydration tube, a stirrer, and a thermocouple was charged with 484 parts of a bisphenol A propylene oxide (2 mol) adduct (available from Sanyo Chemical Industries, Ltd.), 124 parts of recycled PET (available from Kyoei J&T Recycling Corporation), 304 parts of plant-derived dodecanedioic acid (available from Verdezyne, Inc.), and 89 parts of sodium 5-sulfoisophthalate (available from Tokyo Chemical Industry Co., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-7]. The composition and physical properties of [Amorphous Polyester Resin A-7] are presented in Tables 1-1 to 1-3 below.

### Production Example A-8: Synthesis of Amorphous Polyester Resin A-8

A four-necked flask equipped with a nitrogen-inlet tube, a dehydration tube, a stirrer, and a thermocouple was charged with 22 parts of plant-derived propylene glycol (available from DuPont de Nemours, Inc.), 416 parts of a bisphenol A propylene oxide (2 mol) adduct (available from Sanyo Chemical Industries, Ltd.), 340 parts of recycled PET (available from Kyoei J&T Recycling Corporation), and 222 parts of plant-derived succinic acid (available from BASF). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-8]. The composition and physical properties of [Amorphous Polyester Resin A-8] are presented in Tables 1-1 to 1-3 below.

### Production Example A-9: Synthesis of Amorphous Polyester Resin A-9

A four-necked flask equipped with a nitrogen-inlet tube, a dehydration tube, a stirrer, and a thermocouple was charged with 20 parts of plant-derived propylene glycol (available from DuPont de Nemours, Inc.), 385 parts of a bisphenol A propylene oxide (2 mol) adduct (available from Sanyo Chemical Industries, Ltd.), 314 parts of recycled PET (available from Kyoei J&T Recycling Corporation), 111 parts of plant-derived succinic acid (available from BASF), and 170 parts of sodium 5-sulfoisophthalate (available from Tokyo Chemical Industry Co., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-9]. The composition and physical properties of [Amorphous Polyester Resin A-9] are presented in Tables 1-1 to 1-3 below.

### Production Example A-10: Synthesis of Amorphous Polyester Resin A-10

A four-necked flask equipped with a nitrogen-inlet tube, a dehydration tube, a stirrer, and a thermocouple was charged with 21 parts of plant-derived propylene glycol (available from DuPont de Nemours, Inc.), 392 parts of bisphenol A propylene oxide (2 mol) adduct (available from Sanyo Chemical Industries, Ltd.), 320 parts of recycled PET (available from Kyoei J&T Recycling Corporation), 243 parts of adipic acid (available from Hayashi Pure Chemical Ind., Ltd.), and 23 parts of sodium 5-sulfoisophthalate (available from Tokyo Chemical Industry Co., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-10]. The composition and physical properties of [Amorphous Polyester Resin A-10] are presented in Tables 1-1 to 1-3 below.

### Production Example A-11: Synthesis of Amorphous Polyester Resin A-11

A four-necked flask equipped with a nitrogen-inlet tube, a dehydration tube, a stirrer, and a thermocouple was charged with 35 parts of plant-derived propylene glycol (available from DuPont de Nemours, Inc.), 116 parts of bisphenol A propylene oxide (2 mol) adduct (available from Sanyo Chemical Industries, Ltd.), 594 parts of recycled PET (available from Kyoei J&T Recycling Corporation), 230 parts of plant-derived dodecanedioic acid (available from Verdezyne, Inc.), and 24 parts of sodium 5-sulfoisophthalate (available from Tokyo Chemical Industry Co., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-11]. The composition and physical properties of [Amorphous Polyester Resin A-11] are presented in Tables 1-1 to 1-3 below.

### Production Example A-12: Synthesis of Amorphous Polyester Resin A-12

A four-necked flask equipped with a nitrogen-inlet tube, a dehydration tube, a stirrer, and a thermocouple was charged with 21 parts of plant-derived propylene glycol (available from DuPont de Nemours, Inc.), 395 parts of a bisphenol A propylene oxide (2 mol) adduct (available from Sanyo Chemical Industries, Ltd.), 323 parts of recycled PET (available from Kyoei J&T Recycling Corporation), and 261 parts of adipic acid (available from Hayashi Pure Chemical Ind., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-12]. The composition and physical properties of [Amorphous Polyester Resin A-12] are presented in Tables 1-1 to 1-3 below.

### Production Example A-13: Synthesis of Amorphous Polyester Resin A-13

A four-necked flask equipped with a nitrogen-inlet tube, a dehydration tube, a stirrer, and a thermocouple was charged with 271 parts of a bisphenol A ethylene oxide (2 mol) adduct (available from Sanyo Chemical Industries, Ltd.), 285 parts of a bisphenol A propylene oxide (2 mol) adduct (available from Sanyo Chemical Industries, Ltd.), 145 parts of recycled PET (available from Kyoei J&T Recycling Corporation), and 299 parts of adipic acid (available from Hayashi Pure Chemical Ind., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin A-13]. The composition and physical properties of [Amorphous Polyester Resin A-13] are presented in Tables 1-1 to 1-3 below.

TABLE 1-1

| PE | Monomers | | | | | |
|---|---|---|---|---|---|---|
| resin | Alcohol monomer | | | Acid monomer | | |
| No. | 1 | 2 | 3 | 1 | 2 | 3 |
| A-1 | Plant-derived | Bisphenol A | Recycled PET- | Plant-derived | Recycled | Sodium |
| | propylene | propylene | derived ethylene | succinic acid | PET-derived | 5-sulfoisophthalate |
| | glycol | oxide adduct | glycol | | terephthalic | |
| | | | | | acid | |
| A-2 | Plant-derived | Bisphenol A | Recycled PET- | Plant-derived | Recycled | Sodium |
| | neopentyl | propylene | derived ethylene | succinic acid | PET-derived | 5-sulfoisophthalate |
| | glycol | oxide adduct | glycol | | terephthalic | |
| | | | | | acid | |
| A-3 | Bisphenol A | Bisphenol A | Recycled PET- | Adipic acid | Recycled | Sodium |
| | ethylene | propylene | derived ethylene | | PET-derived | 5-sulfoisophthalate |
| | oxide adduct | oxide adduct | glycol | | terephthalic | |
| | | | | | acid | |
| A-4 | Plant-derived | Bisphenol A | Recycled PET- | Plant-derived | Recycled | Sodium |
| | propylene | propylene | derived ethylene | sebacic acid | PET-derived | 5-sulfoisophthalate |
| | glycol | oxide adduct | glycol | | terephthalic | |
| | | | | | acid | |
| A-5 | — | Bisphenol A | Recycled PET- | Plant-derived | Recycled | Sodium |
| | | propylene | derived ethylene | sebacic acid | PET-derived | 5-sulfoisophthalate |
| | | oxide adduct | glycol | | terephthalic | |
| | | | | | acid | |
| A-6 | — | Bisphenol A | Recycled PET- | Isophthalic | Recycled | Sodium |
| | | propylene | derived ethylene | acid | PET-derived | 5-sulfoisophthalate |
| | | oxide adduct | glycol | | terephthalic | |
| | | | | | acid | |
| A-7 | — | Bisphenol A | Recycled PET- | Plant-derived | Recycled | Sodium |
| | | propylene | derived ethylene | dodecane | PET-derived | 5-sulfoisophthalate |
| | | oxide adduct | glycol | dioic acid | terephthalic | |
| | | | | | acid | |
| A-8 | Plant-derived | Bisphenol A | Recycled PET- | Plant-derived | Recycled | — |
| | propylene | propylene | derived ethylene | succinic acid | PET-derived | |
| | glycol | oxide adduct | glycol | | terephthalic | |
| | | | | | acid | |
| A-9 | Plant-derived | Bisphenol A | Recycled PET- | Plant-derived | Recycled | Sodium |
| | propylene | propylene | derived ethylene | succinic acid | PET-derived | 5-sulfoisophthalate |
| | glycol | oxide adduct | glycol | | terephthalic | |
| | | | | | acid | |
| A-10 | Plant-derived | Bisphenol A | Recycled PET- | Adipic acid | Recycled | Sodium |
| | propylene | propylene | derived ethylene | | PET-derived | 5-sulfoisophthalate |
| | glycol | oxide adduct | glycol | | terephthalic | |
| | | | | | acid | |
| A-11 | Plant-derived | Bisphenol A | Recycled PET- | Plant-derived | Recycled | Sodium |
| | propylene | propylene | derived ethylene | dodecane | PET-derived | 5-sulfoisophthalate |
| | glycol | oxide adduct | glycol | dioic acid | terephthalic | |
| | | | | | acid | |
| A-12 | Plant-derived | Bisphenol A | Recycled PET- | Adipic acid | Recycled | Sodium |
| | propylene | propylene | derived ethylene | | PET-derived | 5-sulfoisophthalate |
| | glycol | oxide adduct | glycol | | terephthalic | |
| | | | | | acid | |
| A-13 | Bisphenol A | Bisphenol A | Recycled PET- | Adipic acid | Recycled | Sodium |
| | ethylene | propylene | derived ethylene | | PET-derived | 5-sulfoisophthalate |
| | oxide adduct | oxide adduct | glycol | | terephthalic | |
| | | | | | acid | |

In Table 1-1, “PE resin No.” denotes the number of Amorphous Polyester Resin, and “Bisphenol A ethylene oxide adduct” and “bisphenol A propylene oxide adduct” denote a bisphenol A ethylene oxide (2 mol) adduct and a bisphenol A propylene oxide (2 mol) adduct, respectively.

TABLE 1-2

| Amorphous | Parts | | | | | | Number of moles | | | | | |
|---|---|---|---|---|---|---|---|---|---|---|---|---|
| polyester | Alcohol monomer | | | Acid monomer | | | Alcohol monomer | | | Acid monomer | | |
| resin No. | 1 | 2 | 3 | 1 | 2 | 3 | 1 | 2 | 3 | 1 | 2 | 3 |
| A-1 | 21 | 395 | 161 | 146 | 161 | 116 | 5 | 25 | 20 | 22 | 18 | 10 |
| A-2 | 11 | 386 | 181 | 126 | 181 | 113 | 2 | 25 | 23 | 20 | 20 | 10 |
| A-3 | 58 | 306 | 203 | 173 | 203 | 56 | 4 | 20 | 26 | 22 | 23 | 5 |
| A-4 | 30 | 195 | 257 | 238 | 257 | 24 | 7 | 12 | 31 | 21 | 27 | 2 |
| A-5 | 0 | 409 | 139 | 293 | 139 | 20 | 0 | 30 | 20 | 30 | 18 | 2 |
| A-6 | 0 | 307 | 235 | 166 | 235 | 56 | 0 | 20 | 30 | 19 | 26 | 5 |
| A-7 | 0 | 484 | 62 | 304 | 62 | 89 | 0 | 40 | 10 | 31 | 9 | 10 |
| A-8 | 22 | 416 | 170 | 222 | 170 | 0 | 5 | 25 | 20 | 32 | 18 | 0 |
| A-9 | 20 | 385 | 157 | 111 | 157 | 170 | 5 | 25 | 20 | 17 | 18 | 15 |
| A-10 | 21 | 392 | 160 | 243 | 160 | 23 | 5 | 25 | 20 | 30 | 18 | 2 |
| A-11 | 35 | 116 | 297 | 230 | 297 | 24 | 8 | 7 | 35 | 17 | 31 | 2 |
| A-12 | 21 | 395 | 161 | 261 | 161 | 0 | 5 | 25 | 20 | 32 | 18 | 0 |
| A-13 | 271 | 285 | 73 | 299 | 73 | 0 | 20 | 20 | 10 | 41 | 9 | 0 |

TABLE 1-3

| | Environmentally | |
|---|---|---|
| Amorphous | friendly | |
| polyester | component | |
| resin No. | content | SP |
| A-1 | 49 | 12.9 |
| A-2 | 50 | 12.9 |
| A-3 | 41 | 12.6 |
| A-4 | 78 | 13.0 |
| A-5 | 57 | 11.8 |
| A-6 | 47 | 13.3 |
| A-7 | 43 | 11.3 |
| A-8 | 58 | 12.7 |
| A-9 | 45 | 13.0 |
| A-10 | 34 | 12.3 |
| A-11 | 86 | 13.3 |
| A-12 | 34 | 12.2 |
| A-13 | 15 | 11.4 |

### Production Example B-1: Synthesis of Amorphous Polyester Resin B-1

A four-necked flask equipped with a nitrogen-inlet tube, a dehydration tube, a stirrer, and a thermocouple was charged with 195 parts of plant-derived propylene glycol (available from DuPont de Nemours, Inc.), 109 parts of plant-derived succinic acid (available from BioAmber Inc.), and 697 parts of plant-derived terephthalic acid (available from Gevo). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin B-1]. The physical properties of [Amorphous Polyester Resin B-1] are presented in Tables 2-1 and 2-2 below.

### Production Example B-2: Synthesis of Amorphous Polyester Resin B-2

A four-necked flask equipped with a nitrogen-inlet tube, a dehydration tube, a stirrer, and a thermocouple was charged with 131 parts of plant-derived propylene glycol (available from DuPont de Nemours, Inc.), 429 parts of recycled PET (available from Kyoei J&T Recycling Corporation), 229 parts of plant-derived terephthalic acid (available from Gevo), and 50 parts of adipic acid (available from Hayashi Pure Chemical Ind., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin B-2]. The physical properties of [Amorphous Polyester Resin B-2] are presented in Tables 2-1 and 2-2 below.

### Production Example B-3: Synthesis of Amorphous Polyester Resin B-3

A four-necked flask equipped with a nitrogen-inlet tube, a dehydration tube, a stirrer, and a thermocouple was charged with 385 parts of a bisphenol A propylene oxide (2 mol) adduct (available from Sanyo Chemical Industries, Ltd.), 244 parts of a bisphenol A ethylene oxide (2 mol) adduct (available from Sanyo Chemical Industries, Ltd.), 358 parts of isophthalic acid (available from KANTO CHEMICAL CO., INC.), and 13 parts of adipic acid (available from Hayashi Pure Chemical Ind., Ltd.). The resulting mixture was allowed to react together with titanium tetraisopropoxide (500 ppm relative to the resin component) for 8 hours at 230° C. under ambient pressure, followed by further reacting for 4 hours under the reduced pressure of from 10 mmHg to 15 mmHg. To the flask, 1 mol % of trimellitic anhydride relative to the total resin component was added. The resulting mixture was allowed to react for 3 hours at 180° C. under ambient pressure, to thereby obtain [Amorphous Polyester Resin B-3]. The physical properties of [Amorphous Polyester Resin B-3] are presented in Tables 2-1 and 2-2 below.

TABLE 2-1

| Amorphous | Monomers | | | | |
|---|---|---|---|---|---|
| polyester | Alcohol monomer | | Acid monomer | | |
| resin No. | 1 | 2 | 1 | 2 | 3 |
| B-1 | Plant- | | Plant- | Plant- | |
| | derived | | derived | derived | |
| | propylene | | succinic | terephthalic | |
| | glycol | | acid | acid | |
| B-2 | Plant- | Recycled | Plant- | Recycled | Adipic |
| | derived | PET-deriv | Derived | PET-derived | acid |
| | propylene | ed ethyle | terephthalic | terephthalic | |
| | glycol | ne glycol | acid | acid | |
| B-3 | Bisphenol | Bisphenol | Isophthalic | Adipic acid | |
| | A | A | acid | | |
| | propylene | ethylene | | | |
| | oxide | oxide | | | |
| | (2 mol) | (2 mol) | | | |
| | adduct | adduct | | | |

TABLE 2-2

| | Part(s) | | | | | Number of moles | | | | |
|---|---|---|---|---|---|---|---|---|---|---|
| | Alcohol | | | | | Alcohol | | | | |
| | monomer | | Acid monomer | | | monomer | | Acid monomer | | |
| | 1 | 2 | 1 | 2 | 3 | 1 | 2 | 1 | 2 | 3 |
| B-1 | 195 | 0 | 109 | 697 | 0 | 50 | 0 | 18 | 82 | 0 |
| B-2 | 131 | 160 | 229 | 429 | 50 | 20 | 30 | 16 | 30 | 4 |
| B-3 | 385 | 244 | 359 | 13 | 0 | 30 | 20 | 48 | 2 | 0 |

### Example 1

### <Preparation of Aqueous Dispersion Liquid of Amorphous Polyester Resin>

### <<Preparation of Oil Phase>>

A vessel was charged with 150 parts of [Amorphous Polyester Resin A-1] and 150 parts of methyl ethyl ketone. The resulting mixture was mixed by a TK Homomixer (available from PRIMIX Corporation) for 60 minutes at 7,000 rpm, to thereby obtain [Oil Phase 1].

The amount of each component denotes the solid content of raw material(s) of each component. An amount of each component will be described in the same manner in the following steps.

### <Preparation of Aqueous Phase>

As [Aqueous Phase 1], 800 parts of ion-exchanged water was provided.

### <Phase Inversion Emulsification>

While stirring 700 parts of [Oil Phase 1] by a TK Homomixer at the rotational speed of 5,000 rpm, 10 parts of 10% sodium hydroxide was added to [Oil Phase 1]. After mixing the resulting mixture for 10 minutes, 1,200 parts of [Aqueous Phase 1] was gradually added by dripping, to thereby obtain [Emulsified Slurry 1].

### <Removal of Solvent>

A vessel to which a stirrer and a thermometer were set was charged with [Emulsified Slurry 1]. [Emulsified Slurry 1] was desolventized for 180 minutes at 30° C., to thereby obtain [Amorphous Polyester Aqueous Dispersion Liquid 1]. The volume average particle diameter of the particles included in [Amorphous Polyester Aqueous Dispersion Liquid 1] was 50 nm. The solid content of [Amorphous Polyester Aqueous Dispersion Liquid 1] was 25%.

### <Preparation of Resin Particles>

### <<Preparation of Oil Phase>>

A vessel was charged with 750 parts of [Amorphous Polyester Resin B-1], followed by mixing by a TK Homomixer (available from PRIMIX Corporation) for 60 minutes at 7,000 rpm, to thereby obtain [Oil Phase 2].

The amount of each component denotes the solid content of raw material(s) of each component. An amount of each component will be described in the same manner in the following steps.

### <<Preparation of Aqueous Phase>>

Water (990 parts), 25 parts of sodium dodecyl sulfate, and 90 parts of ethyl acetate were mixed and stirred, to thereby obtain a milky white emulsion, which was provided as [Aqueous Phase 2].

### <<Phase Inversion Emulsification>>

While stirring 700 parts of [Oil Phase 2] by a TK Homomixer at the rotational speed of 5,000 rpm, 20 parts of a 28% ammonia solution was added to [Oil Phase 2]. After mixing the resulting mixture for 10 minutes, 1,200 parts of [Aqueous Phase 2] was gradually added by dripping, to thereby obtain [Emulsified Slurry 2].

### <<Removal of Solvent>>

A vessel to which a stirrer and a thermometer were set was charged with [Emulsified Slurry 2]. [Emulsified Slurry 2] was desolventized for 180 minutes at 30° C., to thereby obtain [Desolventized Slurry 2]. The volume average particle diameter of the particles included in [Desolventized Slurry 2] was 0.35 μm.

### <<Aggregation>>

To [Desolventized Slurry 2], 100 parts of a 10% magnesium sulfate solution was added by dripping. After stirring the resulting mixture for 5 minutes, the temperature of the mixture was elevated to 60° C. When particle diameters of the particles in the mixture reached 5.0 μm, 300 parts of [Amorphous Polyester Aqueous Dispersion Liquid 1] was added by dripping. After stirring for 60 minutes, 200 parts of a 10% sodium chloride aqueous solution was added to terminate the aggregation process, to thereby obtain [Aggregate Slurry 1].

### <<Fusion>>

[Aggregate Slurry 1] was heated at 70° C., while stirring. When the aggregated particles reached the predetermined average circularity, which was 0.961, the slurry was cooled to thereby obtain [Dispersion Slurry 1].

### <<Washing and Drying>>

After performing filtration under reduced pressure on 100 parts of [Dispersion Slurry 1], the following processes (1) to (4) were performed twice to thereby obtain [Filtration Cake 1].
(1): To the filtration cake, 100 parts of ion-exchanged water was added, and the resulting mixture was mixed by a TK Homomixer (for 10 minutes at the rotational speed of 12,000 rpm), followed by performing filtration.
(2): To the filtration cake of (1), 100 parts of a 10% sodium hydroxide aqueous solution was added, and the resulting mixture was mixed by a TK Homomixer (for 30 minutes at the rotational speed of 12,000 rpm), followed by performing filtration under reduced pressure.
(3): To the filtration cake of (2), 100 parts of 10% hydrochloric acid was added, and the resulting mixture was mixed by a TK Homomixer (for 10 minutes at the rotational speed of 12,000 rpm), followed by performing filtration.
(4): To the filtration cake of (3), 300 parts of ion-exchanged water was added, and the resulting mixture was mixed by a TK Homomixer (for 10 minutes at the rotational speed of 12,000 rpm), followed by performing filtration.

[Filtration Cake 1] obtained was dried by an air circulation dryer for 48 hours at 45° C., followed by sieving with a mesh having an opening size of 75 μm, to thereby obtain [Resin Particles 1].

### Example 2

[Amorphous Polyester Aqueous Dispersion Liquid 2] and [Resin Particles 2] were obtained in the same manner as in Example 1, except that [Amorphous Polyester Resin A-1] was replaced with [Amorphous Polyester Resin A-2]. The volume average particle diameter of the resin particles in [Amorphous Polyester Aqueous Dispersion Liquid 2] obtained was 62 nm. The solid content of [Amorphous Polyester Aqueous Dispersion Liquid 2] was 25%.

### Example 3

[Amorphous Polyester Aqueous Dispersion Liquid 3] and [Resin Particles 3] were obtained in the same manner as in Example 1, except that [Amorphous Polyester Resin A-1] was replaced with [Amorphous Polyester Resin A-3] and [Amorphous Polyester Resin B-1] was replaced with [Amorphous Polyester Resin B-2]. The volume average particle diameter of the resin particles in [Amorphous Polyester Aqueous Dispersion Liquid 3] obtained was 73 nm. The solid content of [Amorphous Polyester Aqueous Dispersion Liquid 3] was 25%.

### Example 4

[Polyester Dispersion Liquid 4] and [Resin Particles 4] were obtained in the same manner as in Example 1, except that [Amorphous Polyester Resin A-1] was replaced with [Amorphous Polyester Resin A-4], 1,200 parts of ion-exchanged water was replaced with 1,200 parts of a mixture of ion-exchanged water and methyl ethyl ketone at a weight ratio of 90/10, and [Amorphous Polyester Resin B-1] was replaced with [Amorphous Polyester Resin B-3]. The volume average particle diameter of the resin particles in [Polyester Dispersion Liquid 4] obtained was 69 nm. The solid content of [Polyester Dispersion Liquid 4] was 25%.

### Example 5

[Amorphous Polyester Aqueous Dispersion Liquid 5] and [Resin Particles 5] were obtained in the same manner as in Example 1, except that [Amorphous Polyester Resin A-1] was replaced with [Amorphous Polyester Resin A-5] and the amount of methyl ethyl ketone was changed from 150 parts to 100 parts. The volume average particle diameter of the resin particles in [Amorphous Polyester Aqueous Dispersion Liquid 5] obtained was 39 nm. The solid content of [Amorphous Polyester Aqueous Dispersion Liquid 5] was 25%.

### Example 6

[Amorphous Polyester Aqueous Dispersion Liquid 6] and [Resin Particles 6] were obtained in the same manner as in Example 1, except that [Amorphous Polyester Resin A-1] was replaced with [Amorphous Polyester Resin A-6] and [Amorphous Polyester Resin B-1] was replaced with [Amorphous Polyester Resin B-2]. The volume average particle diameter of the resin particles in [Amorphous Polyester Aqueous Dispersion Liquid 6] obtained was 58 nm. The solid content of [Amorphous Polyester Aqueous Dispersion Liquid 6] was 25%.

### Example 7

[Amorphous Polyester Aqueous Dispersion Liquid 7] and [Resin Particles 7] were obtained in the same manner as in Example 1, except that [Amorphous Polyester Resin A-1] was replaced with [Amorphous Polyester Resin A-7] and [Amorphous Polyester Resin B-1] was replaced with [Amorphous Polyester Resin B-3]. The volume average particle diameter of the resin particles in [Amorphous Polyester Aqueous Dispersion Liquid 7] obtained was 67 nm. The solid content of [Amorphous Polyester Aqueous Dispersion Liquid 7] was 25%.

### Comparative Example 1

[Amorphous Polyester Aqueous Dispersion Liquid 8] and [Resin Particles 8] were obtained in the same manner as in Example 1, except that [Amorphous Polyester Resin A-1] was replaced with [Amorphous Polyester Resin A-8]. The volume average particle diameter of the resin particles in [Amorphous Polyester Aqueous Dispersion Liquid 8] obtained was 55 nm. The solid content of [Amorphous Polyester Aqueous Dispersion Liquid 8] was 25%.

### Comparative Example 2

[Amorphous Polyester Aqueous Dispersion Liquid 9] and [Resin Particles 9] were obtained in the same manner as in Example 1, except that [Amorphous Polyester Resin A-1] was replaced with [Amorphous Polyester Resin A-9] and [Amorphous Polyester Resin B-1] was replaced with [Amorphous Polyester Resin B-2]. The volume average particle diameter of the resin particles in [Amorphous Polyester Aqueous Dispersion Liquid 9] obtained was 63 nm. The solid content of [Amorphous Polyester Aqueous Dispersion Liquid 9] was 25%.

### Comparative Example 3

[Amorphous Polyester Aqueous Dispersion Liquid 10] and [Resin Particles 10] were obtained in the same manner as in Example 1, except that [Amorphous Polyester Resin A-1] was replaced with [Amorphous Polyester Resin A-10] and [Amorphous Polyester Resin B-1] was replaced with [Amorphous Polyester Resin B-3]. The volume average particle diameter of the resin particles in [Amorphous Polyester Aqueous Dispersion Liquid 10] obtained was 50 nm. The solid content of [Amorphous Polyester Aqueous Dispersion Liquid 10] was 25%.

### Comparative Example 4

[Amorphous Polyester Aqueous Dispersion Liquid 11] and [Resin Particles 11] were obtained in the same manner as in Example 1, except that [Amorphous Polyester Resin A-1] was replaced with [Amorphous Polyester Resin A-11]. The volume average particle diameter of the resin particles in [Amorphous Polyester Aqueous Dispersion Liquid 11] obtained was 70 nm. The solid content of [Amorphous Polyester Aqueous Dispersion Liquid 11] was 25%.

### Comparative Example 5

[Amorphous Polyester Aqueous Dispersion Liquid 12] and [Resin Particles 12] were obtained in the same manner as in Example 1, except that [Amorphous Polyester Resin A-1] was replaced with [Amorphous Polyester Resin A-12] and [Amorphous Polyester Resin B-1] was replaced with [Amorphous Polyester Resin B-2]. The volume average particle diameter of the resin particles in [Amorphous Polyester Aqueous Dispersion Liquid 12] obtained was 61 nm. The solid content of [Amorphous Polyester Aqueous Dispersion Liquid 12] was 25%.

### Comparative Example 6

[Amorphous Polyester Aqueous Dispersion Liquid 13] and [Resin Particles 13] were obtained in the same manner as in Example 1, except that [Amorphous Polyester Resin A-1] was replaced with [Amorphous Polyester Resin A-13] and [Amorphous Polyester Resin B-1] was replaced with [Amorphous Polyester Resin B-3]. The volume average particle diameter of the resin particles in [Amorphous Polyester Aqueous Dispersion Liquid 13] obtained was 52 nm. The solid content of [Amorphous Polyester Aqueous Dispersion Liquid 13] was 25%.

Each of the amorphous polyester aqueous dispersion liquids obtained in Examples 1 to 7 and Comparative Examples 1 to 6 was evaluated on environmental friendliness of the polyester resin, stability of the amorphous polyester aqueous dispersion liquid, durability of the polyester resin, an durability of the resin particles in the following manner. The results are presented in Tables 3-1 and 3-2.

### <Evaluation Methods>

### <<Environmental Friendliness of Polyester Resin>>

“Environmental friendliness” was evaluated based on the environmentally friendly component content, which was the chroloform-soluble component content, of the amorphous polyester resin in the amorphous polyester aqueous dispersion liquid according to the following evaluation criteria.

### <<<Measuring Method of Environmentally Friendly Component Content of Amorphous Polyester Resin in Amorphous Polyester Aqueous Dispersion Liquid>>>

To 100 mL of chloroform, 1 g of a dried product of each of the amorphous polyester aqueous dispersion liquids was added. The dried product was obtained by drying each of the amorphous polyester aqueous dispersion liquids by a vacuum dryer for 6 hours. The resulting mixture was stirred for 30 minutes at 25° C. to prepare a solution in which a soluble component was dissolved. The resulting solution was filtered with a membrane filter having an opening size of 0.2 μm to obtain a chloroform-soluble component of the amorphous polyester resin, followed by measuring a mass (X) of the chloroform-soluble component. Subsequently, the obtained chloroform-soluble component was dissolved in chloroform to prepare a sample for GPC, and the sample was injected to GPC to measure a molecular weight as described above. A fraction collector was disposed at an eluate outlet of the GPC. The eluate was fractionated per the predetermined count to collect the eluate per 5% from the elution onset of the elution curve (a rise of the elution curve) based on an area ratio. After condensing and drying each of the fractions of the eluate by an evaporator to prepare a sample, 30 mg of each of the prepared samples was dissolved in 1 mL of deuterated chloroform. To the resulting solution, 0.05% by volume of tetramethylsilane (TMS) was added as a standard material. The resulting solution was added to a 5 mm-diameter glass tube for nuclear magnetic resonance (NMR) spectroscopy, and a spectrum of the sample was obtained by a nuclear magnetic resonance spectrometer (JNM-AL400, available from JEOL Ltd.) by integrating 128 times at a temperature of from 23° C. to 25° C. The monomer composition and the composition ratios of the eluate component of the amorphous polyester resin were determined from the peak integration ratios of the obtained spectra. The obtained composition ratio was inserted into Equation (4) below to calculate the “environmentally friendly component content” of the amorphous polyester resin.

$$Environmentally friendly component content ( \% ) = total mass ( Y ) of constituent monomer components / total mass ( X ) of chloroform soluble component \times 100 \qquad Equation ( 4 )$$

In Equation (4), the “mass of the constituent monomer component” is a mass (y) calculated by multiplying a molecular weight of the constituent monomer component included in the sample with a composition ratio (molar ratio) of the monomer component determined from the peak integration ratio of the spectrum, and the “total mass (Y) of constituent monomer components” is a sum of masses (y) of the constituent monomer components included in the amorphous polyester resin of the sample determined by the monomer composition of the spectra.

The constituent monomers are the environmentally friendly component, and are any monomers selected from the group consisting of PET-derived ethylene glycol, plant-derived propylene glycol, plant-derived succinic acid, plant-derived sebacic acid, plant-derived dodecanedioic acid, and PET-derived terephthalic acid included in the amorphous polyester resin of the amorphous polyester aqueous dispersion liquids of Examples 1 to 10 and Comparative Examples 1 to 12.

The evaluation results of “Excellent and Good” in the following evaluation criteria are acceptable levels without any problems on practical use.

### —Evaluation Criteria of “Environmental Friendliness”—

Excellent: 60% or greater
Good: 40% or greater and less than 60%
Not good: less than 40%<

### <<Measuring Method for Stability of Amorphous Polyester Aqueous Dispersion Liquid>>

The solid content of each of the amorphous polyester aqueous dispersion liquids was adjusted to 10% with ion-exchanged water. A container was charged with 10 g of the prepared amorphous polyester aqueous dispersion liquid. While stirring the amorphous polyester aqueous dispersion liquid with a magnetic stirrer, a 5% calcium chloride aqueous solution was added by dripping. The minimum concentration of the calcium chloride aqueous solution at which the volume average particle diameter of the dispersed particles in the amorphous polyester aqueous dispersion liquid became double or larger compared to the volume average particle diameter of the particles before addition of the calcium chloride aqueous solution was determined as a critical aggregation concentration. The volume average particle diameter of the particles was measured by a particle size distribution analyzer, Nanotrac (UPA-EX150, available from NIKKISO CO., LTD., dynamic light scattering/laser doppler velocimetry).

The evaluation results of “Excellent and Good” in the following evaluation criteria are acceptable levels without any problems on practical use.

### —Evaluation Criteria of “Stability of Amorphous Polyester Aqueous Dispersion Liquid”—

Excellent: The critical aggregation concentration was 10% or greater relative to the solid content of the amorphous polyester resin.
Good: The critical aggregation concentration was 5% or greater and less than 10% relative to the solid content of the amorphous polyester resin.
Not good: The critical aggregation concentration was less than 5% relative to the solid content of the amorphous polyester resin.

### <<Measuring Method for Durability of Polyester Resin>>

After adjusting the solid content of each of the amorphous polyester aqueous dispersion liquids to 20%, the prepared amorphous polyester aqueous dispersion liquid was applied onto a glass plate by a film applicator to form a film having a thickness of 0.2 mm. The formed film was dried in an oven of 150° C. for 1 hour, followed by storing in a constant temperature and humidity chamber of 40° C./70% RH for 168 hours. Thereafter, scratch hardness (pencil method) of the film was measured according to JIS K5600-5-4.

The evaluation results of “Excellent and Good” in the following evaluation criteria are acceptable levels without any problems on practical use.

### —Evaluation Criteria of “Durability of Polyester Resin”—

Excellent: 2H or harder
Good: F to H
Not good: HB or softer

### <<Measuring Method for Durability of Resin Particles>>

A container was charged with 32 g of the resin particles and 618 g of a standard carrier provided by The Imaging Society of Japan (Standard carrier for negatively charged toner “N-01”), and the resulting mixture was homogeneously mixed by a TURBULA mixer (available from Willy A. Bachofen AG) for 5 minutes at 48 rpm, to thereby prepare a mixture of the resin particles and the carrier.

A commercially available copier (RICOH MP C6502, available from Ricoh Company Limited) was charged with 650 g of the mixture of the resin particles and the carrier. After setting the copier to drive only a developing device without printing an image, the developing device was driven to stir for hours to prepare a deteriorated developer.

### (Measurement of Small Particle Content)

The resin particles were separated from the deteriorated developer after the stirring in the following manner, and the separated resin particles were measured by FPIA-3000. A small particle content was a number frequency of the resin particles of 3.5 μm or smaller, and a subtracted value from the small particle content of the deteriorated resin particles to the small particle content of the initial resin particles was determined as A small particle content. The resin particles having high durability have a small value of Δ small particle content, and the resin particles having low durability have a large value of Δ small particle content because of breakage of the particles.

### (Method for Separating Resin Particles)

The deteriorated developer (2 g) and 1 g of DRIWEL (available from FUJI FILM Corporation) were diluted 3-fold with ion-exchanged water. After further weighing ion-exchanged water by 15 g, the resulting mixture was placed in a ultrasonic bath and was dispersed for 1 minute.

The supernatant was collected, and the resin particles were measured by FPIA-3000.

The evaluation results of “Excellent and Good” in the following evaluation criteria are acceptable levels without any problems on practical use.

### —Evaluation Criteria of “Durability of Resin Particles”—

Excellent: The Δ small particle content was less than 1%.
Good: The Δ small particle content was 1% or greater and less than 10%.
Not good: The Δ small particle content was 10% or greater.

TABLE 3-1

| | Amorphous polyester | Amorphous polyester | Resin |
|---|---|---|---|
| | resin No. of shell | resin No. of core | Particles No. |
| Ex. 1 | A-1 | B-1 | Resin |
| | | | Particles 1 |
| Ex. 2 | A-2 | B-1 | Resin |
| | | | Particles 2 |
| Ex. 3 | A-3 | B-2 | Resin |
| | | | Particles 3 |
| Ex. 4 | A-4 | B-3 | Resin |
| | | | Particles 4 |
| Ex. 5 | A-5 | B-1 | Resin |
| | | | Particles 5 |
| Ex. 6 | A-6 | B-2 | Resin |
| | | | Particles 6 |
| Ex. 7 | A-7 | B-3 | Resin |
| | | | Particles 7 |
| Comp. | A-8 | B-1 | Resin |
| Ex. 1 | | | Particles 8 |
| Comp. | A-9 | B-2 | Resin |
| Ex. 2 | | | Particles 9 |
| Comp. | A-10 | B-3 | Resin |
| Ex. 3 | | | Particles 10 |
| Comp. | A-11 | B-1 | Resin |
| Ex. 4 | | | Particles 11 |
| Comp. | A-12 | B-2 | Resin |
| Ex. 5 | | | Particles 12 |
| Comp. | A-13 | B-3 | Resin |
| Ex. 6 | | | Particles 13 |

TABLE 3-2

| | Evaluation results | | | |
|---|---|---|---|---|
| | Environmentally | | Durability of | Durability |
| | friendly | | amorphous | of |
| | component | | polyester | resin |
| | content | Stability | resin | particles |
| Ex. 1 | Good | Excellent | Good | Good |
| Ex. 2 | Good | Excellent | Good | Good |
| Ex. 3 | Good | Good | Excellent | Excellent |
| Ex. 4 | Excellent | Good | Good | Good |
| Ex. 5 | Good | Good | Good | Good |
| Ex. 6 | Good | Good | Good | Good |
| Ex. 7 | Good | Good | Good | Good |
| Comp. | Good | Not good | Not good | Not good |
| Ex. 1 | | | | |
| Comp. | Good | Excellent | Not good | Not good |
| Ex. 2 | | | | |
| Comp. | Not good | Good | Good | Good |
| Ex. 3 | | | | |
| Comp. | Excellent | Good | Not good | Not good |
| Ex. 4 | | | | |
| Comp. | Not good | Not good | Not good | Not good |
| Ex. 5 | | | | |
| Comp. | Not good | Not good | Not good | Not good |
| Ex. 6 | | | | |

For example, embodiments of the present disclosure include as follows.
(1) An amorphous polyester resin, including:
an environmentally friendly component, where an environmentally friendly component content of the amorphous polyester resin is 408 by mass or greater and 80% by mass or less,
wherein the amorphous polyester resin is a sulfo group-containing amorphous polyester resin, where a sulfo group content of the sulfo group-containing amorphous polyester resin is 2 mol % or greater and 10 mol % or less.
(2) The amorphous polyester resin according to (1),
   wherein the sulfo group-containing amorphous polyester resin has an SP value of 11.5 or greater and 13.0 or less.
(3) The amorphous polyester resin according to (1) or (2),
   wherein the environmentally friendly component includes at least one selected from the group consisting of a recycled polyethylene terephthalate-derived component, a recycled polybutylene terephthalate-derived component, and a plant-derived component.
(4) An aqueous dispersion liquid of an amorphous polyester resin, the aqueous dispersion liquid including:
the amorphous polyester resin of any one of (1) to (3) as dispersed particles; and
an aqueous medium as a dispersion medium.
(5) A method for producing an aqueous dispersion liquid of an amorphous polyester resin, the method including:
Step A: dissolving or dispersing the amorphous polyester resin of any one of (1) to (3) in an organic solvent to prepare an oil phase; and
Step B: adding an aqueous medium to the oil phase to cause phase inversion from a water-in-oil dispersion liquid to an oil-in-water dispersion liquid to obtain an aqueous dispersion liquid including the amorphous polyester resin as dispersed particles, and the aqueous medium as a dispersion medium.
(6) Resin particles, each including:
a core layer; and
a shell layer including the amorphous polyester resin of any one of (1) to (3),
the core layer and the shell layer constituting a core-shell structure of each of the resin particles.
(7) A method for producing resin particles, the method including:
Step a: dissolving or dispersing an amorphous polyester resin in an organic solvent to prepare an oil phase;
Step b: adding an aqueous medium to the oil phase to cause phase inversion from a water-in-oil dispersion liquid to an oil-in-water dispersion liquid where the oil phase is dispersed as dispersed particles in the aqueous medium;
Step c: aggregating the dispersed particles in the oil-in-water dispersion liquid; and
Step d: after Step c, adding the aqueous dispersion liquid of (4) to the oil-in-water dispersion liquid to aggregate the amorphous polyester resin contained in the aqueous dispersion liquid to form a shell layer on each of the aggregated particles obtained in Step c.
(8) Toner resin particles, including:
the resin particles according to (6), each including at least one selected from the group consisting of a crystalline resin, a release agent, and a colorant.
(9) A toner including:
the toner resin particles of (8); and an external additive.
(10) A method for producing a toner, the method including:
adding an external additive to the toner resin particles of (8).
(11) A developer, including:
the toner of (9); and
a carrier.
(12) A toner storage, including:
a storage configured to store a toner; and
the toner of (9) stored in the storage.
(13) An image forming apparatus, including:
an electrostatic latent image bearer;
an electrostatic latent image forming mechanism configured to form an electrostatic latent image on the electrostatic latent image bearer; and
a developing device that contains the toner of (9) and is configured to develop the electrostatic latent image formed on the electrostatic latent image bearer with the toner to form a visible image.

What is claimed is:

1. An amorphous polyester resin, comprising:
an environmentally friendly component, where an environmentally friendly component content of the amorphous polyester resin is 40% by mass or greater and 80% by mass or less,
wherein the amorphous polyester resin is a sulfo group-containing amorphous polyester resin, where a sulfo group content of the sulfo group-containing amorphous polyester resin is 2 mol % or greater and 10 mol % or less.

2. The amorphous polyester resin according to claim 1,
wherein the sulfo group-containing amorphous polyester resin has an SP value of 11.5 or greater and 13.0 or less.

3. The amorphous polyester resin according to claim 1,
wherein the environmentally friendly component includes at least one selected from the group consisting of a recycled polyethylene terephthalate-derived component, a recycled polybutylene terephthalate-derived component, and a plant-derived component.

4. An aqueous dispersion liquid of an amorphous polyester resin, the aqueous dispersion liquid comprising:
the amorphous polyester resin of claim 1 as dispersed particles; and
an aqueous medium as a dispersion medium.

5. A method for producing an aqueous dispersion liquid of an amorphous polyester resin, the method comprising:
Step A: dissolving or dispersing the amorphous polyester resin of claim 1 in an organic solvent to prepare an oil phase; and
Step B: adding an aqueous medium to the oil phase to cause phase inversion from a water-in-oil dispersion liquid to an oil-in-water dispersion liquid to obtain an aqueous dispersion liquid including the amorphous polyester resin as dispersed particles, and the aqueous medium as a dispersion medium.

6. Resin particles, each comprising:
a core layer; and
a shell layer including the amorphous polyester resin of claim 1,
the core layer and the shell layer constituting a core-shell structure of each of the resin particles.

7. A method for producing resin particles, the method comprising:
Step a: dissolving or dispersing an amorphous polyester resin in an organic solvent to prepare an oil phase;
Step b: adding an aqueous medium to the oil phase to cause phase inversion from a water-in-oil dispersion liquid to an oil-in-water dispersion liquid where the oil phase is dispersed as dispersed particles in the aqueous medium;
Step c: aggregating the dispersed particles in the oil-in-water dispersion liquid; and
Step d: after Step c, adding the aqueous dispersion liquid of claim 4 to the oil-in-water dispersion liquid to aggregate the amorphous polyester resin contained in the aqueous dispersion liquid to form a shell layer on each of the aggregated particles obtained in Step c.

8. Toner resin particles, comprising:
the resin particles of claim 6, each including at least one selected from the group consisting of a crystalline resin, a release agent, and a colorant.

9. A toner comprising:
the toner resin particles of claim 8; and
an external additive.

10. A method for producing a toner, the method comprising:
adding an external additive to the toner resin particles of claim 8.

11. A developer, comprising:
the toner of claim 9; and
a carrier.

12. A toner storage, comprising:
a storage configured to store a toner; and
the toner of claim 9 stored in the storage.

13. An image forming apparatus, comprising:
an electrostatic latent image bearer;
an electrostatic latent image forming mechanism configured to form an electrostatic latent image on the electrostatic latent image bearer; and
a developing device that contains the toner of claim 9 and is configured to develop the electrostatic latent image formed on the electrostatic latent image bearer with the toner to form a visible image.
